(19) United States
(12) Patent Application Publication
(10) Pub. No.: US 2025/0260839 A1
(43) Pub. Date: Aug. 14, 2025

(54) INFORMATION PROCESSING DEVICE AND METHOD

(71) Applicant: Sony Group Corporation, Tokyo (JP)

(72) Inventors: Mitsuhiro HIRABAYASHI, Tokyo (JP); Ryohei TAKAHASHI, Tokyo (JP)

(73) Assignee: Sony Group Corporation, Tokyo (JP)

(21) Appl. No.: 18/857,212

(22) PCT Filed: Apr. 21, 2023
(86) PCT No.: PCT/JP2023/015856

§ 371 Date: Oct. 16, 2024

Related U.S. Application Data
(60) Provisional application No. 63/435,380, filed on Dec. 27, 2022.
(60) Provisional application No. 63/333,627, filed on Apr. 22, 2022.

(51) Int. Cl. H04N 19/597; H04N 19/46

(52) U.S. Cl. CPC H04N 19/597; H04N 19/46

(57) ABSTRACT

The present disclosure relates to an information processing device and method that make it possible to suppress a reduction in distribution performance for media data associated with 3D data.

An interaction type medium associated with 3D data is encoded, coded data of the interaction type medium is generated, and a distribution file including the coded data and information defining the interaction type medium is generated. Furthermore, a distribution file including coded data of the interaction type medium associated with the 3D data and the information defining the interaction type medium is acquired, the coded data is extracted from the distribution file on the basis of the information, and the extracted coded data is decoded. The present disclosure can be applied to, for example, an information processing device, an information processing method, or the like.

### TECHNICAL FIELD

The present disclosure relates to an information processing device and a method, and particularly, to an information processing device and a method enabled to suppress a reduction in distribution performance for media data associated with 3D data.

### BACKGROUND ART

Conventionally, there has been the GL transmission format (glTF) (registered trademark) 2.0 that is a format of a scene description for disposing and rendering a three-dimensional (3D) object in a three-dimensional space (for example, see Non-Patent Document 1).

Furthermore, in the moving picture experts group (MPEG)-I scene description, a method of extending the glTF 2.0 and handling dynamic content in the time direction has been proposed (for example, see Non-Patent Document 2).

Meanwhile, standardization of encoding transmission technology for tactile information (also referred to as haptics media) has started in addition to that for audio media and video media that are components of 2D video content and 3 degrees of freedom (DoF)/6 DoF video content (see, for example, Non-Patent Document 3).

Furthermore, a basic function has been created for storing a bitstream obtained by encoding the haptics media in International Organization for Standardization Base Media File Format (ISOBMFF) (see, for example, Non-Patent Document 4).

Furthermore, in parallel with the standardization of encoding transmission technology for haptics media, a technology search study has started for handling haptics media with MPEG-I scene description (see, for example, Non-Patent Document 5).

### CITATION LIST

### Non-Patent Document

Non-Patent Document 1: Saurabh Bhatia, Patrick Cozzi, Alexey Knyazev, Tony Parisi, “Khronos glTF2.0”, https://github.com/KhronosGroup/glTF/tree/master/specification/2.0, Jun. 9, 2017
Non-Patent Document 2: “Text of ISO/IEC CD 23090-14 scene description for MPEG Media”, ISO/IEC JTC 1/SC 29/WG 3 N00485, 2021 Oct. 12
Non-Patent Document 3: Quentin Galvane, Fabien Danieau, Philippe Guillotel, Eric Vezzoli, Alexandre Hulsken, Titouan Rabu, Andreas Noll, Lars Nockenberg, “WD on the Coded Representation of Haptics-Phase 1”, ISO/IEC JTC 1/SC 29/WG 2, m58748, 2021/10/Non-Patent Document 4: “Information technology-Coding of audio-visual objects-Part 12: ISO base media file format, TECHNICAL CORRIGENDUM 1”, ISO/IEC 14496-12:2015/Cor.1, ISO/IEC JTC 1/SC 29/WG 11, 2016 Jun. 3
Non-Patent Document 5: Chris Ullrich, Yeshwant Muthusamy, Fabien Danieau, Quentin Galvane, Philippe Guillotel, Eric Vezzoli, Titouan Rabu, “MPEG-I SD Revised Haptic Schema and Processing Model”, ISO/IEC JTC 1/SC 29/WG 3 m58487 v3, 2021/10/

### SUMMARY OF THE INVENTION

### Problems to be Solved by the Invention

However, technology search study have just started for distributing media data associated with 3D data such as a haptics medium, and there has been some media data still difficult to be correctly distributed. For that reason, there has been a possibility that distribution performance for media data associated with 3D data is reduced.

The present disclosure has been made in view of such a situation, and an object thereof is to make it possible to suppress a reduction in distribution performance for media data associated with 3D data.

### Solutions to Problems

An information processing device of one aspect of the present technology is an information processing device including: an encoding unit that encodes an interaction type medium associated with 3D data and generates coded data of the interaction type medium; and a generation unit that generates a distribution file including the coded data and information defining the interaction type medium, in which the interaction type medium is a medium to be reproduced on the basis of occurrence of a predetermined event.

An information processing method of one aspect of the present technology is an information processing method including: encoding an interaction type medium associated with 3D data and generating coded data of the interaction type medium; and generating a distribution file including the coded data and information defining the interaction type medium, in which the interaction type medium is a medium to be reproduced on the basis of occurrence of a predetermined event.

An information processing device of another aspect of the present technology is an information processing device including: an acquisition unit that acquires a distribution file including coded data of an interaction type medium associated with 3D data and information defining the interaction type medium; an extraction unit that extracts the coded data from the distribution file on the basis of the information; and a decoding unit that decodes the coded data extracted, in which the interaction type medium is a medium to be reproduced on the basis of occurrence of a predetermined event.

An information processing method of another aspect of the present technology is an information processing method including: acquiring a distribution file including coded data of an interaction type medium associated with 3D data and information defining the interaction type medium; extracting the coded data from the distribution file on the basis of the information; and decoding the coded data extracted, in which the interaction type medium is a medium to be reproduced on the basis of occurrence of a predetermined event.

An information processing device of still another aspect of the present technology is an information processing device including: an encoding unit that encodes an interaction type medium associated with 3D data and generates coded data of the interaction type medium; and a generation unit that generates a media file including the coded data, and further generates a control file including control information on distribution of the media file and information defining the interaction type medium, in which the interaction type medium is a medium to be reproduced on the basis of occurrence of a predetermined event.

An information processing method of still another aspect of the present technology is an information processing method including: encoding an interaction type medium associated with 3D data and generating coded data of the interaction type medium; and generating a media file including the coded data, and further generating a control file including control information on distribution of the media file and information defining the interaction type medium, in which the interaction type medium is a medium to be reproduced on the basis of occurrence of a predetermined event.

An information processing device of still another aspect of the present technology is an information processing device including: an acquisition unit that acquires a media file on the basis of information that is included in a control file for controlling distribution of the media file including coded data of an interaction type medium associated with 3D data and defines the interaction type medium; an extraction unit that extracts the coded data from the media file; and a decoding unit that decodes the coded data extracted, in which the interaction type medium is a medium to be reproduced on the basis of occurrence of a predetermined event.

An information processing method of still another aspect of the present technology is an information processing method including: acquiring a media file on the basis of information that is included in a control file for controlling distribution of the media file including coded data of an interaction type medium associated with 3D data and defines the interaction type medium; extracting the coded data from the media file; and decoding the coded data extracted, in which the interaction type medium is a medium to be reproduced on the basis of occurrence of a predetermined event.

An information processing device of still another aspect of the present technology is an information processing device including: an encoding unit that encodes a haptics medium associated with 3D data and generates coded data of the haptics medium; and a generation unit that generates a distribution file in which the coded data is stored as metadata and further including information defining the haptics medium as the metadata.

An information processing method of still another aspect of the present technology is an information processing method including: encoding a haptics medium associated with 3D data and generating coded data of the haptics medium; and generating a distribution file in which the coded data is stored as metadata and further including information defining the haptics medium as the metadata.

An information processing device of still another aspect of the present technology is an information processing device including: an acquisition unit that acquires a distribution file in which coded data of a haptics medium associated with 3D data is stored as metadata and further including information defining the haptics medium as the metadata; an extraction unit that extracts the coded data from the distribution file on the basis of the information; and a decoding unit that decodes the coded data extracted.

An information processing method of still another aspect of the present technology is an information processing method including: acquiring a distribution file in which coded data of a haptics medium associated with 3D data is stored as metadata and further including information defining the haptics medium as the metadata; extracting the coded data from the distribution file on the basis of the information; and decoding the coded data extracted.

In the information processing device and the method of one aspect of the present technology, an interaction type medium associated with 3D data is encoded, coded data of the interaction type medium is generated, and a distribution file including the coded data and information defining the interaction type medium is generated.

In the information processing device and the method of another aspect of the present technology, a distribution file including coded data of an interaction type medium associated with 3D data and information defining the interaction type medium is acquired, the coded data is extracted from the distribution file on the basis of the information, and the extracted coded data is decoded.

In the information processing device and the method of still another aspect of the present technology, an interaction type medium associated with 3D data is encoded, coded data of the interaction type medium is generated, a media file including the coded data is generated, and further, a control file including control information on distribution of the media file and information defining the interaction type medium is generated.

In the information processing device and the method of still another aspect of the present technology, a media file is acquired on the basis of information that is included in a control file for controlling distribution of the media file including coded data of an interaction type medium associated with 3D data and defines the interaction type medium, the coded data is extracted from the media file, and the extracted coded data is decoded.

In the information processing device and the method of still another aspect of the present technology, a haptics medium associated with 3D data is encoded, coded data of the haptics medium is generated, the coded data is stored as metadata, and further, a distribution file including information defining the haptics medium as the metadata is generated.

In the information processing device and the method of still another aspect of the present technology, coded data of a haptics medium associated with 3D data is stored as metadata, and further, a distribution file including information defining the haptics medium as the metadata is acquired, the coded data is extracted from the distribution file on the basis of the information, and the extracted coded data is decoded.

### BRIEF DESCRIPTION OF DRAWINGS

FIG. 1 is a diagram illustrating a main configuration example of the glTF 2.0.

FIG. 2 is a diagram illustrating an example of a glTF object and a reference relationship.

FIG. 3 is a diagram illustrating a description example of a scene description.

FIG. 4 is a diagram for describing a method of accessing binary data.

FIG. 5 is a diagram illustrating a description example of a scene description.

FIG. 6 is a diagram describing a relationship between a buffer object, a buffer view object, and an accessor object.

FIG. 7 is a diagram illustrating description examples of the buffer object, the buffer view object, and the accessor object.

FIG. 8 is a diagram describing a configuration example of an object of a scene description.

FIG. 9 is a diagram illustrating a description example of a scene description.

FIG. 10 is a diagram for describing an object extension method.

FIG. 11 is a diagram for describing a configuration of a client process.

FIG. 12 is a diagram illustrating a configuration example of an extension for handling timed metadata.

FIG. 13 is a diagram illustrating a description example of a scene description.

FIG. 14 is a diagram illustrating a description example of a scene description.

FIG. 15 is a diagram illustrating a configuration example of an extension for handling timed metadata.

FIG. 16 is a diagram illustrating a main configuration example of a client.

FIG. 17 is a flowchart describing an example of a flow of a client process.

FIG. 18 is a diagram illustrating an example of storing a glTF object in an MP4 file.

FIG. 19 is a diagram illustrating an example of storing the glTF object in the MP4 file.

FIG. 20 is a diagram illustrating an example of storing an image item as metadata in an MP4 file.

FIG. 21 is a diagram describing an outline of encoding of a haptics medium.

FIG. 22 is a diagram illustrating a configuration example of a binary header.

FIG. 23 is a diagram illustrating an example of semantics of haptic file metadata.

FIG. 24 is a diagram illustrating an example of semantics of avatar metadata.

FIG. 25 is a diagram illustrating an example of semantics of perception metadata.

FIG. 26 is a diagram illustrating an example of semantics of reference device metadata.

FIG. 27 is a diagram illustrating an example of semantics of a track header.

FIG. 28 is a diagram illustrating an example of semantics of a band header.

FIG. 29 is a diagram illustrating an example of semantics of a transient band body and a curve band body.

FIG. 30 is a diagram illustrating an example of semantics of a wave band body.

FIG. 31 is a diagram illustrating an extension example of ISOBMFF for storing a haptics medium.

FIG. 32 is a diagram illustrating an example of a state of reproduction control with an edit list.

FIG. 33 is a diagram illustrating an extension example of a scene description for handling a haptics medium.

FIG. 34 is a diagram illustrating an example of an extended definition regarding a medium associated with 3D data in a distribution file format.

FIG. 35 is a diagram illustrating an extension example of ISOBMFF for handling a haptics medium.

FIG. 36 is a diagram illustrating an extension example of a sample entry and a sample structure.

FIG. 37 is a diagram illustrating an example of syntax of each structure stored in a haptic configuration box.

FIG. 38 is a diagram illustrating an example of syntax of a sample structure.

FIG. 39 is a diagram illustrating an extension example of a sample entry and a sample structure.

FIG. 40 is a diagram illustrating an example of syntax of a sample structure.

FIG. 41 is a diagram illustrating an extension example of a sample entry and a sample structure.

FIG. 42 is a diagram illustrating an example of syntax of a sample structure.

FIG. 43 is a diagram illustrating an extension example of a sample entry and a sample structure.

FIG. 44 is a diagram illustrating an example of syntax of a sample structure.

FIG. 45 is a diagram illustrating an extension example of a sample entry and a sample structure.

FIG. 46 is a diagram illustrating an example of syntax of a sample structure.

FIG. 47 is a diagram illustrating an extension example of a sample entry and a sample structure.

FIG. 48 is a diagram illustrating an example of syntax of a band header structure stored in a haptic configuration box.

FIG. 49 is a diagram illustrating an example of syntax of a sample structure.

FIG. 50 is a diagram illustrating an extension example of ISOBMFF for handling an interaction type medium.

FIG. 51 is a diagram illustrating an extension example of semantics of Flags.

FIG. 52 is a diagram illustrating an extension example of an edit list box.

FIG. 53 is a diagram illustrating an extension example of ‘sync’ track reference.

FIG. 54 is a diagram illustrating an extension example of RestrictedSampleEntry ‘resp’.

FIG. 55 is a diagram illustrating an example of adding flag information.

FIG. 56 is a diagram illustrating an example of adding an extension of ‘sync’ track reference.

FIG. 57 is a diagram illustrating an extension example of ISOBMFF for storing a haptics medium as metadata.

FIG. 58 is a diagram illustrating an extension example of a meta-box.

FIG. 59 is a diagram illustrating an extension example of the meta-box.

FIG. 60 is a diagram illustrating an example of TimedMetadataInformationProperty.

FIG. 61 is a diagram illustrating an extension example of the meta-box.

FIG. 62 is a diagram illustrating an extension example of ISOBMFF for associating 3D data with an interaction type medium.

FIG. 63 is a diagram illustrating an example of a state of associating 3D data with an interaction type medium.

FIG. 64 is a diagram illustrating an example of a state of associating 3D data with an interaction type medium.

FIG. 65 is a diagram illustrating an example of a state of associating 3D data with an interaction type medium using a scene description.

FIG. 66 is a diagram illustrating an example of a state of associating 3D data with an interaction type medium using a scene description.

FIG. 67 is a diagram illustrating an example of InteractionInformationProperty.

FIG. 68 is a diagram illustrating an example of a state of associating 3D data with an interaction type medium using a scene description.

FIG. 69 is a diagram illustrating an example of a state of associating 3D data with an interaction type medium using a scene description.

FIG. 70 is a diagram illustrating an extension example of RestrictedSampleEntry ‘resp’.

FIG. 71 is a diagram illustrating an example of adding flag information.

FIG. 72 is a diagram illustrating an example of adding an extension of ‘sync’ track reference.

FIG. 73 is a diagram illustrating an extension example of an MPD for handling an interaction type medium.

FIG. 74 is a diagram illustrating an extension example of the MPD.

FIG. 75 is a diagram illustrating an extension example of the MPD.

FIG. 76 is a diagram illustrating an extension example of the MPD.

FIG. 77 is a diagram illustrating an extension example of the MPD.

FIG. 78 is a diagram illustrating a configuration example of a Matroska media container.

FIG. 79 is a block diagram illustrating a main configuration example of a file generation device.

FIG. 80 is a flowchart illustrating an example of a flow of a file generation process.

FIG. 81 is a block diagram illustrating a main configuration example of a client device.

FIG. 82 is a flowchart illustrating an example of a flow of a reproduction process.

FIG. 83 is a block diagram illustrating a main configuration example of a computer.

### MODE FOR CARRYING OUT THE INVENTION

Hereinafter, modes for carrying out the present disclosure (hereinafter referred to as embodiments) will be described. Note that the description will be made in the following order.
1. Documents and the Like Supporting Technical Content and Technical Terms
2. File Distribution Technology
3. Haptics Medium Support in ISOBMFF
4. Interaction Type Medium Support in ISOBMFF
5. Storage of Haptics Medium as Metadata
6. Associating 3D Data with Interaction Type Medium
7. Interaction Type Medium Support in MPD
8. Matroska Media Container
9. First Embodiment (File Generation Device)
10. Second Embodiment (Client Device)
11. Supplementary Note

### 1. Documents and the Like Supporting Technical Content and Technical Terms

The scope disclosed in the present technology includes, in addition to the contents disclosed in the embodiments, contents described in following Non-Patent Documents and the like known at the time of filing, the contents of other documents referred to in following Non-Patent Documents and the like.
Non-Patent Document 1: (described above)
Non-Patent Document 2: (described above)
Non-Patent Document 3: (described above)
Non-Patent Document 4: (described above)
Non-Patent Document 5: (described above)
Non-Patent Document 6: “Information technology-MPEG systems technologies-Part 12: Image File Format”, MPEG N20585, ISO/IEC FDIS 23008-12 2nd Edition, ISO/IEC JTC 1/SC 29/WG 3, 2021 Sep. 29
Non-Patent Document 7: “Information technology-Dynamic adaptive streaming over HTTP (DASH)—Part 1: Media presentation description and segment formats”, ISO/IEC JTC 1/SC 29/WG 3, WG3_00227, ISO 23009-1:2021 (X), 2021 Jun. 24
Non-Patent Document 8: https://www.matroska.org/Non-Patent Document 9: David Singer, “Text of ISO/IEC FDIS 14496-14 2nd edition including minor revision”. SO/IEC JTC1/SC29/WG11. MPEG01/N17593. 12 Jul. 2019

That is, the contents described in Non-Patent Documents described above, the contents of other documents referred to in Non-Patent Documents described above, and the like are also basis for determining the support requirement. For example, even in a case where syntax and terms such as the glTF 2.0 and its extension described in Non-Patent Documents described above are not directly defined in the present disclosure, they are within the scope of the present disclosure and satisfy the support requirements of the claims. Furthermore, for example, technical terms such as parsing, syntax, and semantics are similarly within the scope of the present disclosure and satisfy the support requirements of the claims even in a case where they are not directly defined in the present disclosure.

### 2. File Distribution Technology

<gltf 2.0>

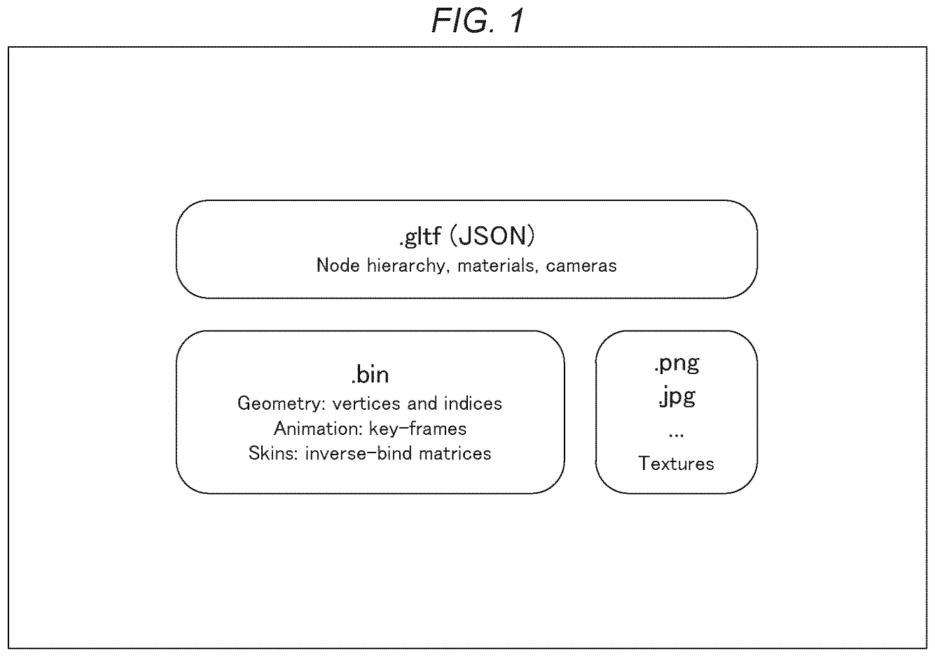

Conventionally, for example, as described in Non-Patent Document 1, there has been the GL Transmission Format (glTF) (registered trademark) 2.0 that is a format for disposing a three-dimensional (3D) object in a three-dimensional space. For example, as illustrated in FIG. 1, the glTF 2.0 includes a JSON format file (.glTF), a binary file (.bin), and an image file (.png, .jpg, or the like). The binary file stores binary data such as geometry and animation. The image file stores data such as texture.

The JSON format file is a scene description file described in JavaScript (registered trademark) Object Notation (JSON). A scene description is metadata describing (a description of) a scene of a 3D content. A description of the scene description defines what kind of scene the scene is. The scene description file is a file that stores such a scene description. In the present disclosure, the scene description file is also referred to as a scene describing file.

A description of the JSON format file includes a list of pairs of a key (KEY) and a value (VALUE). An example of a format of the description will be described below.
“KEY”:“VALUE”

The key includes a character string. The value includes a numerical value, a character string, a true/false value, an array, an object, null, or the like. Furthermore, a plurality of pairs of a key and a value (“KEY”:“VALUE”) can be put together using { } (braces). A pair put together in braces is also referred to as a JSON object. An example of a format of the description will be described below.
“user”:{“id”:1, “name”:“tanaka”}

In the case of the example, a JSON object in which a pair of “id”:1 and a pair of “name”:“tanaka” are put together is defined as a value corresponding to a key (user).

Furthermore, zero or more values can be made to be an array by using [ ] (square brackets). The array is also referred to as a JSON array. For example, a JSON object can be applied as an element of the JSON array. An example of a format of the description will be described below.
test”:[“hoge”, “fuga”, “bar”]
“users”:[{“id”:1, “name”:“tanaka”}, {“id”:2, “name”:“yamada”}, {“id”:3, “name”:“sato”}]

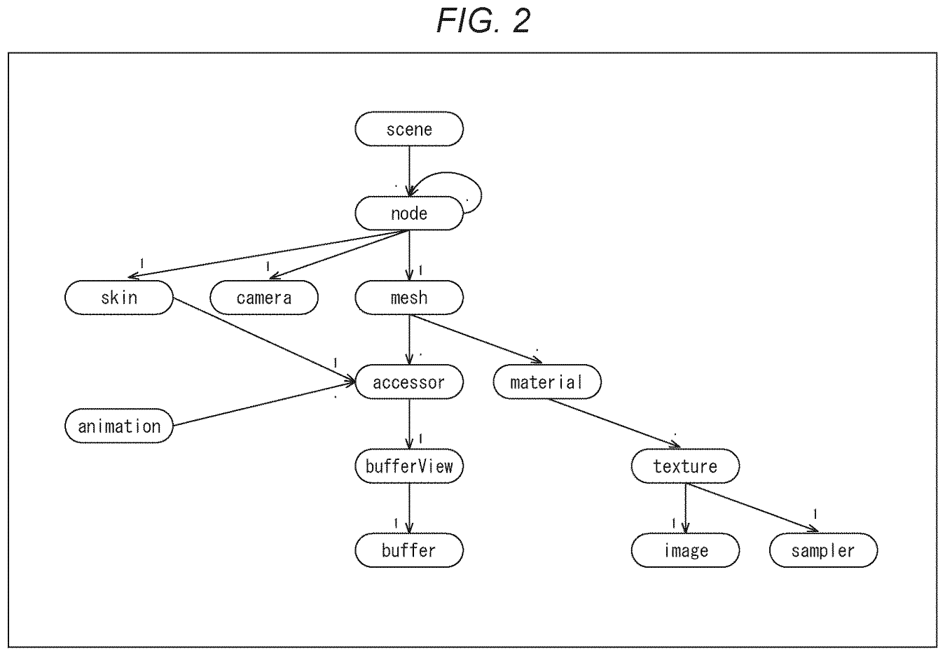

FIG. 2 illustrates glTF objects that can be described at the top of the JSON format file and a reference relationship that they have. Long circles in the tree structure illustrated in FIG. 2 indicate objects, and arrows between the objects indicate reference relationships. As illustrated in FIG. 2, objects such as “scene”, “node”, “mesh”, “camera”, “skin”, “material”, and “texture” are described at the top of the JSON format file.

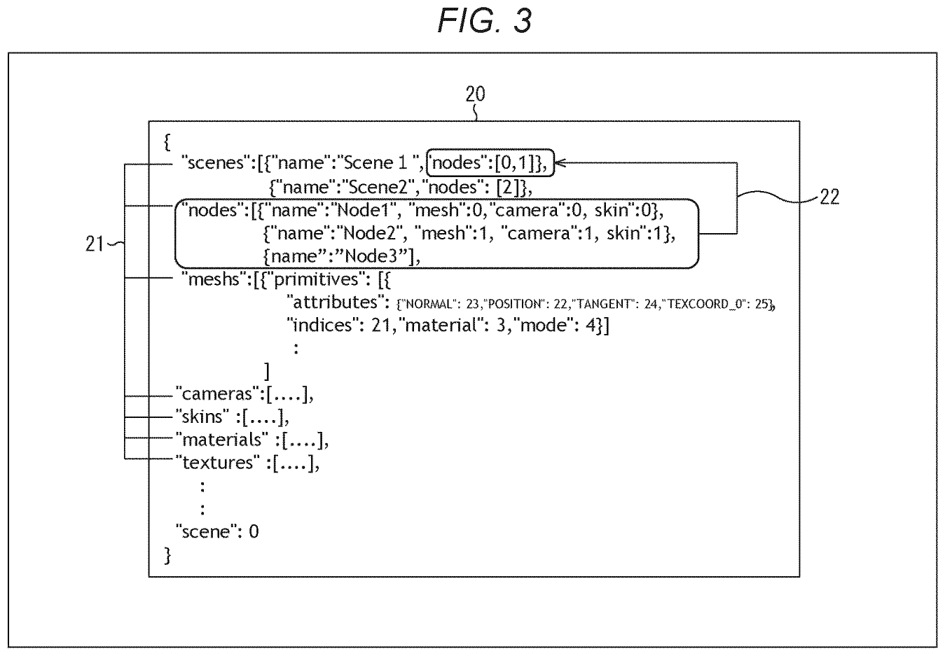

FIG. 3 illustrates a description example of such a JSON format file (scene description). A JSON format file 20 of FIG. 3 illustrates a description example of part of the top. In the JSON format file 20, top-level objects 21 used are all described at the top. The top-level objects 21 are the glTF objects illustrated in FIG. 2. Furthermore, in the JSON format file 20, as indicated as an arrow 22, a reference relationship between objects is indicated. More specifically, the reference relationship is indicated by designating an index of an element of an array of an object to be referred to with a property of a superior object.

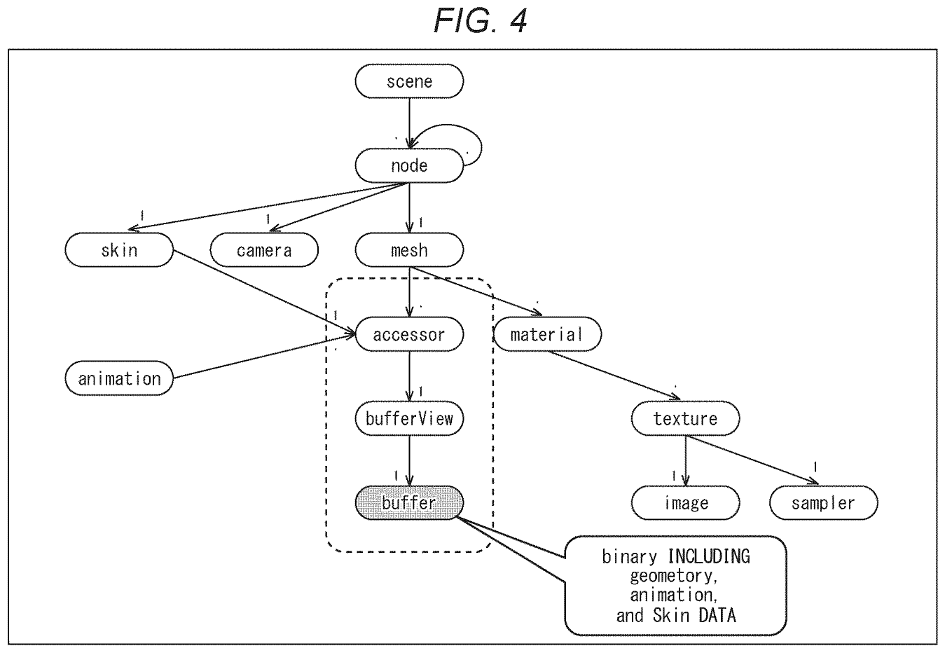

FIG. 4 is a diagram for describing a method of accessing binary data. As illustrated in FIG. 4, the binary data is stored in a buffer object (buffer object). That is, information (for example, a uniform resource identifier (URI) or the like) for accessing the binary data in the buffer object is indicated. In the JSON format file, as illustrated in FIG. 4, it is possible to access the buffer object via an accessor object (accessor object) and a buffer view object (bufferView object), for example, from objects such as a mesh (mesh), a camera (camera), and a skin (skin).

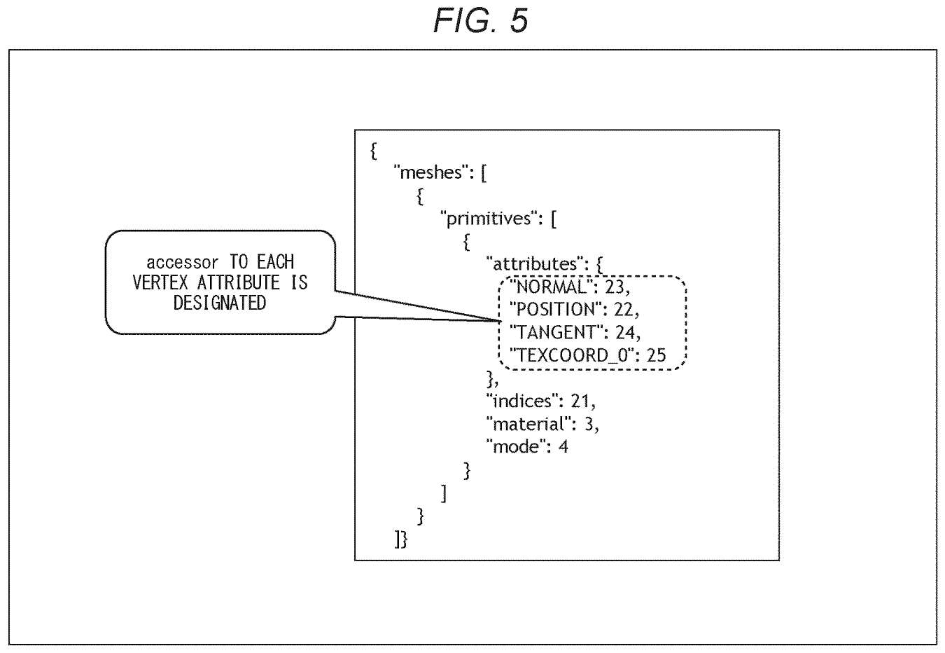

That is, in an object such as the mesh (mesh), the camera (camera), or the skin (skin), an accessor object to be referred to is designated. FIG. 5 illustrates a description example of the mesh object (mesh) in the JSON format file. For example, as illustrated in FIG. 5, in the mesh object, attributes (attribute) of vertices such as NORMAL, POSITION, TANGENT, and TEXCORD_0 are defined as keys, and an accessor object to be referred to is designated as a value for each attribute.

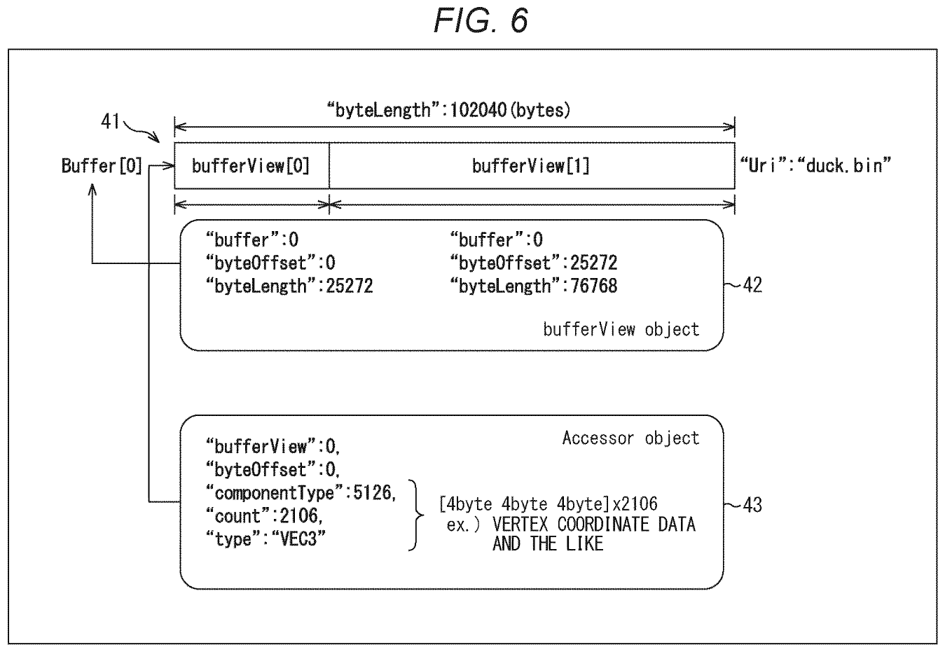

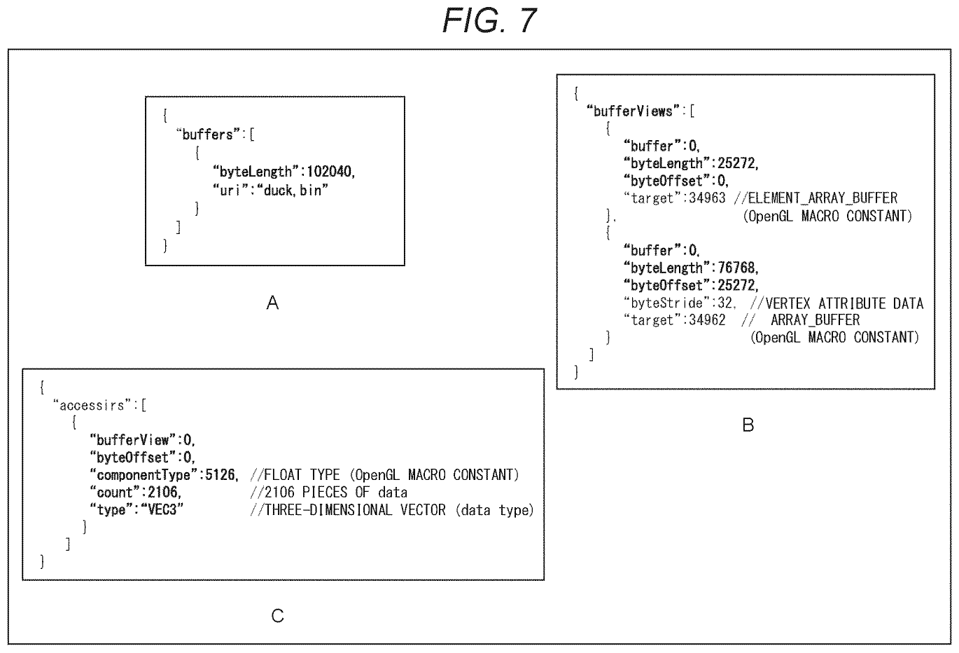

FIG. 6 illustrates a relationship between a buffer object, a buffer view object, and an accessor object. Furthermore, FIG. 7 illustrates a description example of those objects in the JSON format file.

In FIG. 6, a buffer object 41 is an object that stores information (such as URI) for accessing binary data that is actual data, and information indicating a data length (for example, byte length) of the binary data. A of FIG. 7 illustrates a description example of the buffer object 41. It is indicated in ““bytelength”:102040” illustrated in A of FIG. 7 that the byte length of the buffer object 41 is 102040 bytes (bytes) as illustrated in FIG. 6. Furthermore, ““uri”:“duck.bin”” illustrated in A of FIG. 7 indicates that the URI of the buffer object 41 is “duck.bin” as illustrated in FIG. 6.

In FIG. 6, a buffer view object 42 is an object that stores information regarding a subset region of binary data designated in the buffer object 41 (that is, information regarding a partial region of the buffer object 41). B of FIG. 7 illustrates a description example of the buffer view object 42. As illustrated in FIG. 6 and B of FIG. 7, the buffer view object 42 stores, for example, information such as identification information about the buffer object 41 to which the buffer view object 42 belongs, an offset (for example, a byte offset) indicating a position of the buffer view object 42 in the buffer object 41, and a length (for example, a byte length) indicating a data length (for example, a byte length) of the buffer view object 42.

As illustrated in B of FIG. 7, in a case where there is a plurality of buffer view objects, information is described for each buffer view object (that is, for each subset region). For example, information such as ““buffer”:0”, ““bytelength”:25272”, and ““byteOffset”:0” illustrated on the upper side in B of FIG. 7 is information about the first buffer view object 42 (bufferView[0]) illustrated in the buffer object 41 in FIG. 6. Furthermore, the information such as “buffer”:0”, ““bytelength”:76768”, and ““byteOffset”:25272” illustrated on the lower side in B of FIG. 7 is information about the second buffer view object 42 (bufferView[1]) illustrated in the buffer object 41 in FIG. 6.

It is indicated in ““buffer”:0” of the first buffer view object 42 (bufferView[0]) illustrated in B of FIG. 7 that the identification information about the buffer object 41 to which the buffer view object 42 (bufferView[0]) belongs is “0” (Buffer[0]) as illustrated in FIG. 6. Furthermore, ““bytelength”:25272” indicates that the byte length of the buffer view object 42 (bufferView[0]) is 25272 bytes. Moreover, ““byteOffset”:0” indicates that the byte offset of the buffer view object 42 (bufferView[0]) is 0 bytes.

It is indicated in ““buffer”:0” of the second buffer view object 42 (bufferView[1]) illustrated in B of FIG. 7 that the identification information about the buffer object 41 to which the buffer view object 42 (bufferView[0]) belongs is “0” (Buffer[0]) as illustrated in FIG. 6. Furthermore, ““bytelength”:76768” indicates that the byte length of the buffer view object 42 (bufferView[0]) is 76768 bytes. Moreover, ““byteOffset”:25272” indicates that the byte offset of the buffer view object 42 (bufferView[0]) is 25272 bytes.

In FIG. 6, an accessor object 43 is an object that stores information regarding a method of interpreting data of the buffer view object 42. C of FIG. 7 illustrates a description example of the accessor object 43. As illustrated in C of FIG. 6 or 7, the accessor object 43 stores, for example, information such as identification information about the buffer view object 42 to which the accessor object 43 belongs, an offset (for example, byte offset) indicating a position of the buffer view object 42 in the buffer object 41, a component type of the buffer view object 42, the number of pieces of data stored in the buffer view object 42, a type of data stored in the buffer view object 42. These pieces of information are described for each buffer view object.

In the example in C of FIG. 7, information is indicated such as ““bufferView”:0”, ““byteOffset”:0”, ““componentType”:5126”, ““count”:2106”, and ““type”:“VEC3””. It is indicated in ““bufferView”:0” that the identification information about the buffer view object 42 to which the accessor object 43 belongs is “0” (bufferView [0]) as illustrated in FIG. 6. Furthermore, ““byteOffset”:0” indicates that the byte offset of the buffer view object 42 (bufferView[0]) is 0 bytes. Moreover, ““componentType”:5126” indicates that the component type is a FLOAT type (OpenGL macro constant).

Furthermore, ““count”:2106” indicates that the number of pieces of data stored in the buffer view object 42 (bufferView[0]) is 2106. Moreover, ““type”:“VEC3”” indicates that (the type of) the data stored in the buffer view object 42 (bufferView[0]) is a three-dimensional vector.

Accesses to data other than an image (image) are all defined (by designating an accessor index) by reference to the accessor object 43.

Next, a method of designating a 3D object of a point cloud in a scene description (JSON format file) conforming to such a glTF 2.0 will be described. The point cloud is a 3D content expressing a three-dimensional structure (three-dimensional shaped object) as a set of a large number of points. Data of the point cloud includes position information (also referred to as geometry) and attribute information (also referred to as an attribute) of each point. The attribute can include any information. For example, color information, reflectance information, normal line information, and the like regarding each point may be included in the attribute. As described above, the point cloud has a relatively simple data structure and can express any three-dimensional structure with a sufficient accuracy by using a sufficiently large number of points.

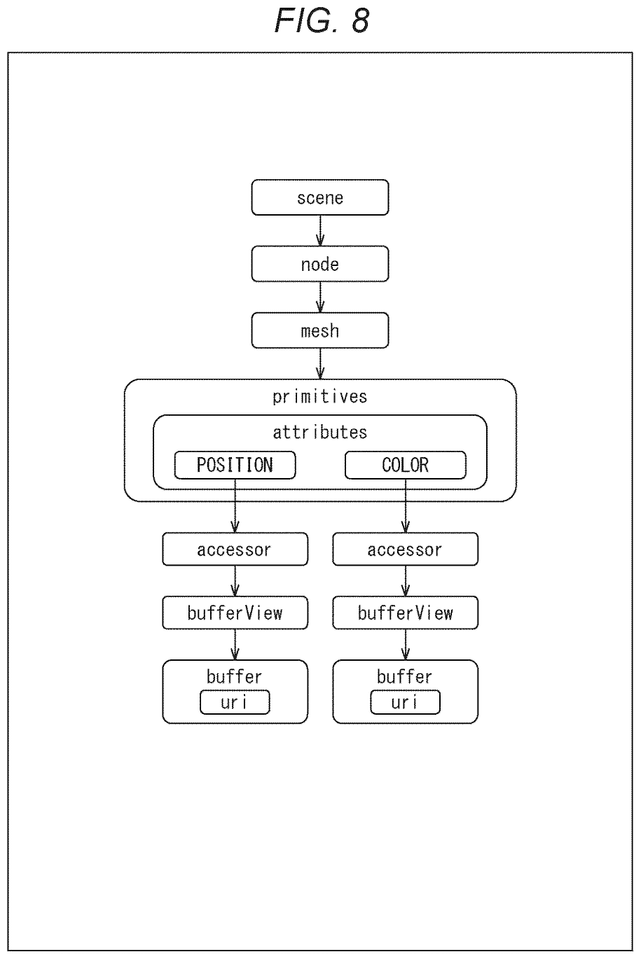

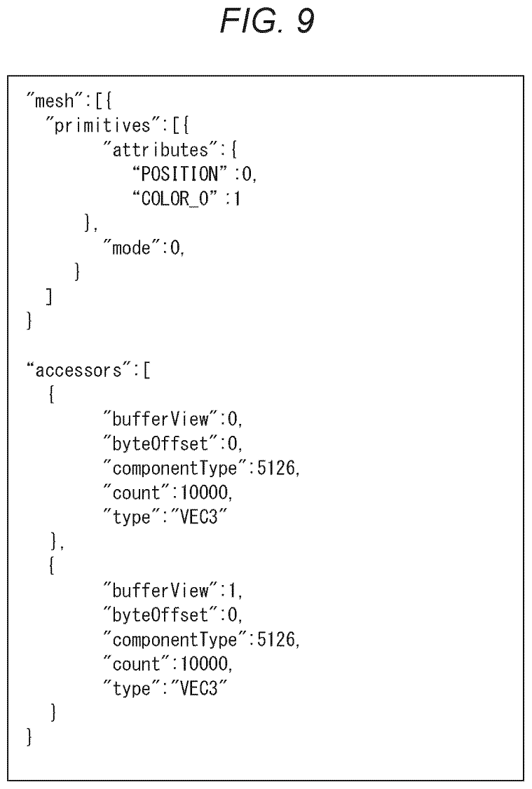

In a case where the point cloud is unchanging in the time direction (also referred to as static), a mesh.primitives object of the glTF 2.0 is used to designate the 3D object. FIG. 8 is a diagram illustrating a configuration example of an object in a scene description in a case where the point cloud is static. FIG. 9 is a diagram illustrating a description example of the scene description.

As illustrated in FIG. 9, the mode of the primitives object is designated 0 indicating that data (data) is handled as a point (point) of a point cloud. As illustrated in FIGS. 8 and 9, in the position property (POSITION property) of the attributes object in mesh.primitives, an accessor (accessor) to a buffer (buffer) that stores position information about the point (Point) is designated. Similarly, in the color property (COLOR property) of the attributes object, an accessor (accessor) to a buffer (buffer) that stores color information about the point (Point) is designated. There may be one buffer (buffer) and one buffer view (bufferView) (data (data) may be stored in one file (file)).

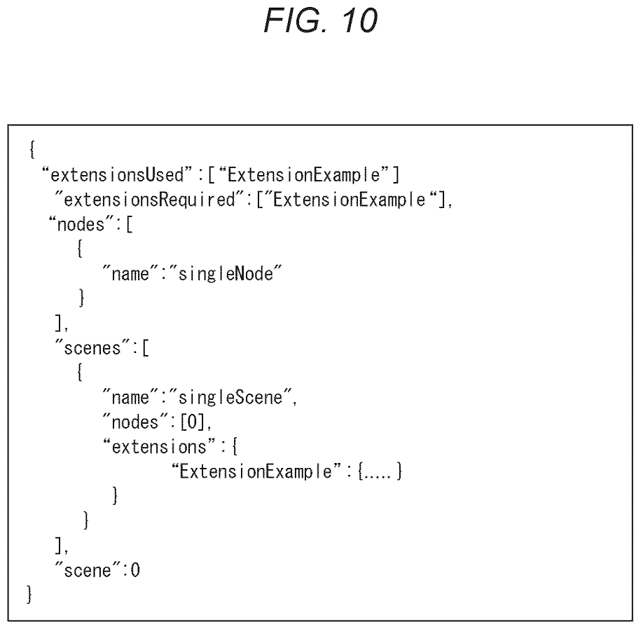

Next, an extension of an object of such a scene description will be described. Each object of the glTF 2.0 can store a newly defined object in an extension object (extension object). FIG. 10 illustrates a description example in a case where a newly defined object (ExtensionExample) is specified. As illustrated in FIG. 10, in a case where a newly defined extension is used, an extension object name (in the case of the example in FIG. 10, ExtensionExample) of the extension is described in “extensionUsed” and “extensionRequired”. As a result, it is indicated that the extension is an extension that is used or is an extension required for loading.

### <Client Process>

Next, processing by a client device in MPEG-I scene description will be described. The client device acquires a scene description, acquires data of a 3D object on the basis of the scene description, and generates a display image using the scene description and the data of the 3D object.

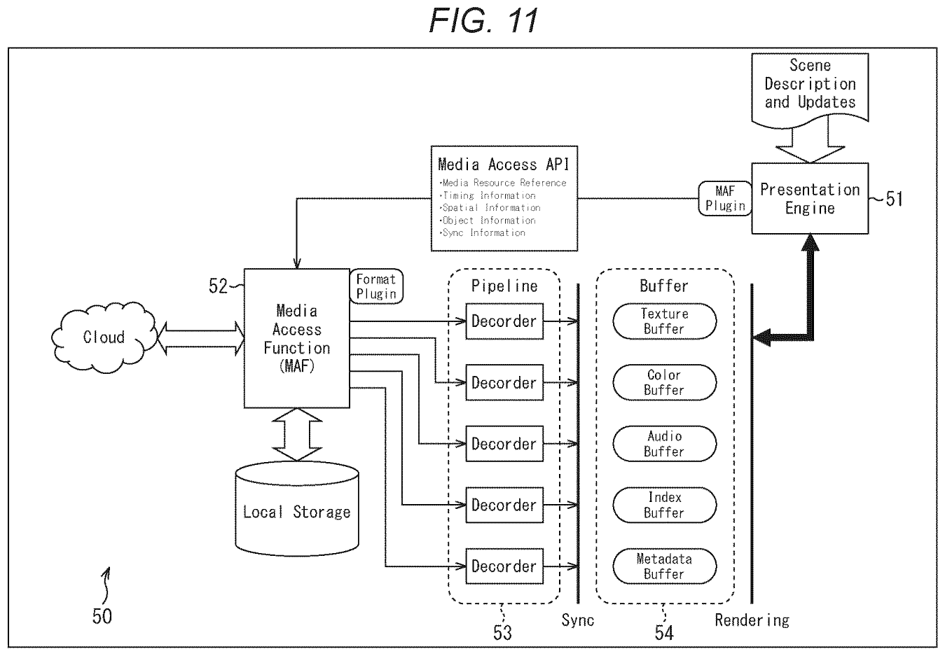

As described in Non-Patent Document 2, in the client device, a presentation engine, a media access function, or the like performs processing. For example, as illustrated in FIG. 11, a presentation engine 51 of a client device 50 acquires an initial value of a scene description and information (hereinafter, also referred to as update information) for updating the scene description, and generates the scene description at a processing target time. Then, the presentation engine 51 parses the scene description and specifies a medium (moving image, audio, or the like) to be reproduced. Then, the presentation engine 51 requests a media access function 52 to acquire the medium via a media access application program interface (API). Furthermore, the presentation engine 51 also performs setting of a pipeline process, designation of a buffer, and the like.

The media access function 52 acquires various types of data of the medium requested by the presentation engine 51 from a cloud, a local storage, or the like. The media access function 52 supplies the acquired various types of data (coded data) of the medium to a pipeline 53.

The pipeline 53 decodes the supplied various types of data (coded data) of the medium by the pipeline process, and supplies a decoding result thereof to a buffer 54. The buffer 54 holds the supplied various types of data of the medium.

The presentation engine 51 performs rendering or the like using various types of data of the medium held in the buffer 54.

### <Application of Timed Media>

In recent years, for example, as described in Non-Patent Document 2, in the MPEG-I scene description, it has been studied to extend the glTF 2.0 and to apply a timed medium (Timed media) as 3D object content. The timed media is media data that changes in the time axis direction like a moving image in a two-dimensional image.

The glTF has been applicable only to still image data as media data (3D object content). That is, the glTF has not been applicable to media data of a moving image. In a case where a 3D object is moved, animation (a method of switching a still image along the time axis) has been applied.

In the MPEG-I scene description, it has been studied to apply the glTF 2.0, apply a JSON format file as a scene description, and further extend the glTF so that timed media (for example, video data) can be handled as media data. In order to handle timed media, for example, an extension is performed as below.

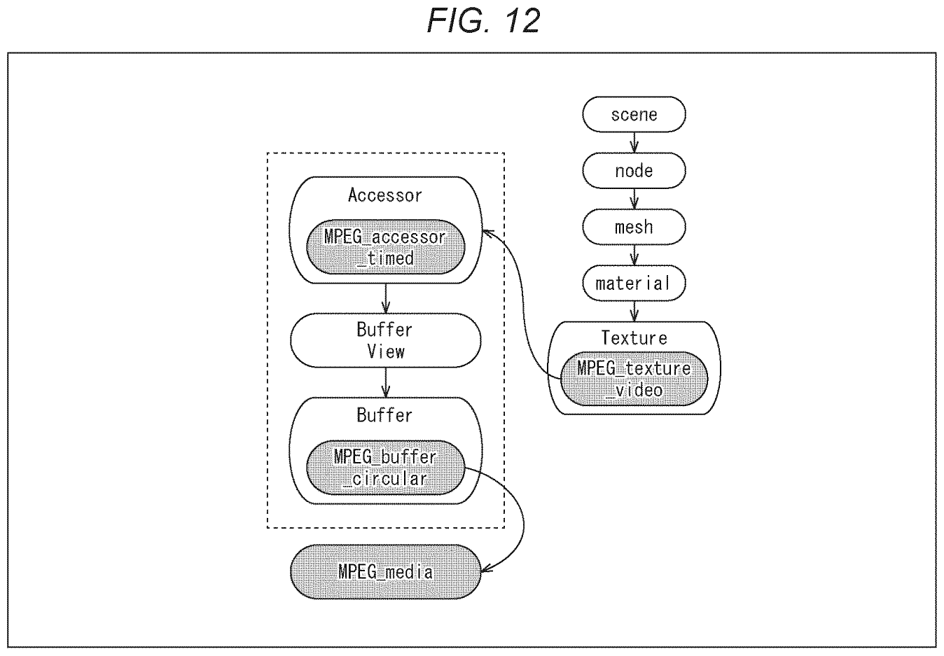

FIG. 12 is a diagram for describing the extension for handling timed media. In the example in FIG. 12, an MPEG media object (MPEG media) is an extension of glTF, and is an object that designates attributes of MPEG media such as video data, for example, uri, track, renderingRate, startTime, and the like.

Furthermore, as illustrated in FIG. 12, an MPEG texture video object (MPEG texture video) is provided as an extension object (extensions) of a texture object (texture). In the MPEG texture video object, information about an accessor corresponding to a buffer object to be accessed is stored. That is, the MPEG texture video object is an object that designates an index of an accessor (accessor) corresponding to a buffer (buffer) in which texture media (texture media) designated by the MPEG media object (MPEG media) are decoded and stored.

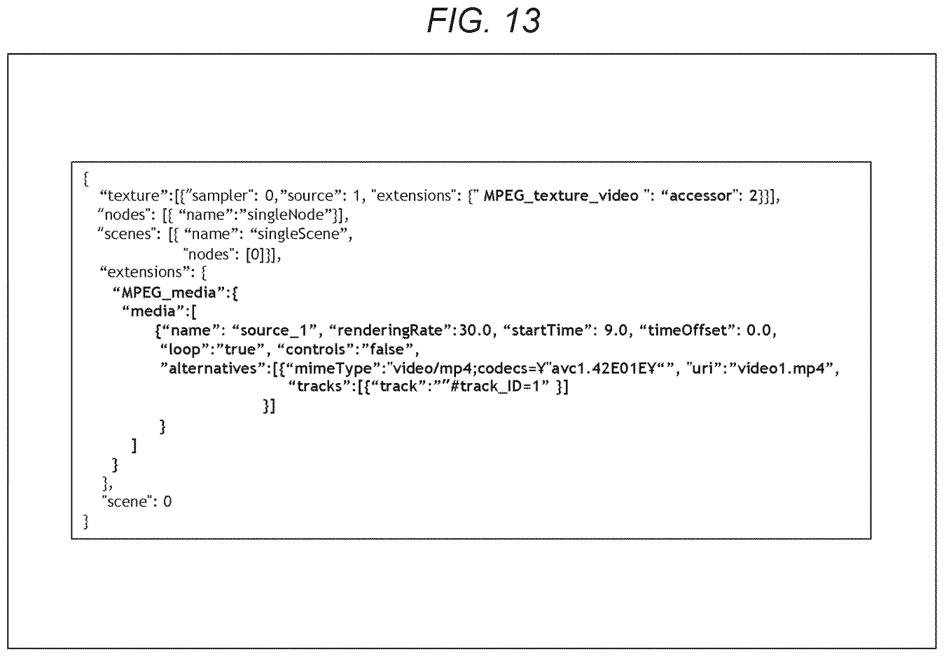

FIG. 13 is a diagram illustrating a description example of the MPEG media object (MPEG media) and the MPEG texture video object (MPEG texture video) in the scene description, for describing the extension for handling timed media. In the case of the example in FIG. 13, in the second line from the top, an MPEG texture video object (MPEG texture video) is set as an extension object (extensions) of a texture object (texture) as described below. Then, the index (“2” in this example) of the accessor is designated as a value of the MPEG video texture object.
“texture”:[{“sampler”:0, “source”:1, “extensions”:{“MPEG texture video “:“accessor”:2}}],

Furthermore, in the case of the example in FIG. 13, in the 7th to 16th lines from the top, an MPEG media object (MPEG media) is set as an extension object (extensions) of the glTF as described below. Then, as values of the MPEG media object, various pieces of information regarding the MPEG media object are stored, for example, encoding and URI of the MPEG media object, and the like.

```
  “MPEG_media”:{
  “media”:[
  {“name”:“source_1”, “renderingRate”:30.0,
“startTime”:9.0, “timeOffset”:0.0,
  “loop”:“true”, “controls”:“false”,
  “alternatives”:[{“mimeType”:“video/mp4;codecs=¥”avc
1.42E01E¥””,“uri”:“video1.mp4”,
  “tracks”:[{“track”:““#track_ID=1”}]
  }]
  }
  ]
  }
```

Furthermore, pieces of frame data are decoded and sequentially stored in a buffer, but its position and the like change, and thus, a mechanism is provided in which the changing information is stored in the scene description and a renderer is enabled to read data. For example, as illustrated in FIG. 12, an MPEG buffer circular object (MPEG_buffer_circular) is provided as an extension object (extensions) of the buffer object (buffer). Information for dynamically storing data in the buffer object is stored in the MPEG buffer circular object. Information is stored in the MPEG buffer circular object, such as information indicating a data length of a buffer header (bufferHeader), and information indicating the number of frames, for example. Note that the buffer header stores information such as an index (index), and a time stamp and a data length of stored frame data, for example.

Furthermore, as illustrated in FIG. 12, an MPEG accessor timed object (MPEG_timed_accessor) is provided as an extension object (extensions) of the accessor object (accessor). In this case, since the media data is a moving image, the buffer view object (bufferView) to be referred to in the time direction can change (the position can change). Thus, information indicating the buffer view object to be referred to is stored in the MPEG accessor timed object. For example, the MPEG accessor timed object stores information indicating a reference to the buffer view object (bufferView) in which a timed accessor information header (timedAccessor information header) is described. Note that the timed accessor information header is, for example, header information that stores information in the dynamically changing accessor object and buffer view object.

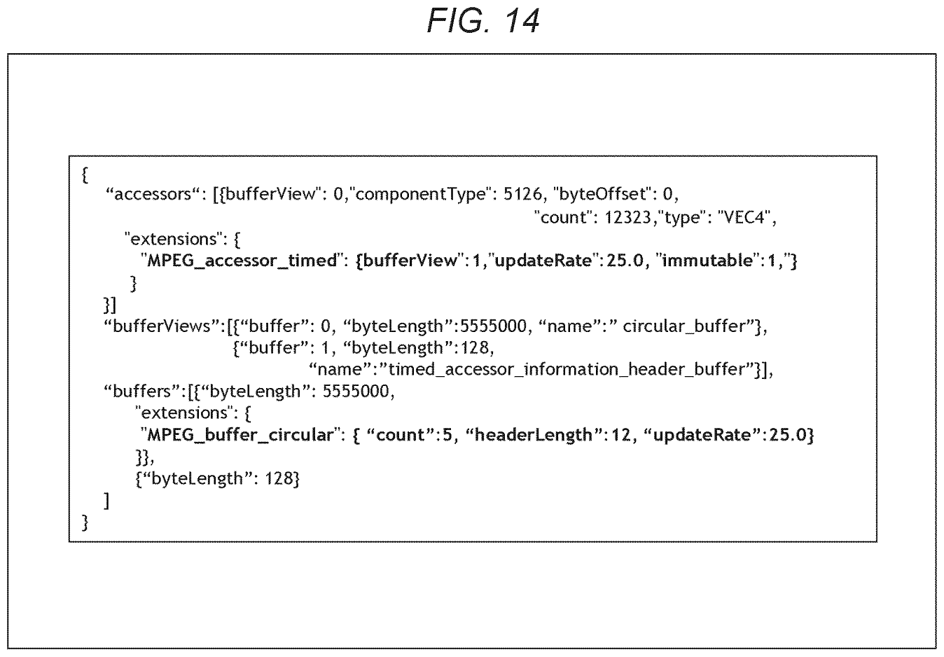

FIG. 14 is a diagram illustrating a description example of the MPEG buffer circular object (MPEG_buffer_circular) and the MPEG accessor timed object (MPEG_accessor_timed) in the scene description, for describing the extension for handling timed media. In the case of the example in FIG. 14, in the fifth line from the top, the MPEG accessor timed object (MPEG_accessor_timed) is set as an extension object (extensions) of the accessor object (accessors) as described below. Then, parameters such as an index (“1” in this example) of the buffer view object, an update rate (updataRate), and immutable information (immutable) and values thereof are designated as values of the MPEG accessor timed object.
“MPEG_accessor_timed”:{“bufferView”:1, “updateRate”:25.0, “immutable”:1,”}

Furthermore, in the case of the example in FIG. 14, in the 13th line from the top, the MPEG buffer circular object (MPEG_buffer_circular) is set as an extension object (extensions) of the buffer object (buffer) as described below. Then, parameters such as a buffer frame count (count), a header length (headerLength), and an update rate (updataRate) and values thereof are designated as values of the MPEG buffer circular object.
“MPEG_buffer_circular”:{“count”:5, “headerLength”:12, “updateRate”:25.0}

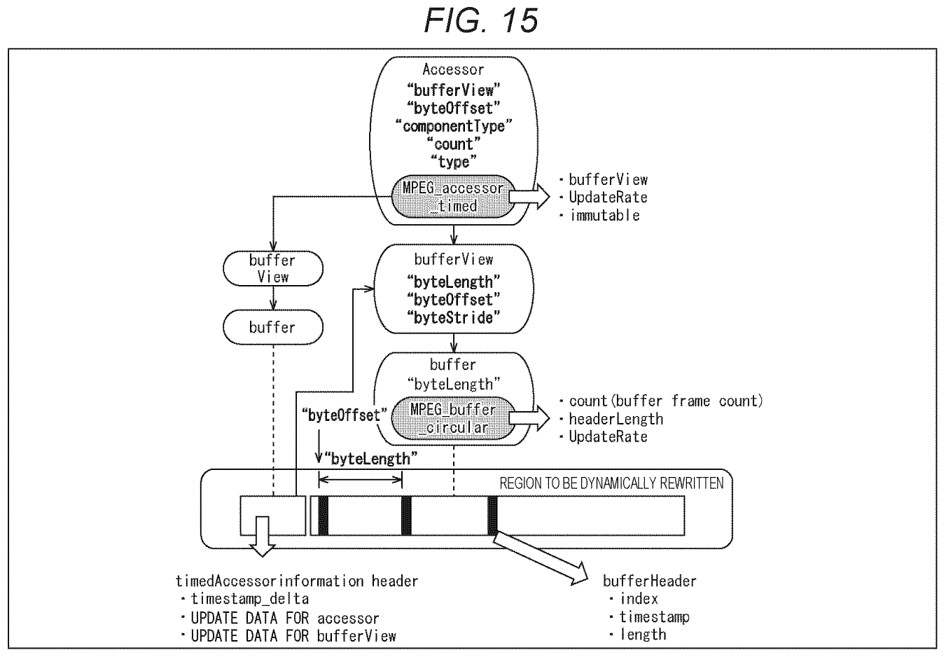

FIG. 15 is a diagram for describing the extension for handling timed media. FIG. 15 illustrates an example of a relationship between the MPEG accessor timed object or the MPEG buffer circular object, and the accessor object, the buffer view object, and the buffer object.

As described above, the MPEG buffer circular object of the buffer object stores information necessary for storing data that changes with time in a buffer region indicated by the buffer object, such as the buffer frame count (count), the header length (headerLength), and the update rate (updataRate). Furthermore, parameters such as an index (idex), a time stamp (timestamp), and a data length (length) are stored in the buffer header (bufferHeader) that is a header of the buffer region.

As described above, the MPEG accessor timed object of the accessor object stores information regarding the buffer view object to be referred to, such as the index of the buffer view object (bufferView), the update rate (updataRate), and the immutable information (immutable). Furthermore, the MPEG accessor timed object stores information regarding the buffer view object in which the timed accessor information header to be referred to is stored. The timed accessor information header can store a timestamp delta (timestamp delta), update data for the accessor object, update data for the buffer view object, and the like.

<Client Process when MPEG Texture Video is Used>

The scene description is spatial arrangement information for disposing one or more 3D objects in a 3D space. The content of the scene description can be updated along the time axis. That is, arrangement of the 3D objects can be updated with a lapse of time. A client process performed in the client device at that time will be described.

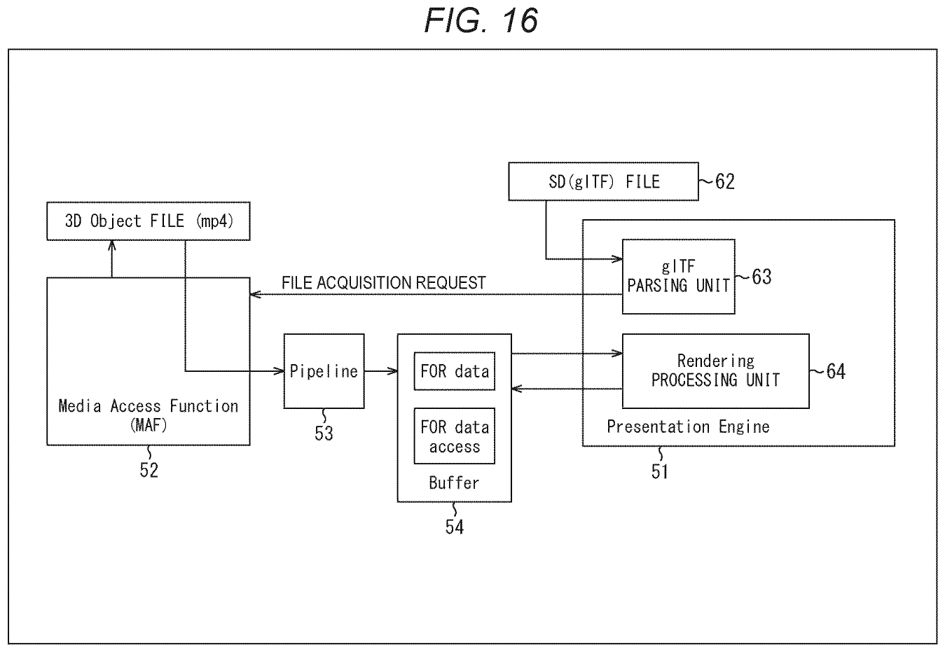

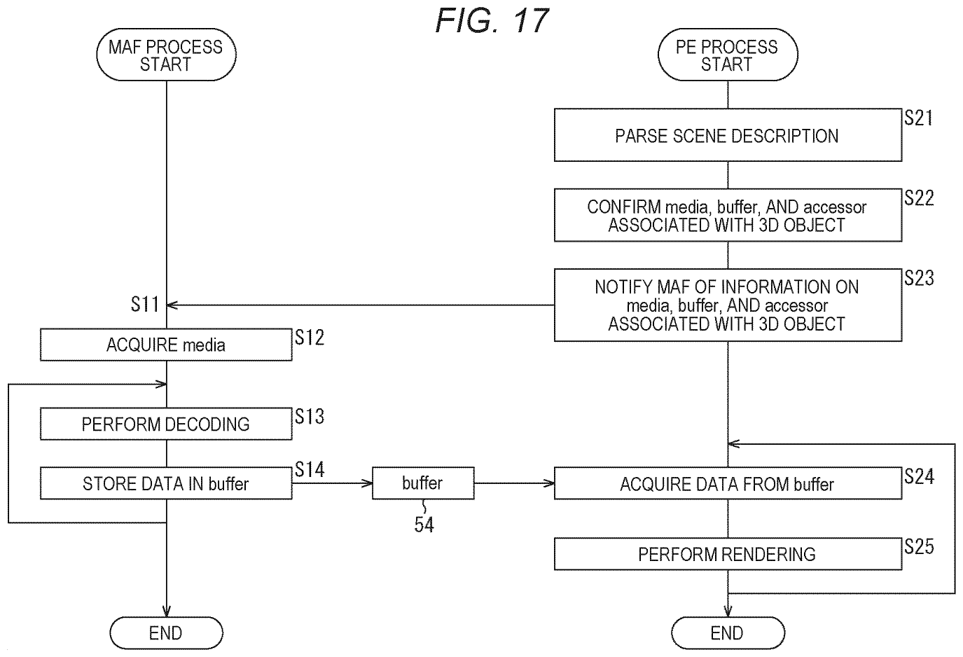

FIG. 16 is a main configuration example regarding the client process, of the client device, and FIG. 17 is a flowchart illustrating an example of a flow of the client process. As illustrated in FIG. 16, the client device includes a presentation engine (PresentaionEngine (hereinafter, also referred to as PE)) 51, a media access function (MediaAccessFuncon (hereinafter, also referred to as MAF)) 52, a pipeline (Pipeline) 53, and a buffer (Buffer) 54. The presentation engine (PE) 51 includes a glTF parsing unit 63 and a rendering processing unit 64.

The presentation engine (PE) 51 causes the media access function 52 to acquire a medium, acquires data thereof via the buffer 54, and performs processing related to display, and the like. Specifically, for example, the processing is performed in the following flow.

When the client process is started, the glTF parsing unit 63 of the presentation engine (PE) 51 starts a PE process as in the example in FIG. 17, and in step S21, acquires an SD (glTF) file 62 that is a scene description file and parses the scene description.

In step S22, the glTF parsing unit 63 confirms a medium (media) associated with a 3D object (texture), a buffer (buffer) that stores the medium after processing, and an accessor (accessor). In step S23, the glTF parsing unit 63 notifies the media access function 52 of confirmed information as a file acquisition request.

The media access function (MAF) 52 starts a MAF process as in the example in FIG. 17, and acquires the notification in step S11. In step S12, the media access function 52 acquires a medium (3D object file (mp4)) on the basis of the notification.

In step S13, the media access function 52 decodes the acquired medium (3D object file (mp4)). In step S14, the media access function 52 stores data of the medium obtained by the decoding in the buffer 54 on the basis of the notification from the presentation engine (PE 51).

In step S24, the rendering processing unit 64 of the presentation engine 51 reads (acquires) the data from the buffer 54 at an appropriate timing. In step S25, the rendering processing unit 64 performs rendering using the acquired data and generates a display image.

The media access function 52 repeats the processing in steps S13 and S14 to execute the processing for each time (each frame). Furthermore, the rendering processing unit 64 of the presentation engine 51 repeats the processing in steps S24 and S25 to execute the processing for each time (each frame). When the processing ends for all the frames, the media access function 52 ends the MAF process, and the presentation engine 51 ends the PE process. That is, the client process ends.

### <Meta Item>

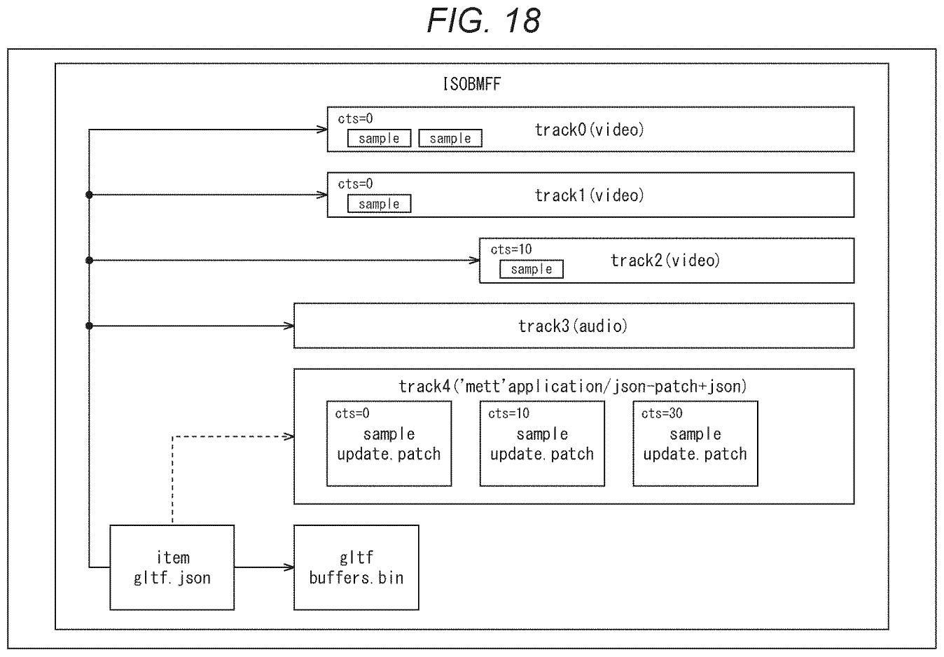

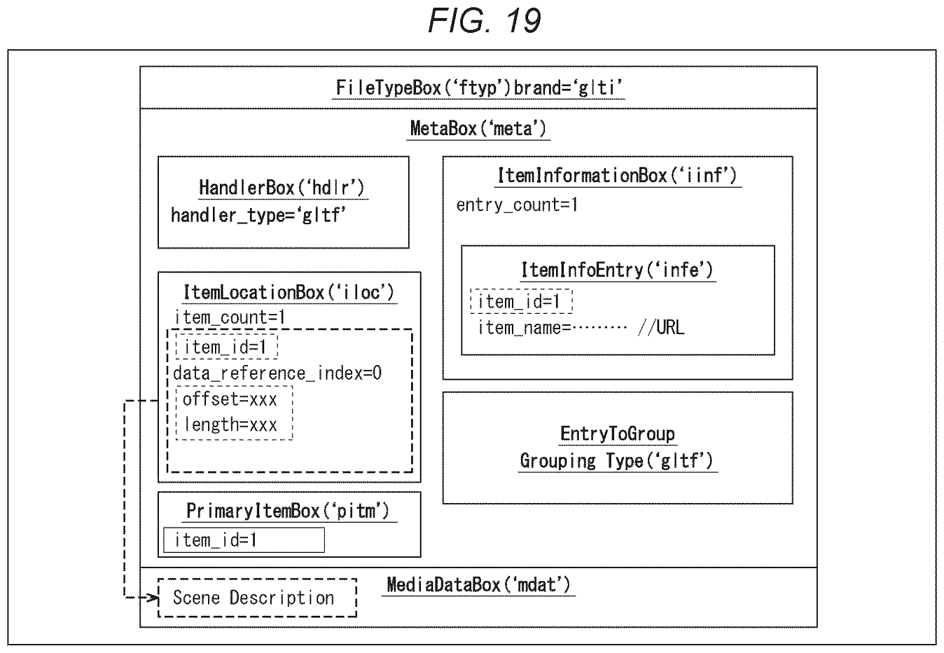

Non-Patent Document 2 also describes a method of storing a glTF item in International Organization for Standardization Base Media File Format (ISOBMFF) as metadata instead of a track. ISBMFF is a file container specification of moving image compression international standard technology Moving Picture Experts Group-4 (MPEG-4), and is, for example, a distribution file for distributing content data such as a moving image (MP4 file). In the example in FIG. 18, an initial file (gltf buffers.bin) of the scene description is stored as an item (metadata) instead of a track, and an update file (sample update.patch) that is timed data is stored in a track. FIG. 19 is a diagram illustrating an example of the meta-box (MetaBox (‘meta’)) in that case. Information associating an item as metadata is stored in the meta-box.

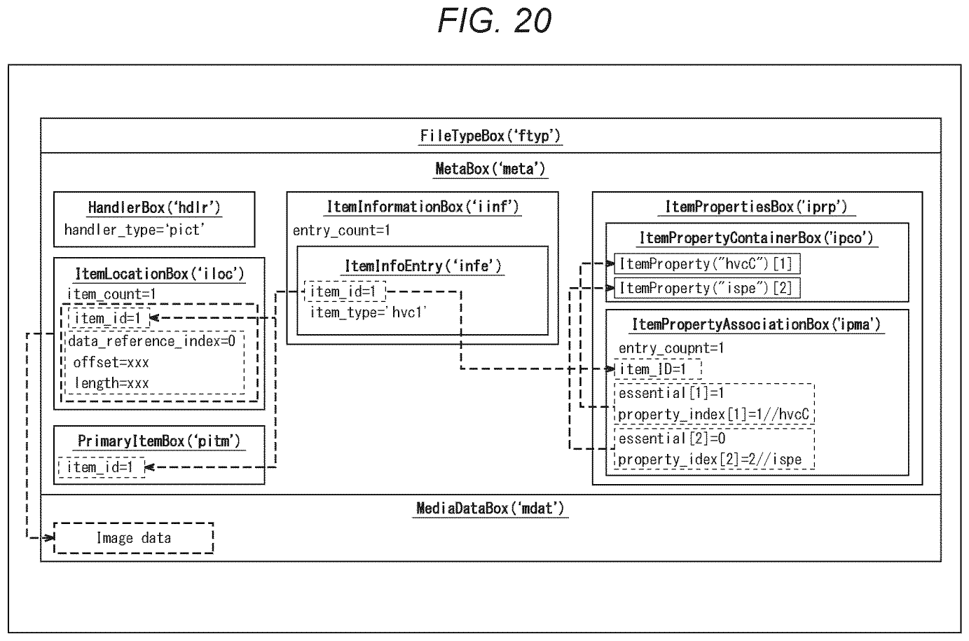

Non-Patent Document 6 describes a method of storing image data of a still image encoded by High Efficiency Video Coding (HEVC), which is an encoding method for moving images, in ISOBMFF as metadata, and this method is applied. FIG. 20 illustrates an example of the meta-box (MetaBox (‘meta’)) in that case.

As illustrated in FIG. 20, a type (handler type) of the item is defined in a handler box (HandlerBox(‘hdlr’)) of the meta-box. In this case, since the item is a still image, a definition is made as “handler type=‘pict’”. Furthermore, identification information (item_id) about the item is defined in an item info entry (ItemInfoEntry(‘infe’)) of an item information box (ItemInformationBox(‘iinf’)) (item_id=1). The identification information (item_id) associates information regarding the item in the meta-box. Furthermore, an encoding tool (item type) necessary for the item is defined. In this case, since the item is encoded by HEVC, a definition is made as “item type=hvc1”. Furthermore, in an item location box (ItemLocationBox(‘iloc’)), a storage location (offset and length) of the item is indicated. The item (in this case, image data) associated as metadata is. stored in a media data box (MediaDataBox(‘mdat’)).

Furthermore, in an item property container box (ItemPropertyContainerBox(‘ipco’)), configuration information (itemProperty(“hvcC”)) and size information (itemProperty(“ispe”)) on the item are defined. Then, in an item property association box (ItemPropertyAssociationBox(‘ipma’)), the item is associated with information necessary for decoding the item (information defined in the item property container box).

By using such a mechanism, it is possible to associate the initial file of the scene description as metadata as illustrated in FIG. 19. For example, in the handler box (HandlerBox(‘hdlr’)), it is indicated that the item is the initial file (glTF) of the scene description (handler type=‘gltf’). Furthermore, in the item location box (ItemLocationBox(‘iloc’)), a storage location (offset and length) of the initial file (Scene Description) of the scene description are indicated.

### <Haptics Media>

Meanwhile, for example, as described in Non-Patent Document 3, standardization of encoding transmission technology for tactile information (also referred to as haptics media) has started in addition to that for audio media and video media that are components of 2D video content and 3 DoF/6 DoF video content. A haptics medium is information expressing a virtual sense using vibration or the like, for example. The haptics medium is used in association with, for example, 3D data that is information expressing a three-dimensional space. The 3D data includes, for example, content expressing a three-dimensional shape of a 3D object disposed in a three-dimensional space (for example, a mesh, a point cloud, or the like), video content and audio content developed in the three-dimensional space (for example, 6 DoF content of video and audio), and the like.

Note that a medium associated with 3D data may be any information, and is not limited to the haptics medium. For example, an image, audio, or the like may be included in the medium. The medium (for example, image, audio, vibration, or the like) associated with the 3D data includes a synchronous type medium to be reproduced in synchronization with progress (change) in the time direction of a scene (state of the three-dimensional space) and an interaction type medium to be reproduced in a case where a predetermined condition is satisfied in the scene by a user operation or the like (that is, reproduced for a predetermined event). The haptics medium of the synchronous type medium is also referred to as a synchronous type haptics medium. Furthermore, a haptics medium of the interaction type medium is also referred to as an interaction type haptics medium. The synchronous type haptics medium is, for example, vibration or the like generated in accordance with a state (so as to express a state of a change in a scene) in a case where wind blows or a 3D object moves. The interaction type haptics medium is, for example, a vibration or the like generated to express a sense in a case where an avatar of a user touches the 3D object, a case where the avatar moves the 3D object, a case where the avatar hits the 3D object, or the like. Of course, these are examples of the haptics medium, and the haptics medium is not limited to these examples.

Furthermore, the medium associated with the 3D data includes a medium that can change in the time direction and a medium that does not change.

The “medium that can change in the time direction” may include, for example, a medium in which reproduction content (action) can change in the time direction. The “medium in which reproduction content can change in the time direction” may include, for example, a moving image, long-time audio information, vibration information, or the like. Furthermore, the “medium in which reproduction content can change in the time direction” may include, for example, a medium to be reproduced only in a predetermined time zone, a medium in which content corresponding to time is reproduced (for example, a medium in which an image to be displayed, audio to be reproduced, a manner of vibration, and the like are switched according to the time), and the like.

Furthermore, the “medium that can change in the time direction” may include, for example, a medium in which an associated reproduction condition (event) can change in the time direction. The “medium in which an associated reproduction condition can change in the time direction” may include, for example, a medium in which content of the event can change in the time direction, such as touching, pushing, or bringing down. Furthermore, the “medium in which an associated reproduction condition can change in the time direction” may include, for example, a medium in which a position where the event occurs can change in the time direction. For example, a medium may be included that is reproduced in a case where the right side of the object is touched at time T1, and is reproduced in a case where the left side of the object is touched at time T2. Of course, any medium may be used as long as change occurs in the time direction, and the medium is not limited to these examples. On the other hand, the “medium that does not change in the time direction” may include, for example, a medium in which the reproduction content (action) does not change in the time direction (a medium in which the action is the same at any time). Furthermore, the “medium that does not change in the time direction” may include, for example, a medium in which the associated reproduction condition (event) does not change in the time direction (a medium in which the content of the event and the position where the event occurs are the same at any time). In the present specification, being able to change in the time direction is also referred to as “dynamic”. For example, a medium that can change in the time direction (Timed media) is also referred to as a dynamic medium. For example, a haptics medium that can change in the time direction is also referred to as a dynamic haptics medium. Furthermore, not changing in the time direction is also referred to as “static”. For example, a medium that does not change in the time direction is also referred to as a static medium. For example, a haptics medium that does not change in the time direction is also referred to as a static haptics medium.

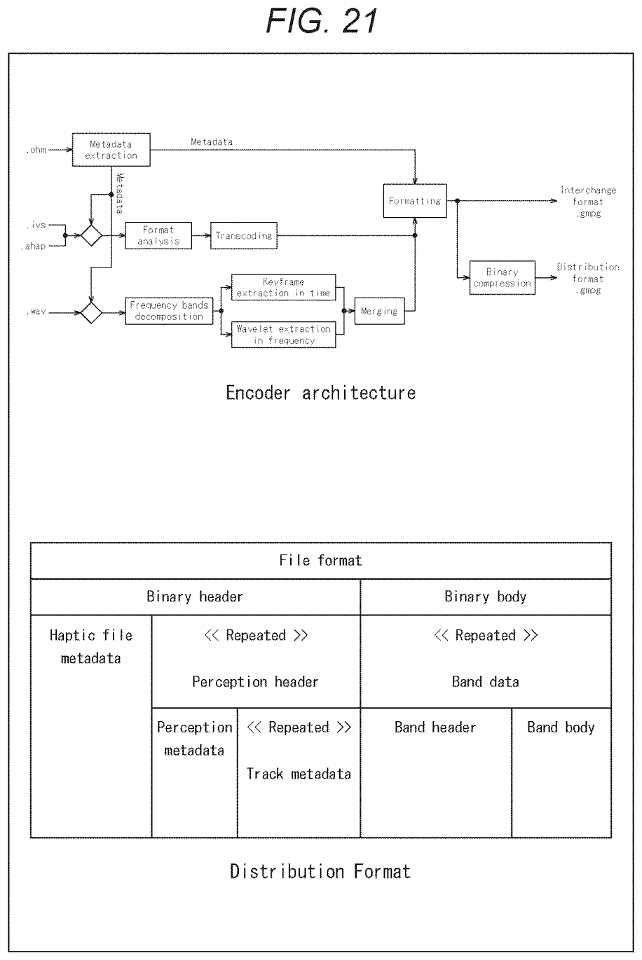

Non-Patent Document 3 proposes an encoding method for such a haptics medium. In the method, a haptics signal (wav) and haptics signal descriptions (ivs, ahap) are encoded using an architecture as illustrated in the upper side of FIG. 21, and an interchange format (gmap) and a distribution format (mpg) are generated. A table in the lower side of FIG. 21 indicates a configuration example of the distribution format. As indicated in the table, a bitstream of a haptics medium includes a binary header and a binary body. In the binary header, characteristics of coded data (Haptics stream) of the haptics medium, a rendering device, information on an encoding method, and the like are stored. Furthermore, the coded data (Haptics stream) of the haptics medium is stored in the binary body.

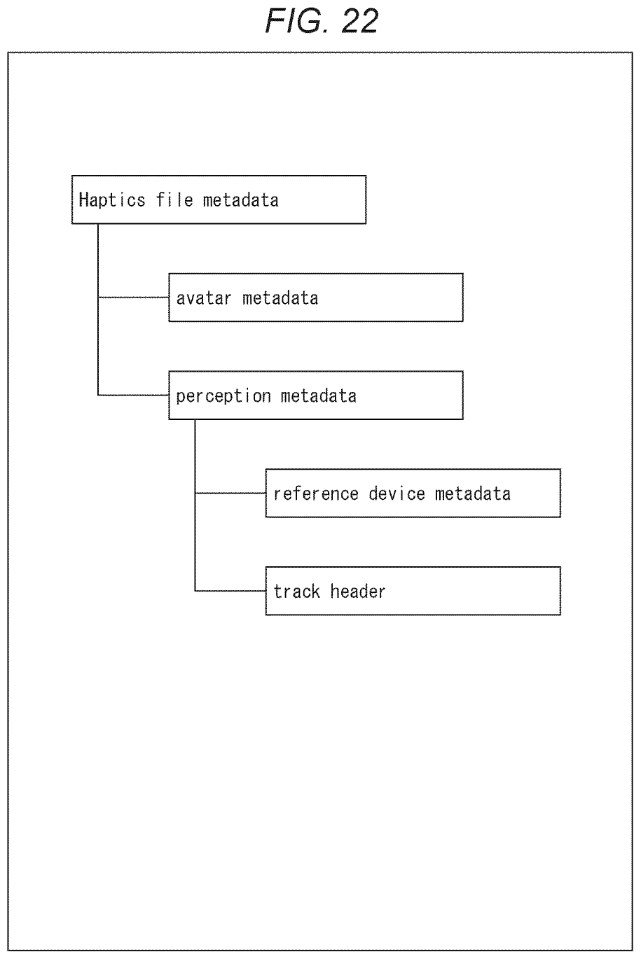

For example, as illustrated in FIG. 22, the binary header includes haptics file metadata (Haptics file metadata), avatar metadata (avatar metadata), perception metadata (perception metadata), reference device metadata (reference device metadata), and a track header, and has a hierarchical structure as illustrated in FIG. 22.

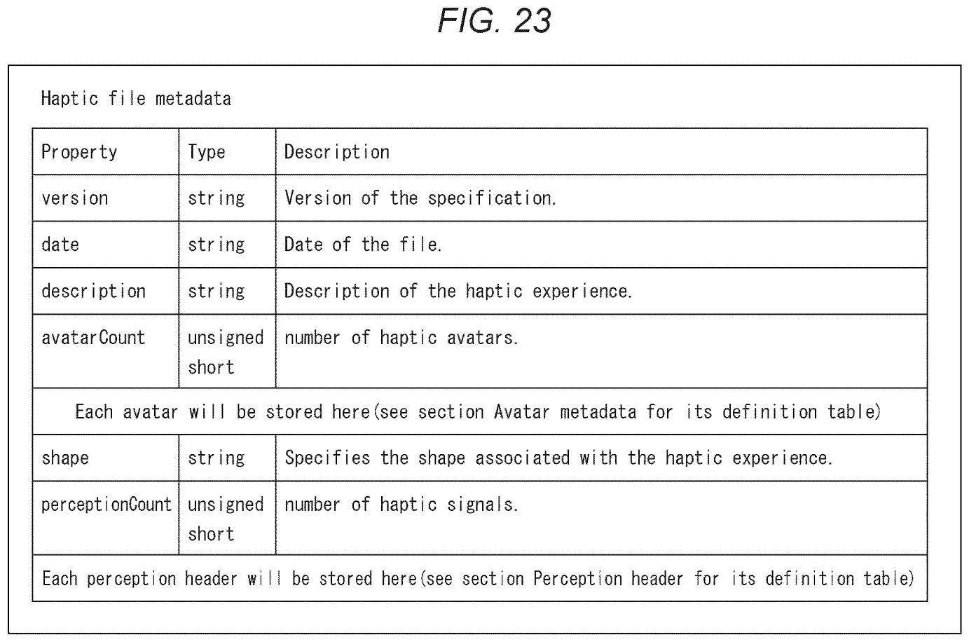

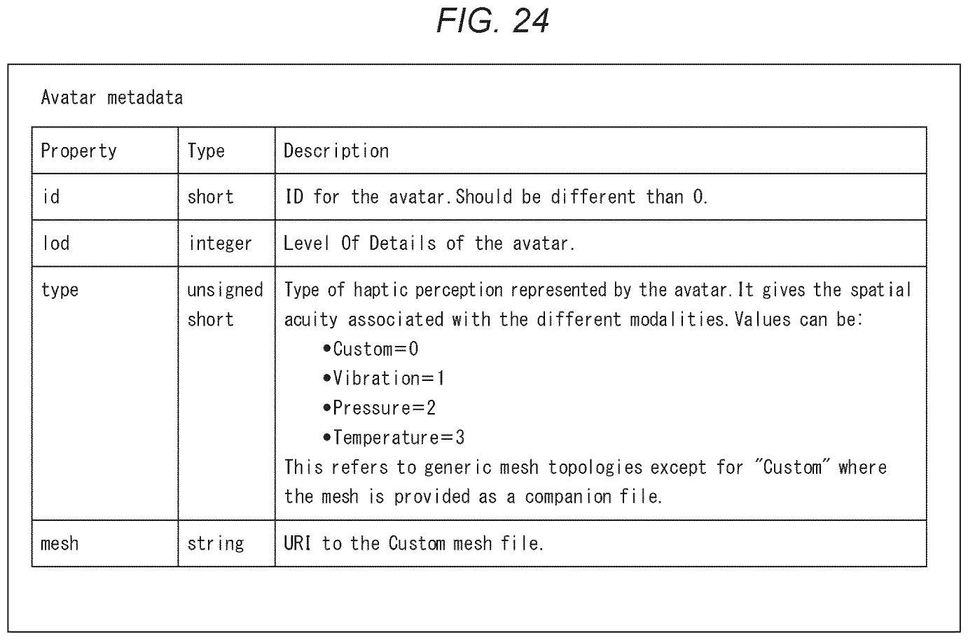

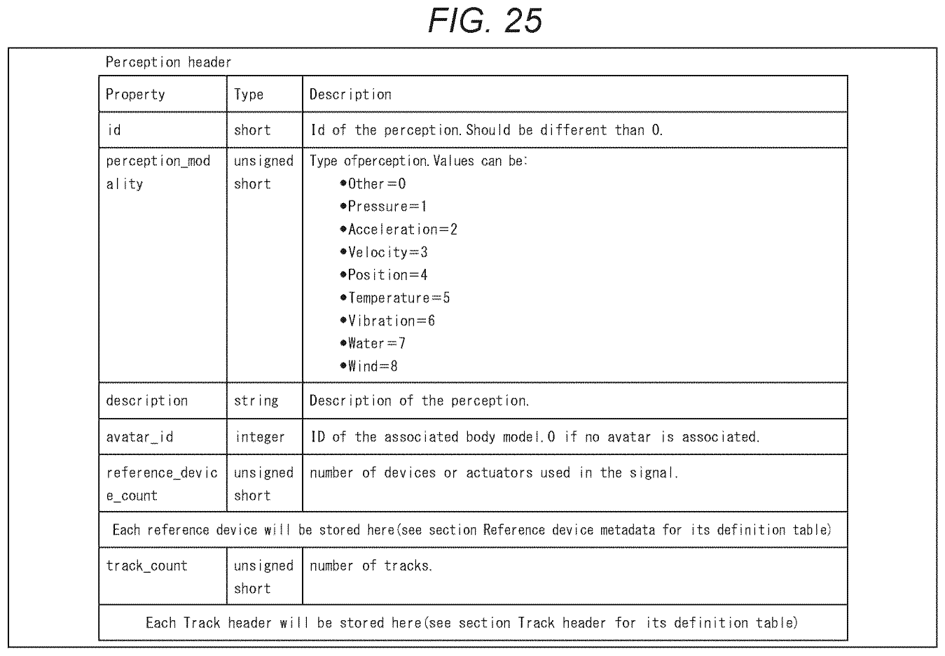

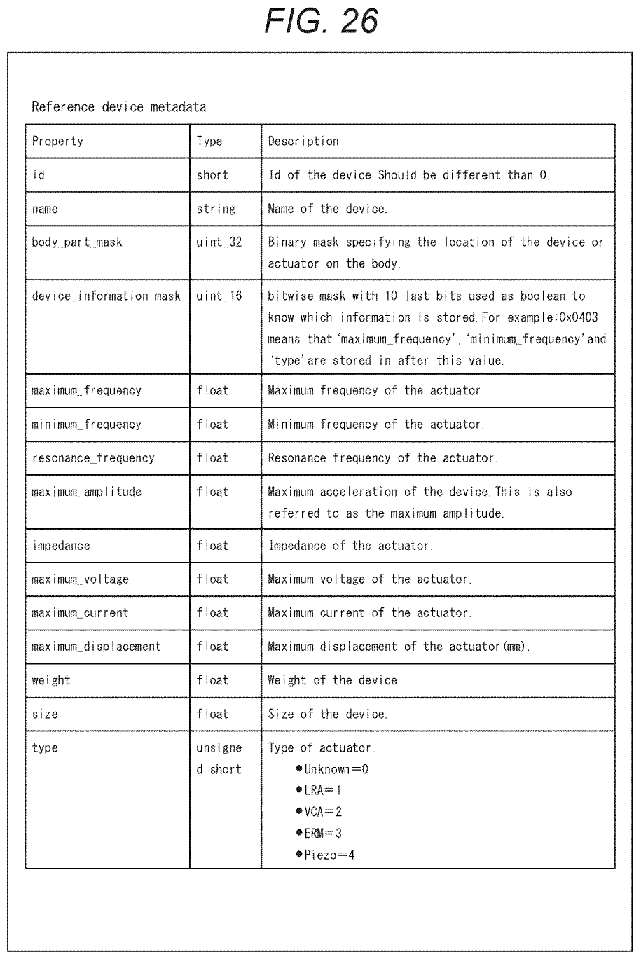

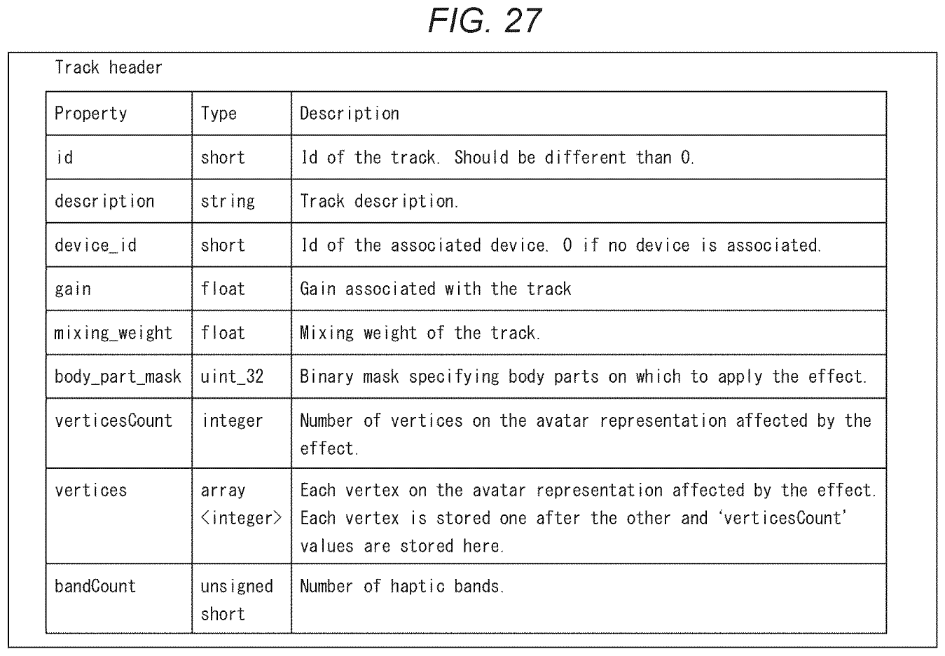

The haptics file metadata includes information regarding the haptics medium. FIG. 23 illustrates an example of semantics of the haptics file metadata. The avatar metadata includes information regarding the avatar. FIG. 24 illustrates an example of semantics of the avatar metadata. The perception metadata includes information regarding how the item behaves. FIG. 25 illustrates an example of semantics of the perception metadata. The reference device metadata includes information regarding a reference device (which device is moved and how the device is moved). FIG. 26 illustrates an example of semantics of the reference device metadata. The track header includes a track in which binary data of the item is stored and information regarding reproduction of the binary data. FIG. 27 illustrates an example of semantics of the track header.

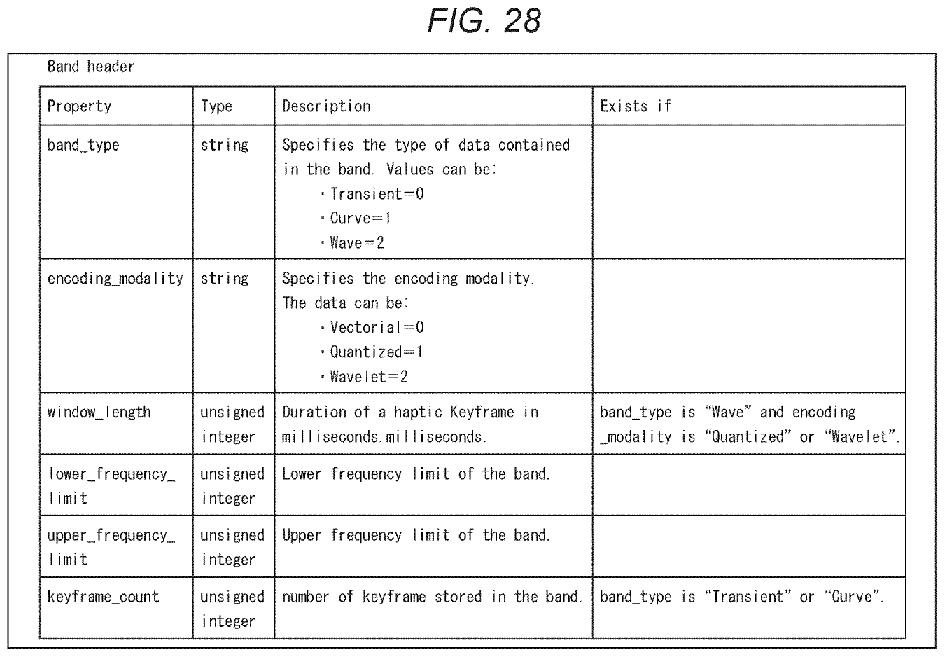

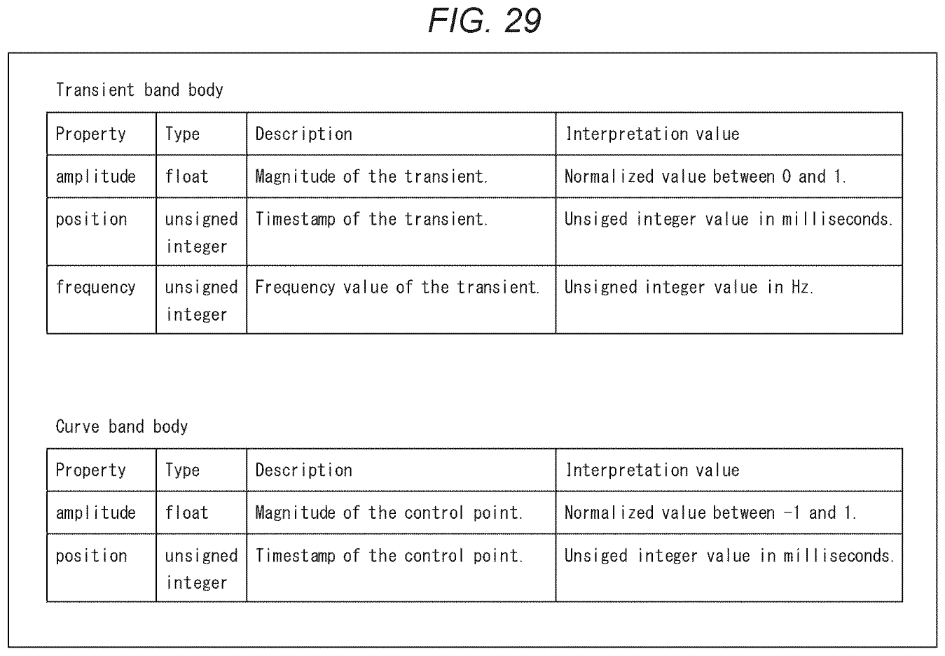

The binary body includes a band header, a transient band body, a curve band body, and a wave band body. FIG. 28 illustrates an example of semantics of the band header. Furthermore, FIG. 29 illustrates an example of semantics of the transient band body and the curve band body.

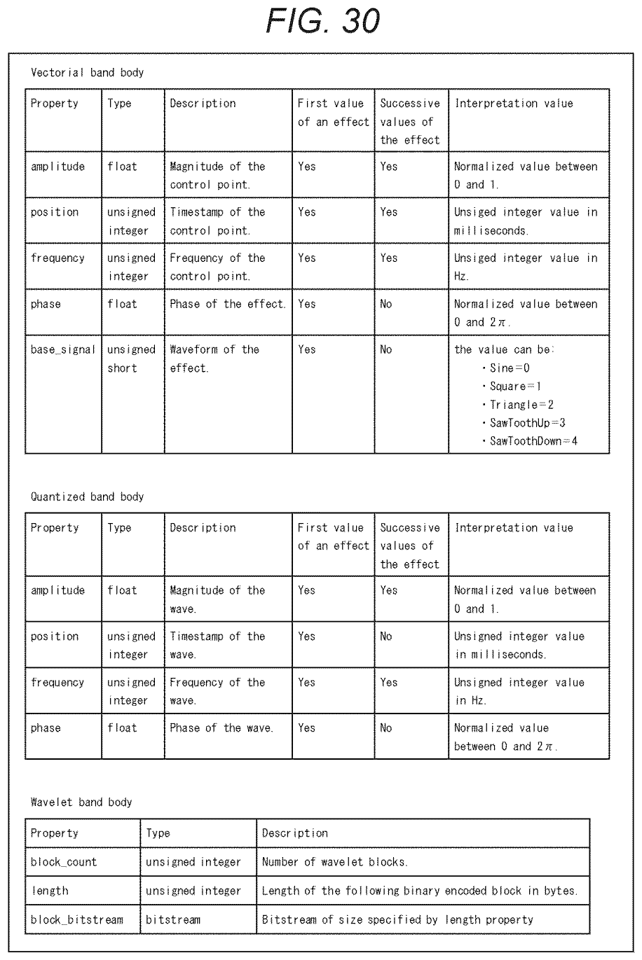

The wave-band body is encoded by any of a vectorial band body, a quantized band body, and a wavelet band body. FIG. 30 illustrates an example of semantics of those.

### <Extension of ISOBMFF for Haptics Medium>

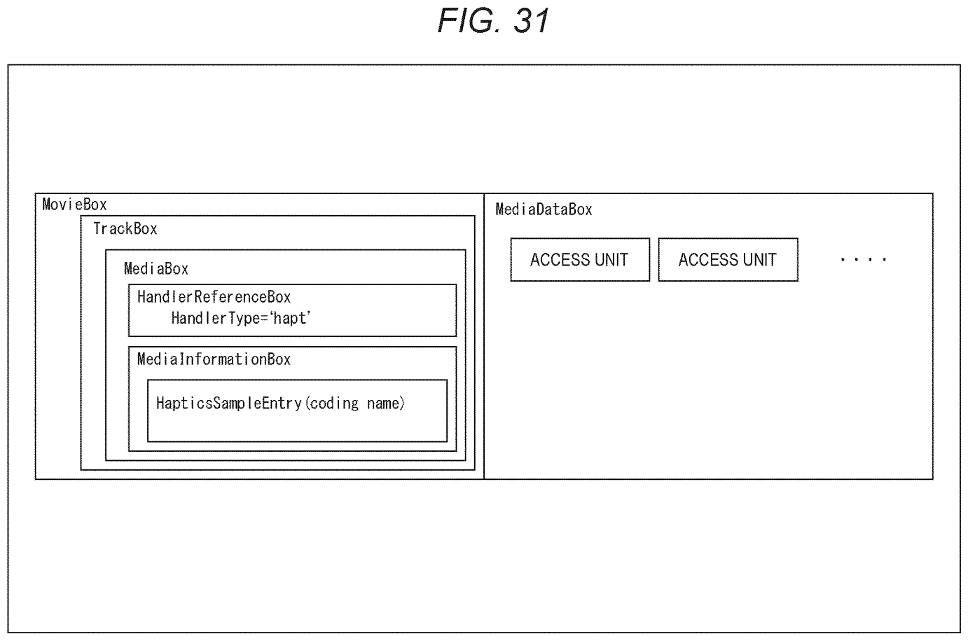

Furthermore, as described in Non-Patent Document 4, a basic function has been created for storing a bitstream obtained by encoding the haptics medium in ISOBMFF. FIG. 31 is a diagram illustrating an extension example of ISOBMFF for storing the haptics medium. In Non-Patent Document 4, a media type ‘hapt’ has been defined to store the haptics medium. Furthermore, a haptics sample entry (HapticsSampleEntry) has been prepared as a media information box. However, an internal structure of the haptics sample entry has been undefined.

### <Reproduction Control of Medium>

A medium stored in a track is a material, and how the material is reproduced is controlled by an edit list (EditList). In other words, the edit silt is information defining a state of reproduction of the medium (how the medium is reproduced).

For example, the edit list can define a start timing of reproduction of the medium (Mapping Media timeline to Movie timeline). For example, when a reference time of a start timing of reproduction of a moving image is “Movie time=0”, the edit list can start reproduction of the medium after the reference time (Movie time=0) by setting an empty edit (empty edit). That is, an offset (Starting offset) from the reference time can be set for a reproduction start time. Furthermore, the edit list can start reproduction from the middle of the medium at the reference time by setting a non-empty edit (Non-empty edit). That is, an offset (Composition offset) from the head of the medium can be set at a reproduction start position.

### <Extension of Scene Description for Haptics Medium>

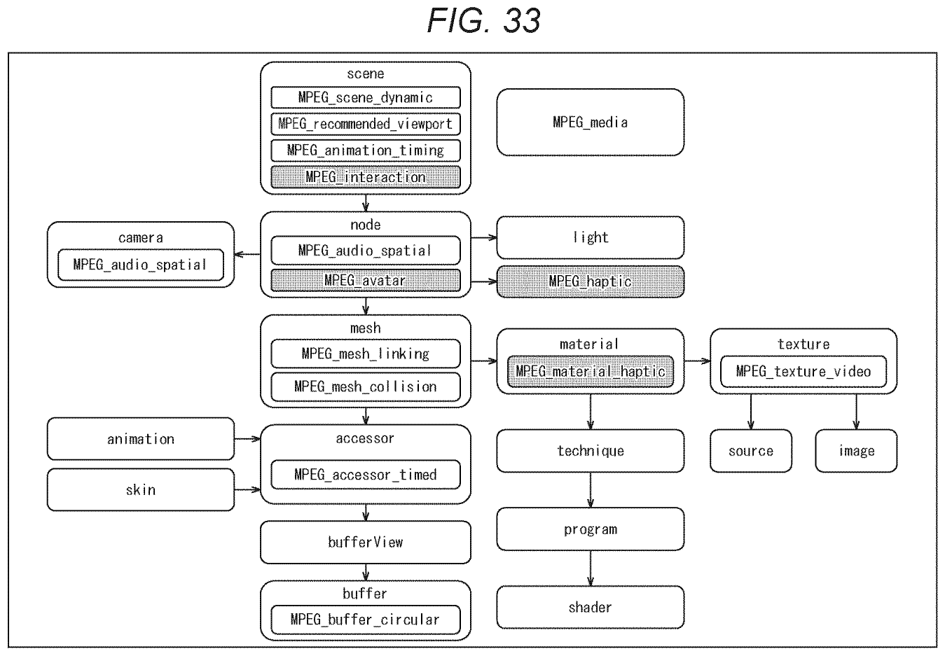

Furthermore, as described in Non-Patent Document 5, in parallel with the standardization of encoding transmission technology for haptics media, a technology search study has started for handling haptics media with MPEG-I scene description. Non-Patent Document 5 proposes four gLTF extensions of MPEG_haptic, MPEG_material_haptic, MPEG_avatar, and MPEG_interaction as illustrated in FIG. 33 in order to support a haptics medium in a scene description.

MPEG_haptic is information (for example, link information or the like) for referring to data of the haptics medium (also referred to as haptics data) referred to from the scene description. The haptics data exists as independent data similarly to data of audio, image, or the like. Furthermore, the haptics data may be encoded (may be coded data).

MPEG_material_haptic, which is a mesh/material extension of an already defined 3D object, defines haptics material information (which haptics medium is associated with which part of the 3D object (mesh), and the like). In the material information, information on a static haptics medium is defined. Furthermore, in the haptics material information, it is possible to define information for accessing MPEG_haptic (for example, link information or the like).

MPEG_avatar defines a 3D shape (avatar) of a user moving in a three-dimensional space. MPEG_interaction lists conditions that can be executed by the avatar (user) (what the user can do) and possible actions (how the object reacts). For example, MPEG_interaction defines an interaction occurring between the user (MPEG_avatar) and the 3D object (that is, an event) and an action occurring as a result thereof (for example, when the user touches the 3D object, vibration occurs).

For example, when an avatar defined in MPEG_avatar generates an interaction (event) defined in MPEG_interaction, a static haptics medium corresponding to a place where the interaction has occurred or the like is generated and reproduced according to material information of MPEG_materal_haptics so that an action corresponding to the interaction is caused (for example, vibration output by a vibrating device is rendered). Alternatively, a haptics data referred to by MPEG_haptic indicated in MPEG_materal_haptics is read, and a dynamic haptics medium is generated and reproduced.

### <Reproduction Synchronization>

Furthermore, Non-Patent Document 9 describes a method of controlling synchronization between tracks in reproduction of a medium. In the document, “‘sync’ track reference” is track reference information indicating whether or not to perform synchronization with reproduction of a medium of another track of the same file (specifically, whether or not to synchronize a reproduction clock with a clock on the transmission side).

In a case where a value of “‘sync’ track reference” is “0” (that is, identification information about a track to be referred to is “0” (track_id=0), or there is no value of track_id), an OCRStreamFlag field of MPEG-4 ESDescriptor is set to false (FALSE), and an OCR_ES_ID field is not inserted. This means that this stream is not synchronized with another stream. Note that Object Clock Reference (OCR) indicates a reference clock of each media object. The Object Time Stamp (OTB) of the transmission side is transmitted to the reception side by OCR.

### <Extended Definition of Distribution File>

However, technology search study have just started for distributing media data associated with 3D data such as a haptics medium, and there has been some media data still difficult to be correctly distributed. For that reason, there has been a possibility that distribution performance for media data associated with 3D data is reduced.

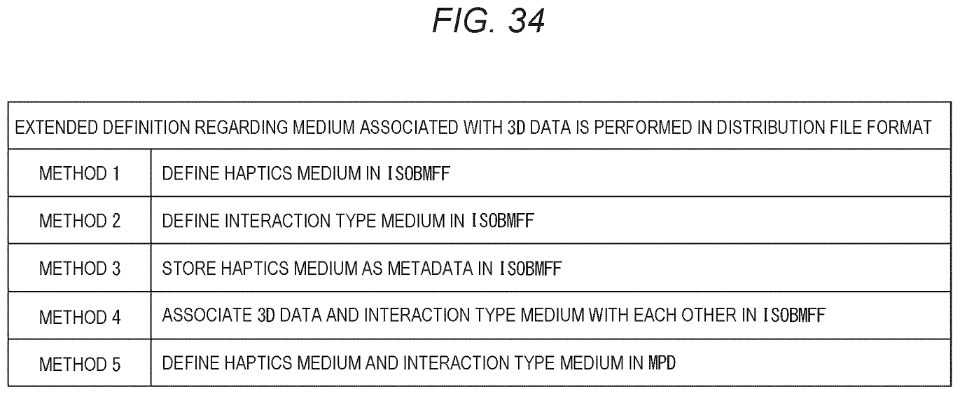

Thus, as indicated in the top row of a table in FIG. 34, extended definition regarding the medium associated with the 3D data is performed in a distribution file format.

### 3. Haptics Medium Support in ISOBMFF

### <Method 1>

For example, in a haptics distribution format structure as illustrated in FIG. 21, it is not assumed that distribution is performed in a time division manner, and thus it has been difficult to perform streaming distribution by a segment to which time division is performed like ISOBMFF with this structure as it is. In other words, in ISOBMFF, a haptics medium associated with 3D data cannot be handled similarly to a moving image, and thus it has been difficult to correctly distribute the haptics medium. For that reason, there has been a possibility that distribution performance for media data associated with 3D data is reduced.

Thus, as indicated in the second row from the top of the table in FIG. 34, a haptics medium is defined in ISOBMFF that is a distribution file (Method 1).

For example, a first information processing device includes: an encoding unit that encodes a haptics medium associated with 3D data and generates coded data of the haptics medium; and a generation unit that generates a distribution file including the coded data and information defining the haptics medium. Furthermore, in a first information processing method executed by the first information processing device, a haptics medium associated with 3D data is encoded, coded data of the haptics medium is generated, and a distribution file including the coded data and information defining the haptics medium is generated.

For example, a second information processing device includes: an acquisition unit that acquires a distribution file including coded data of a haptics medium associated with 3D data and information defining the haptics medium; an extraction unit that extracts the coded data from the distribution file on the basis of the information; and a decoding unit that decodes the extracted coded data. Furthermore, in a second information processing method executed by the second information processing device, a distribution file including coded data of a haptics medium associated with 3D data and information defining the haptics medium is acquired, the coded data is extracted from the distribution file on the basis of the information, and the extracted coded data is decoded.

The distribution file may have any specification. For example, the distribution file may be of ISOBMFF. By doing like this, in ISOBMFF, it is possible to identify a haptics medium and handle the medium as a haptics medium (as information different from a moving image or the like). Thus, the haptics medium can be correctly distributed as the haptics medium. That is, it is possible to suppress a reduction in distribution performance for media data associated with 3D data.

### <Method 1-1>

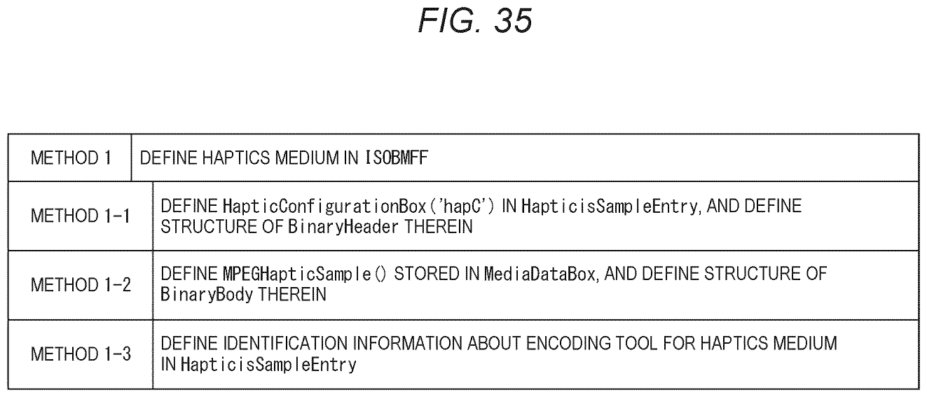

In a case where Method 1 is applied, for example, as indicated in the second row from the top of a table in FIG. 35, a haptic configuration box (HapticConfigurationBox(‘hapC’)) may be defined in the haptics sample entry (HapticisSampleEntry), and the structure of the binary header (BinaryHeader) may be defined therein (Method 1-1).

For example, in the first information processing device, the generation unit may store binary header structure definition information defining the structure of the binary header of the haptics medium in the distribution file as the information defining the haptics medium. Note that a storage location of the binary header structure definition information may be anywhere in the distribution file. For example, the generation unit may generate a configuration box that stores the binary header structure definition information and store the configuration box in the sample entry of the distribution file.

Furthermore, for example, the information defining the haptics medium included in the distribution file supplied to the second information processing device may include binary header structure definition information defining the structure of the binary header of the haptics medium. Then, in the second information processing device, the extraction unit may extract the coded data of the haptics medium associated with the 3D data from the distribution file on the basis of the binary header structure definition information. Note that a storage location of the binary header structure definition information may be anywhere in the distribution file. For example, the binary header structure definition information may be stored in the configuration box of the sample entry of the distribution file.

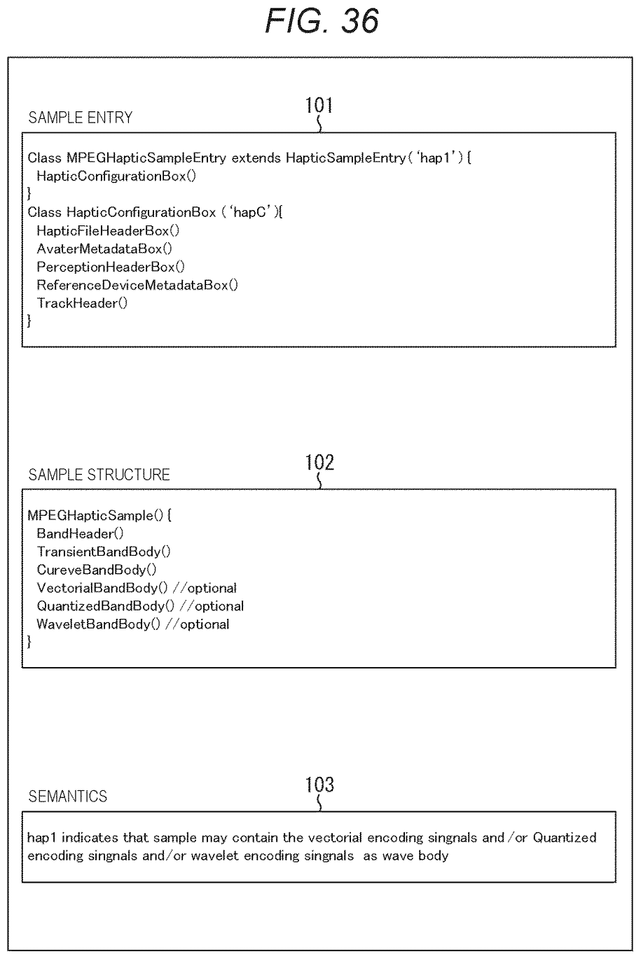

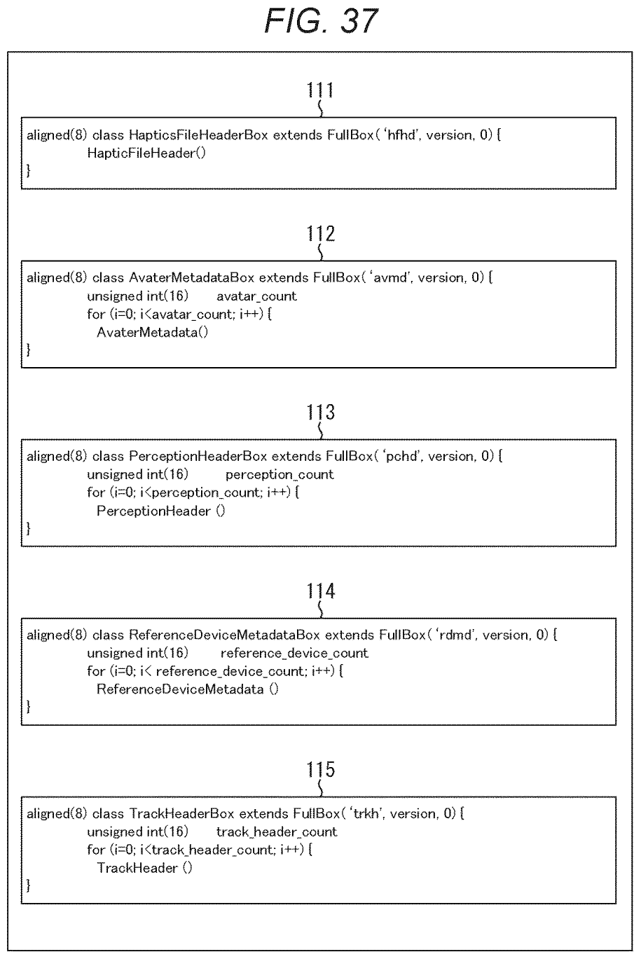

For example, in a square 101 in FIG. 36, a description example of a haptic sample entry (HapticSampleEntry) that is a sample entry for a haptics medium is indicated. In the case of the example indicated in the square 101, the haptic configuration box (HapticConfigurationBox(‘hapC’)) is defined in the haptic sample entry. The haptic configuration box is a box for storing configuration information for a haptics medium. Then, in the haptic configuration box, a haptic file header box (HapticFileHeaderBox( )), an avatar metadata box (AvaterMetadataBox( )), a perception header box (PerceptionHeaderBox( )), a reference device metadata box (ReferenceDeviceMetadataBox( )), and a track header (TrackHeader( )) are defined. The haptic file header box stores haptics file metadata (FIG. 22). A square 111 in FIG. 37 illustrates an example of syntax of the haptic file header box. The avatar metadata box stores avatar metadata (FIG. 22). A square 112 in FIG. 37 illustrates an example of syntax of the avatar metadata box. The perception header box stores perception metadata (FIG. 22). A square 113 in FIG. 37 illustrates an example of syntax of the perception header box. The reference device metadata box stores reference device metadata (FIG. 22). A square 114 in FIG. 37 illustrates an example of syntax of the reference device metadata box. The track header stores a track header (FIG. 22). A square 115 in FIG. 37 illustrates an example of syntax of the track header.

As illustrated in FIG. 22, the haptics file metadata, the avatar metadata, the perception metadata, the reference device metadata, and the track header are data constituting the binary header of the haptics medium. That is, the binary header structure definition information defining the structure of the binary header of the haptics medium is stored in the haptic configuration box in the haptic sample entry.

The binary header structure definition information is provided from the first information processing device to the second information processing device in this manner, whereby the second information processing device can obtain information on the binary header by referring to the haptic sample entry (haptic configuration box).

Thus, the second information processing device can extract the coded data of the haptics medium associated with the 3D data from the distribution file on the basis of the binary header structure definition information. Thus, the haptics medium can be correctly distributed as the haptics medium. That is, it is possible to suppress a reduction in distribution performance for media data associated with 3D data.

Note that band header definition information defining the band header of the binary body of the haptics medium may be stored in the haptic configuration box. For example, in the first information processing device, the generation unit may further store the band header definition information defining the band header of the binary body of the haptics medium in the configuration box that stores the binary header structure definition information.

Furthermore, for example, the band header definition information defining the band header of the binary body of the haptics medium may be further stored in the configuration box of the sample entry of the distribution file supplied to the second information processing device. Then, the extraction unit of the second information processing device may further extract the coded data of the haptics medium associated with the 3D data from the distribution file on the basis of the band header definition information.

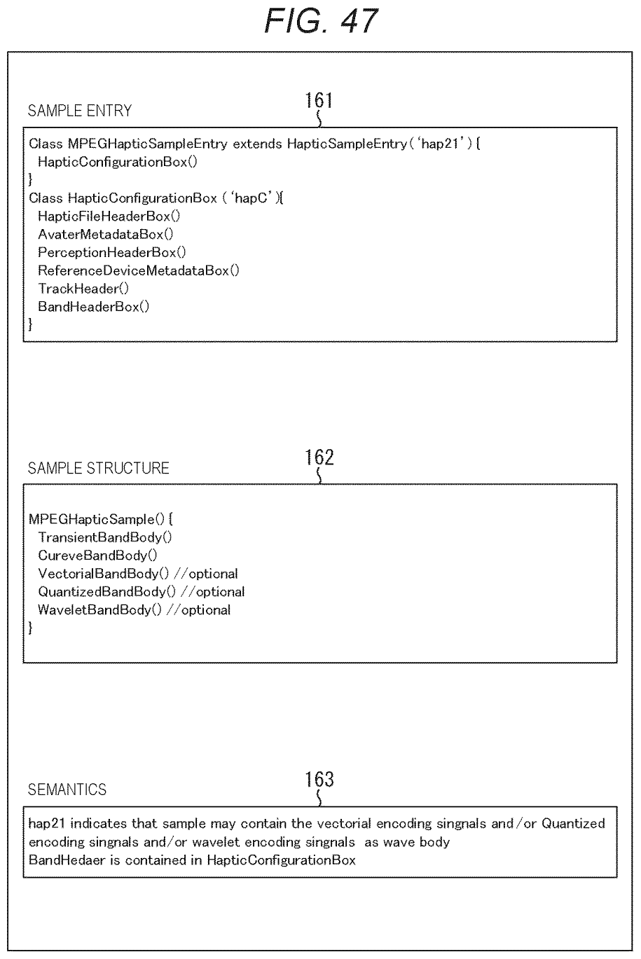

For example, in a square 161 in FIG. 47, a description example of the haptic sample entry (HapticSampleEntry) that is a sample entry for a haptics medium is indicated. In the case of the example indicated in the square 161, in the haptic configuration box (HapticConfigurationBox(‘hapC’)) in the haptic sample entry, in addition to the haptic file header box (HapticFileHeaderBox( )), avatar metadata box (AvaterMetadataBox( )), perception header box (PerceptionHeaderBox( )), reference device metadata box (ReferenceDeviceMetadataBox( )), and track header (TrackHeader( )) described above, a band header box (BandHeaderBox ( ) is defined. The band header box stores a band header (FIG. 28) of the binary body. That is, the band header definition information defining the band header of the binary body of the haptics medium is further stored in the haptic configuration box in the haptic sample entry.

In a case where a common band header is used for a plurality of samples, it is redundant if the band header is defined in each sample. With the configuration described above (that is, the band header definition information is stored in the sample entry.), such redundancy can be reduced.

### <Method 1-2>

Furthermore, in a case where Method 1 is applied, for example, as indicated in the third row from the top of the table in FIG. 35, an MPEG haptic sample (MPEGHapticSample( )) stored in the media data box (MediaDataBox) may be defined, and a structure of the binary body (BinaryBody) may be defined therein (Method 1-2).

For example, in the first information processing device, the generation unit may store binary body structure definition information defining the structure of the binary body of the haptics medium in the distribution file as the information defining the haptics medium. Note that a storage location of the binary body structure definition information may be anywhere in the distribution file. For example, the binary body structure definition information may define the structure of the binary body of the haptics medium by a sample structure in the media data box of the distribution file.

Furthermore, for example, the information defining the haptics medium included in the distribution file supplied to the second information processing device may include the binary body structure definition information defining the structure of the binary body of the haptics medium. Then, in the second information processing device, the extraction unit may extract the coded data of the haptics medium associated with the 3D data from the distribution file on the basis of the binary body structure definition information. Note that a storage location of the binary body structure definition information may be anywhere in the distribution file. For example, the binary body structure definition information may define the structure of the binary body of the haptics medium by a sample structure in the media data box of the distribution file.

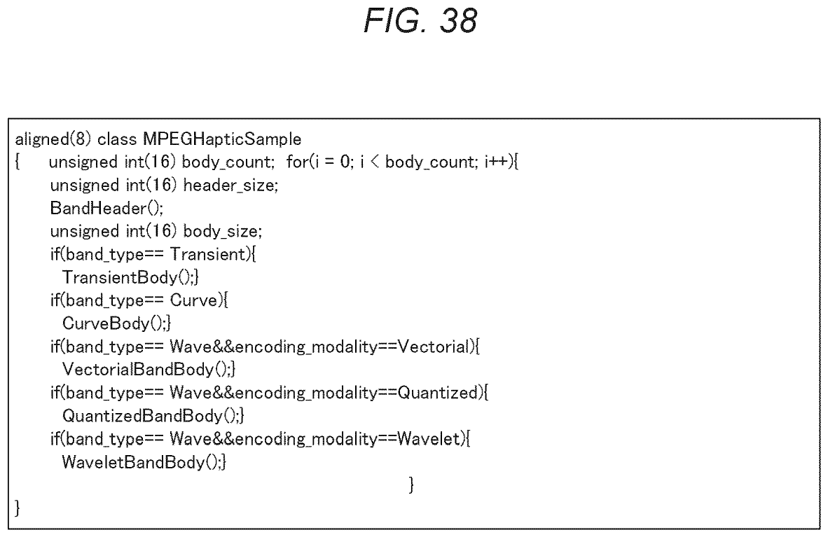

For example, a configuration example of the MPEG haptic sample (MPEGHapticSample( )) that is a sample structure for a haptics medium is indicated in a square 102 in FIG. 36. FIG. 38 illustrates an example of syntax of the MPEG haptic sample in the case of the example. In the case of the example, a band header (BandHeader( )), a transient band body (TransientBandBody( )), a curve band body (CureveBandBody( )), and a wave band body are stored in the MPEG haptic sample. In the case of the example, since any of vectorial encoding, quantized encoding, and wavelet encoding can be used as encoding tools, the wave band body can include any of a vectorial band body (VectorialBandBody( )), a quantized band body (QuantizedBandBody( )), and a wavelet band body (WaveletBandBody( )), which are encoding results thereof. As illustrated in FIGS. 28 to 30, these pieces of data are data constituting the binary body of the haptics medium. That is, the structure of the binary body of the haptics medium is defined by a sample structure of the MPEG haptic sample. That is, it can be said that the binary body structure definition information is stored in the MPEG haptic sample.

The binary body structure definition information is provided from the first information processing device to the second information processing device in this manner, whereby the second information processing device can obtain information on the binary body by referring to the MPEG haptic sample. Thus, the second information processing device can extract the coded data of the haptics medium associated with the 3D data from the distribution file on the basis of the binary body structure definition information. Thus, the haptics medium can be correctly distributed as the haptics medium. That is, it is possible to suppress a reduction in distribution performance for media data associated with 3D data.

### <Method 1-3>

Furthermore, in a case where Method 1 is applied, for example, as indicated in the bottom row of the table in FIG. 35, identification information about the encoding tool for the haptics medium may be defined in the haptic sample entry (HapticisSampleEntry) (Method 1-3).

For example, in the first information processing device, the generation unit may store encoding tool definition information defining the encoding tool used for encoding and decoding the haptics medium in the distribution file as the information defining the haptics medium. Note that the encoding tool definition information may be any information. For example, in the first information processing device, the generation unit may generate the identification information about the encoding tool as the encoding tool definition information and store the identification information in the sample entry of the distribution file.

Furthermore, for example, the information defining the haptics medium included in the distribution file supplied to the second information processing device may include the encoding tool definition information defining the encoding tool used for encoding and decoding the haptics medium. Then, in the second information processing device, the decoding unit may decode the coded data of the haptics medium associated with the 3D data using the encoding tool defined by the encoding tool definition information. Note that the encoding tool definition information may be any information. For example, the encoding tool definition information may include the identification information about the encoding tool.

For example, as indicated in the square 101 in FIG. 36, in the haptic sample entry (HapticSampleEntry), “hap1” is defined (Class MPEGHapticSampleEntry extends HapticSampleEntry(‘hap1’) { ). An example of semantics of the “hap1” is indicated in a square 103 in FIG. 36. That is, the “hap1” is the identification information (coding name) about the encoding tool applied to the haptics medium.

The “hap1” indicates that all encoding tools (vectorial encoding, quantized encoding, wavelet encoding) can be used as the encoding tool for the haptics medium. Thus, in this case, as described above, the wave band body can include any of the vectorial band body (VectorialBandBody( )) that is the encoding result to which the vectorial encoding is applied, the quantized band body (QuantizedBandBody( )) that is the encoding result to which the quantized encoding is applied, and the wavelet band body (WaveletBandBody( )) that is the encoding result to which the wavelet encoding is applied (square 102 in FIG. 36).

Since the processing complexity differs depending on the encoding tool, by identifying which encoding tool is applied by 4CC of the sample entry as described above, the second information processing device can determine a processing load of a device in advance. Thus, the haptics medium can be correctly distributed as the haptics medium. That is, it is possible to suppress a reduction in distribution performance for media data associated with 3D data.

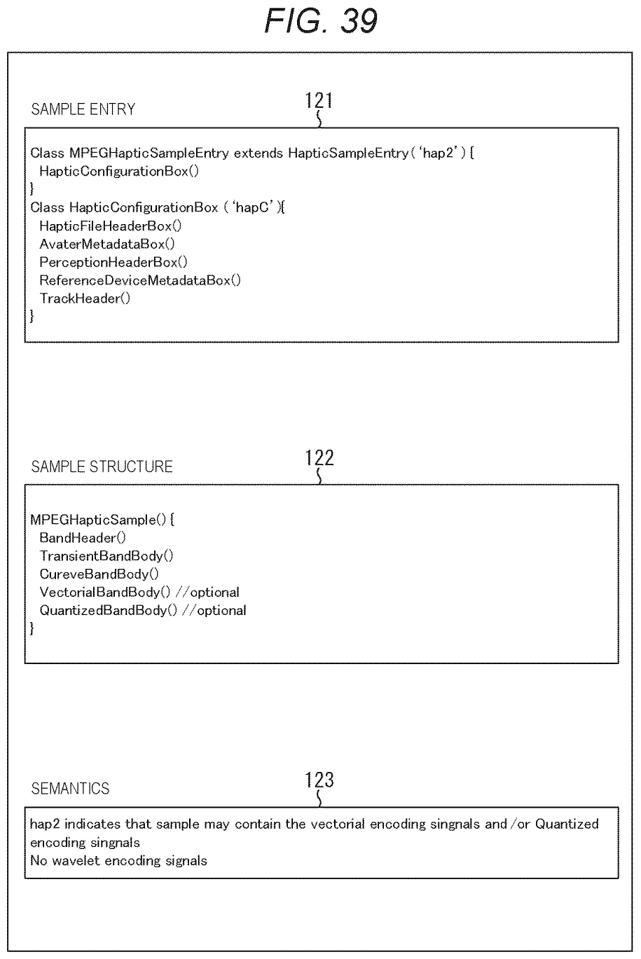

FIG. 39 illustrates an example of a case where “hap2” is defined as the identification information about the encoding tool. As illustrated in a square 121 in FIG. 39, in this case, in the haptic sample entry (HapticSampleEntry), the “hap2” is defined (Class MPEGHapticSampleEntry extends HapticSampleEntry(‘hap2’) { ). An example of semantics of the “hap2” is indicated in a square 123 in FIG. 39. That is, the “hap2” is the identification information (coding name) on the encoding tool applied to the haptics medium.

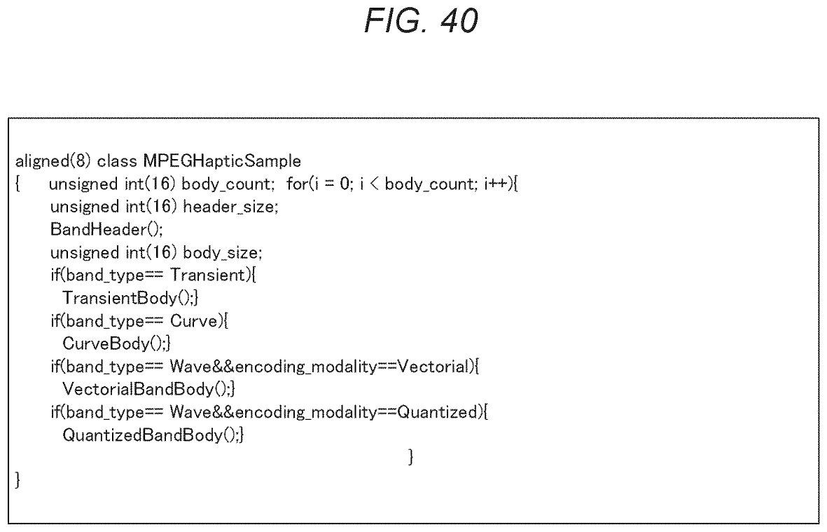

The “hap2” indicates that the wavelet encoding is not used (the vectorial encoding and the quantized encoding can be used) as the encoding tool for the haptics medium. Thus, in this case, the MPEG haptic sample has a configuration as indicated in a square 122 in FIG. 39. That is, in this case, the wave band body can include the vectorial band body (VectorialBandBody( )) that is the encoding result to which the vectorial encoding is applied and the quantized band body (QuantizedBandBody( )) that is the encoding result to which the quantized encoding is applied. FIG. 40 illustrates an example of syntax of the MPEG haptic sample in the case of the example.

In general, since the wavelet encoding is heavy in processing, by applying the “hap2”, it is possible to avoid application of the wavelet encoding, and to suppress an increase in load of decoding processing.

Note that a mode in which the vectorial encoding is not used (mode in which the quantized encoding and the wavelet encodings can be used) or a mode in which the quantized encoding is not used (mode in which the vectorial encoding and the wavelet encoding can be used) may be provided. In that case, identification information indicating each mode is prepared.

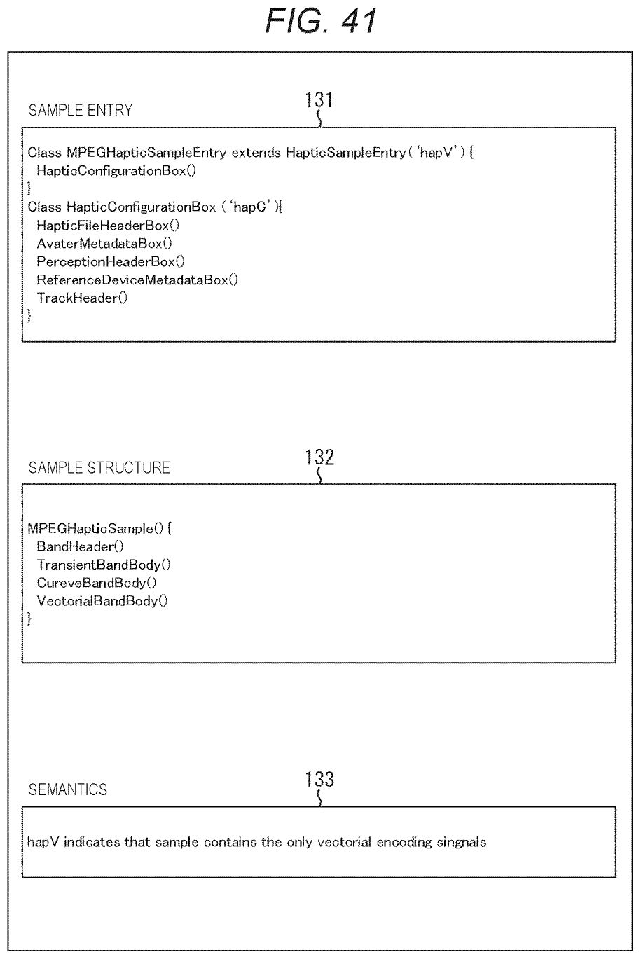

FIG. 41 illustrates an example of a case where “hapV” is defined as the identification information about the encoding tool. As illustrated in a square 131 in FIG. 41, in this case, in the haptic sample entry (HapticSampleEntry), the “hapV” is defined (Class MPEGHapticSampleEntry extends HapticSampleEntry(‘hapV’) { ). An example of semantics of the “hapV” is indicated in a square 133 in FIG. 41. That is, the “hapV” is the identification information (coding name) on the encoding tool applied to the haptics medium.

The “hapV” indicates that the quantized encoding and the wavelet encoding are not used (the vectorial encoding is used) as the encoding tool for the haptics medium. Thus, in this case, the MPEG haptic sample has a configuration as indicated in a square 132 in FIG. 41.

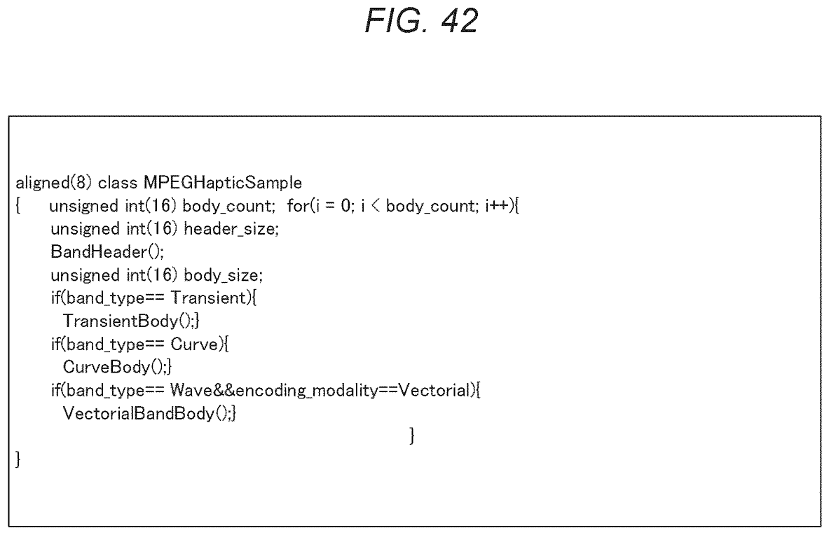

That is, in this case, the wave band body includes the vectorial band body (VectorialBandBody( )) that is the encoding result to which the vectorial encoding is applied. FIG. 42 illustrates an example of syntax of the MPEG haptic sample in the case of the example.

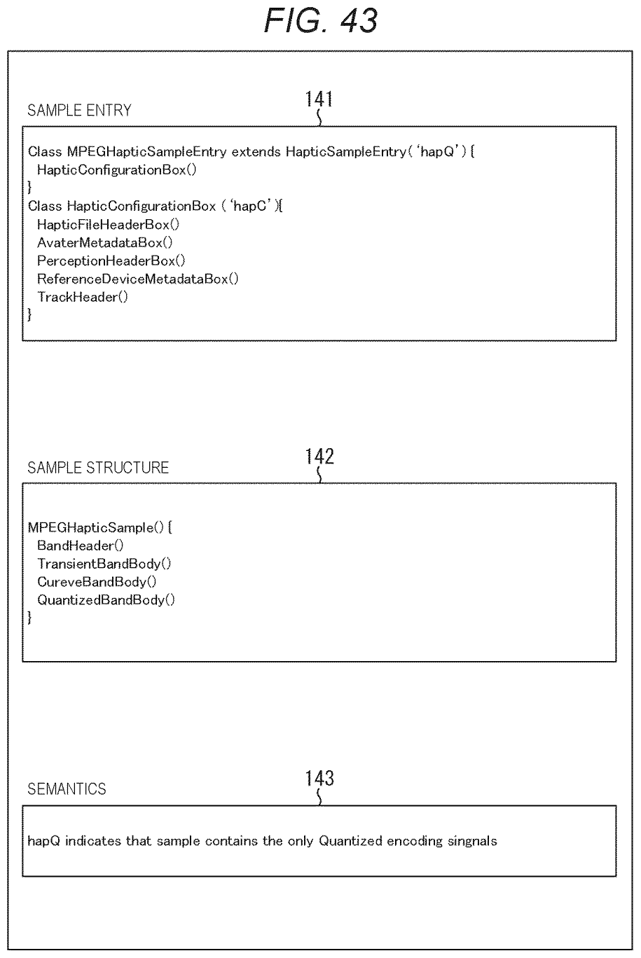

FIG. 43 illustrates an example of a case where “hapQ” is defined as the identification information about the encoding tool. As illustrated in a square 141 in FIG. 43, in this case, in the haptic sample entry (HapticSampleEntry), the “hapQ” is defined (Class MPEGHapticSampleEntry extends HapticSampleEntry(‘hapQ’) { ). An example of semantics of the “hapQ” is indicated in a square 143 in FIG. 43. That is, the “hapQ” is the identification information (coding name) on the encoding tool applied to the haptics medium.

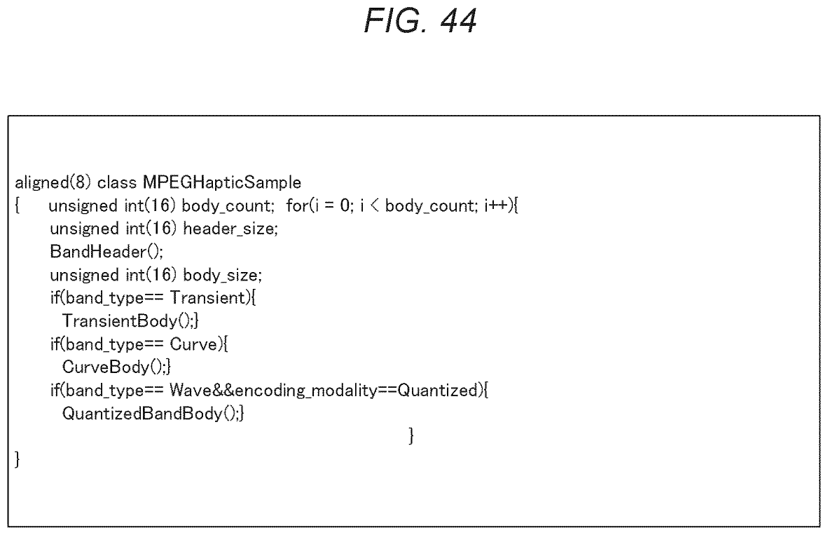

The “hapQ” indicates that the vectorial encoding and the wavelet encoding are not used (the quantized encoding is used) as the encoding tool for the haptics medium. Thus, in this case, the MPEG haptic sample has a configuration as indicated in a square 142 in FIG. 43. That is, in this case, the wave band body includes the quantized band body (QuantizedBandBody( )) that is the encoding result to which the quantized encoding is applied. FIG. 44 illustrates an example of syntax of the MPEG haptic sample in the case of the example.

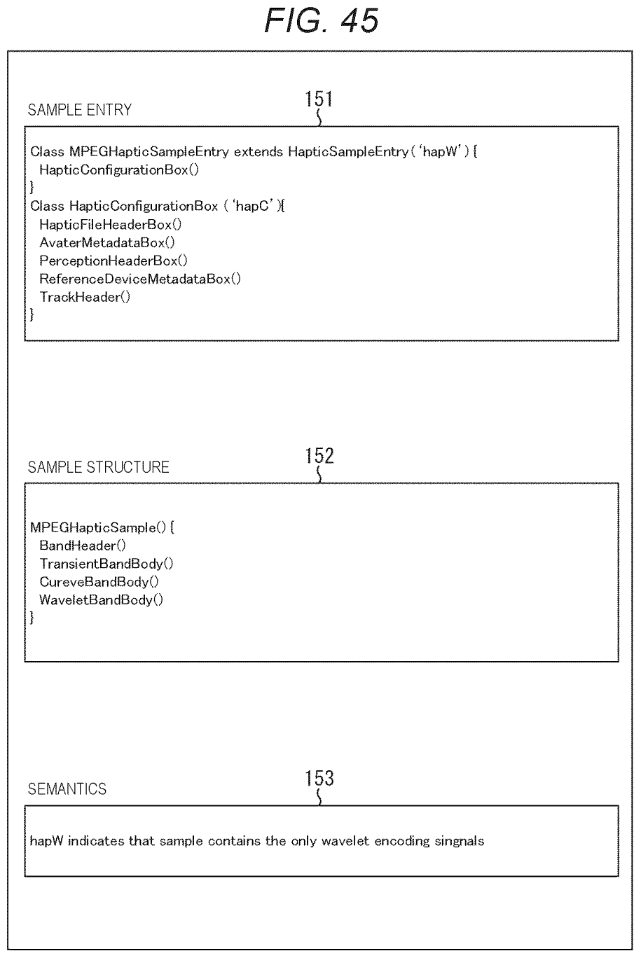

FIG. 45 illustrates an example of a case where “hapW” is defined as the identification information about the encoding tool. As illustrated in a square 151 in FIG. 45, in this case, in the haptic sample entry (HapticSampleEntry), the “hapW” is defined (Class MPEGHapticSampleEntry extends HapticSampleEntry(‘hapW’) { ). An example of semantics of the “hapW” is indicated in a square 153 in FIG. 45. That is, the “hapW” is the identification information (coding name) on the encoding tool applied to the haptics medium.

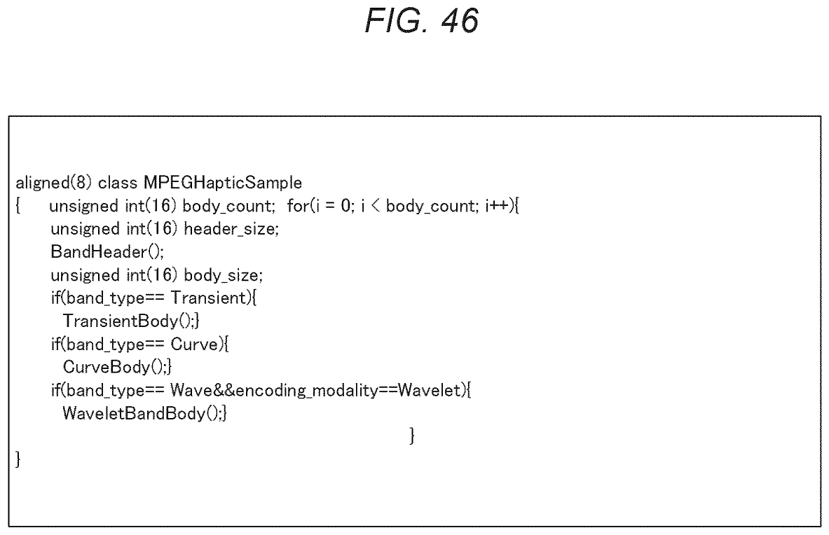

The “hapW” indicates that the vectorial encoding and the quantized encoding are not used (the wavelet encoding is used) as the encoding tool for the haptics medium. Thus, in this case, the MPEG haptic sample has a configuration as indicated in a square 152 in FIG. 45. That is, in this case, the wave band body includes the wavelet band body (WaveletBandBody( )) that is the encoding result to which the wavelet encoding is applied. FIG. 46 illustrates an example of syntax of the MPEG haptic sample in the case of the example.

Note that, as described above, the band header definition information defining the band header of the binary body of the haptics medium may be stored in the haptic configuration box (Method 1-1).

FIG. 47 illustrates an example of a case where “hap21” is defined as the identification information about the encoding tool. As illustrated in the square 161 in FIG. 47, in this case, in the haptic sample entry (HapticSampleEntry), the “hap21” is defined (Class MPEGHapticSampleEntry extends HapticSampleEntry(‘hap21’) { ). An example of semantics of the “hap21” is indicated in a square 163 in FIG. 47. That is, the “hap21” is the identification information (coding name) about the encoding tool applied to the haptics medium.

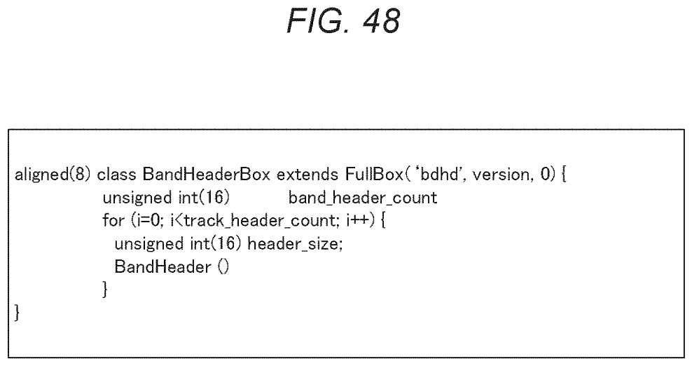

The “hap21” indicates that the band header definition information is stored in the haptic configuration box, and as in the case of the “hap1”, all the encoding tools (vectorial encoding, quantized encoding, wavelet encoding) can be used as the encoding tool for the haptics medium. Thus, in this case, the band header box (BandHeaderBox ( ) that stores the band header definition information is defined in the haptic sample entry (HapticSampleEntry). FIG. 48 illustrates an example of syntax of the band header box. As illustrated in FIG. 48, the band header (BandHeader( )) is stored in the band header box. That is, the band header definition information is stored in the haptic sample entry.

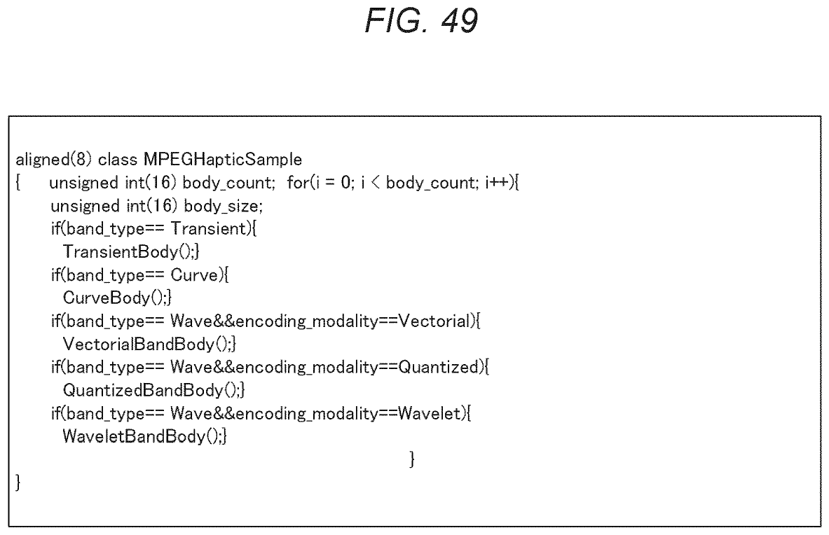

Then, as illustrated in a square 162 in FIG. 47, the MPEG haptic sample does not include the band header. Thus, it is possible to reduce redundancy of the band header in a case where a common band header is used for a plurality of samples. In the case of the “hap21”, as described above, all the encoding tools (vectorial encoding, quantized encoding, wavelet encoding) can be used as the encoding tool for the haptics medium. Thus, the wave band body can include any of the vectorial band body (VectorialBandBody( )) that is the encoding result to which the vectorial encoding is applied, the quantized band body (QuantizedBandBody( )) that is the encoding result to which the quantized encoding is applied, and the wavelet band body (WaveletBandBody( )) that is the encoding result to which the wavelet encoding is applied (square 162 in FIG. 47). FIG. 49 illustrates an example of syntax of the MPEG haptic sample in the case of the example.

Note that the example in which the band header definition information is stored in the haptic configuration box as in the case of the “hap21” can also be applied to other modes (for example, “hap2”, “hapV”, “hapQ”, “hapW”, and the like) other than the “hap1”.

### 4. Interaction Type Medium Support in ISOBMFF

### <Method 2>

The distribution file such as of ISOBMFF has a structure in which times of synchronized media (audio, video, haptics, and the like) are mapped to an entire presentation timeline. For that reason, in a case where an interaction type medium (event base) is distributed by using ISOBMFF, the interaction type medium cannot be mapped to any timing in the presentation, and it has been difficult to correctly reproduce the interaction type medium (that is, reproduce the medium on the basis of occurrence of an event). For example, it has been difficult to reproduce a medium with an interaction (for example, touch, move, bump, or the like) between an avatar or the like of a viewing user and a video object disposed in a 3D space as a trigger. In other words, in ISOBMFF, since an interaction type medium associated with 3D data is handled similarly to a moving image or the like, it has been difficult to correctly distribute the interaction type medium. For that reason, there has been a possibility that distribution performance for media data associated with 3D data is reduced.

Thus, as indicated in the third row from the top of the table in FIG. 34, an interaction type medium is defined in ISOBMFF that is a distribution file (Method 2).

For example, the first information processing device includes: an encoding unit that encodes an interaction type medium associated with 3D data and generates coded data of the interaction type medium; and a generation unit that generates a distribution file including the coded data and information defining the interaction type medium. Furthermore, in the first information processing method executed by the first information processing device, an interaction type medium associated with 3D data is encoded, coded data of the interaction type medium is generated, and a distribution file including the coded data and information defining the interaction type medium is generated.

For example, the second information processing device includes: an acquisition unit that acquires a distribution file including coded data of an interaction type medium associated with 3D data and information defining the interaction type medium; an extraction unit that extracts the coded data from the distribution file on the basis of the information; and a decoding unit that decodes the extracted coded data. Furthermore, in the second information processing method executed by the second information processing device, a distribution file including coded data of an interaction type medium associated with 3D data and information defining the interaction type medium is acquired, the coded data is extracted from the distribution file on the basis of the information, and the extracted coded data is decoded.

Note that the interaction type medium is a medium to be reproduced on the basis of occurrence of a predetermined event.

By doing like this, in ISOBMFF, it is possible to identify an interaction type medium and handle the medium as an interaction type medium (as information different from a moving image or the like). Thus, the interaction type medium can be correctly distributed as the interaction type medium. That is, it is possible to suppress a reduction in distribution performance for media data associated with 3D data.

### <Method 2-1>

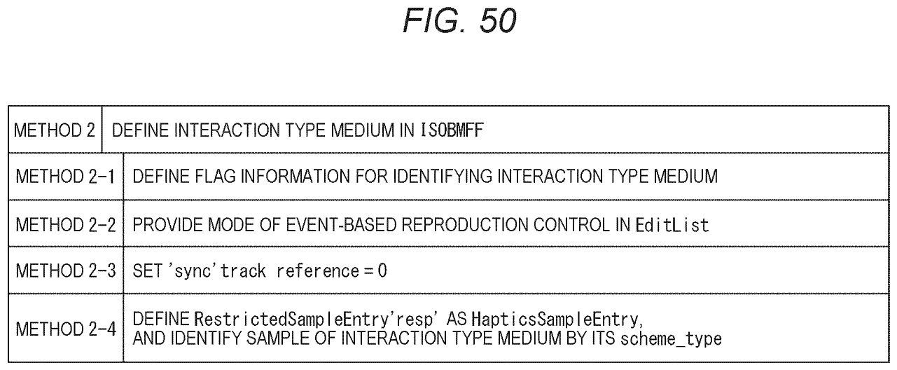

In a case where Method 2 is applied, for example, as indicated in the second row from the top of a table in FIG. 50, flag information for identifying the interaction type medium may be defined (Method 2-1).

For example, in the first information processing device, the generation unit may store the flag information for identifying that the medium associated with the 3D data is the interaction type medium in the distribution file as information defining the interaction type medium. Note that a storage location of this flag information may be anywhere in the distribution file. For example, the flag information may be flag information (Flags) stored in an edit list box (EditListBox) of the distribution file.

Furthermore, for example, the information defining the interaction type medium included in the distribution file supplied to the second information processing device may include the flag information for identifying that the medium associated with the 3D data is the interaction type medium. Then, in the second information processing device, the extraction unit may extract the coded data of the interaction type medium associated with the 3D data on the basis of the flag information. Note that a storage location of the flag information may be anywhere in the distribution file. For example, the flag information may be flag information (Flags) stored in an edit list box (EditListBox) of the distribution file.

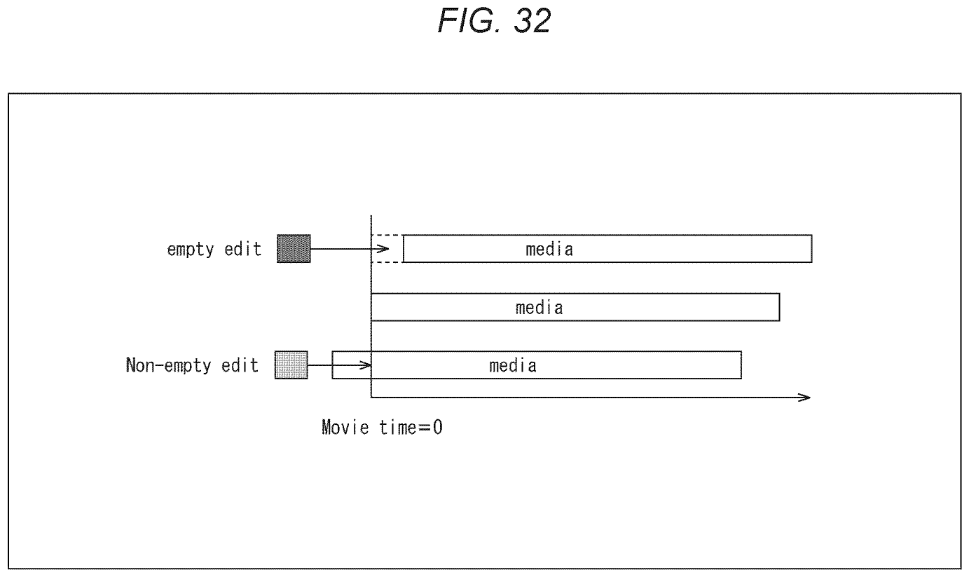

In the edit list box (EditListBox) in ISOBMFF, an edit list as described with reference to FIG. 32 is stored. Furthermore, the Flags is stored in the edit list box. The Flags includes a plurality of bits, and is flag information indicating true or false depending on its value in each bit. The Flags may be extended to indicate whether the medium associated with the 3D data is the interaction type medium.

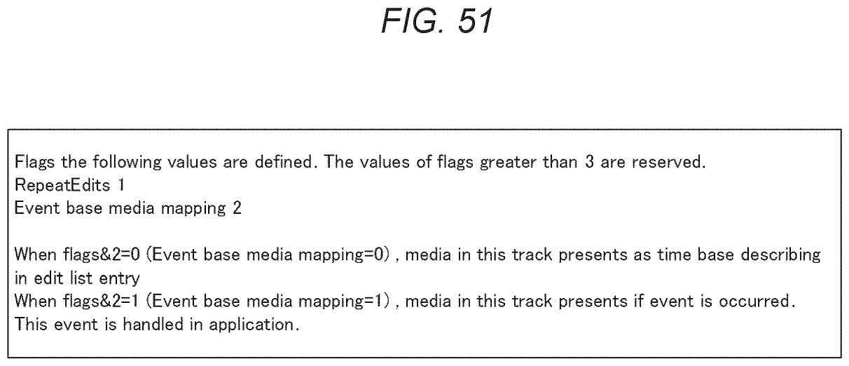

FIG. 51 is a diagram illustrating an example of semantics of the Flags. In the case of the example in FIG. 51, the second bit of the Flags is flag information (Event base media mapping) indicating that the medium associated with the 3D data is the interaction type medium. In a case where the second bit of the Flags is true (flags & 2=1, that is, Event base media mapping=1), it indicates that the medium associated with the 3D data is the interaction type medium. Furthermore, in a case where the second bit of the Flags is false (flags & 2=0, that is, Event base media mapping=0), it indicates that the medium associated with the 3D data is not the interaction type medium.

By doing like this, it is possible for the second information processing device to easily grasp whether or not the medium associated with the 3D data is the interaction type medium by referring to the Flags. Thus, the second information processing device can extract the coded data of the interaction type medium associated with the 3D data from the distribution file on the basis of information of the Flags. Thus, the interaction type medium can be correctly distributed as the interaction type medium. That is, it is possible to suppress a reduction in distribution performance for media data associated with 3D data.

Note that a bit to be the flag information (Event base media mapping) indicating that the medium associated with the 3D data is the interaction type medium may be any bit of the Flags. For example, a bit of the third or subsequent bit of the Flags may be used as this flag information (Event base media mapping).

Furthermore, instead of using the Flags, a field indicating that the medium is event-based may be added.

### <Method 2-2>

Furthermore, in ISOBMFF, it has not been able to perform control for interaction such as performing reproduction on the basis of occurrence of an event. Thus, in a case where Method 2 is applied, for example, as indicated in the third row from the top of the table in FIG. 50, a mode of event-based reproduction control may be provided in the edit list (EditList) (Method 2-2).

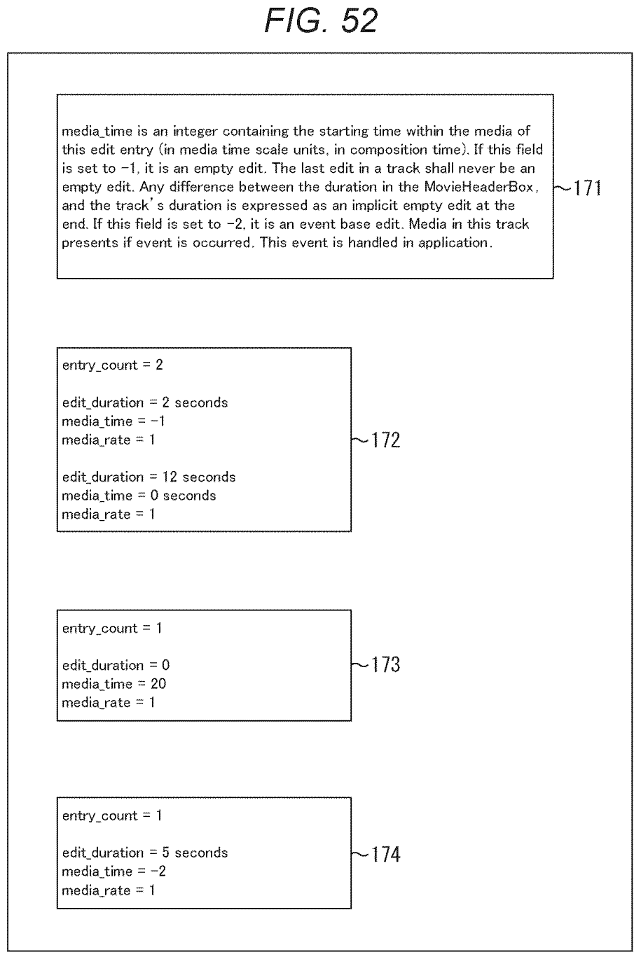

As described in Non-Patent Document 4, the edit list is control information (information defining a state of reproduction of the medium (how the medium is reproduced)) for controlling reproduction of the medium in ISOBMFF. The edit list can include various types of information regarding the reproduction control. For example, the edit list can include information such as an edit duration (edit_duration), a media time (media_time), and a media rate (media_rate) as described in a square 172 and the like in FIG. 52.

The edit duration (edit_duration) indicates a duration of editing. For example, in a case where the media time is “0” or more (media_time=0 or more) (Non-empty edit), a reproduction period is indicated. Furthermore, in a case where the media time is “−1” (media time=−1) (empty edit), a non-reproduction period (that is, a reproduction start delay time) is indicated. The media time (media_time) indicates a reproduction start position in the medium in a case where its value is 0 or more. Furthermore, in a case where the value is −1, empty edit is indicated. The media rate (media rate) indicates a reproduction speed (scale).

It may be enabled to perform the reproduction control of the interaction type medium with such an edit list.

For example, in the first information processing device, the generation unit may store the edit list for controlling reproduction in accordance with occurrence of an event in the distribution file as information defining the interaction type medium. Note that the specification of the edit list may be any specification. For example, information corresponding to media time having a value of “−2” in the edit list may be control information for controlling reproduction in accordance with occurrence of an event.

Furthermore, for example, the information defining the interaction type medium included in the distribution file supplied to the second information processing device may include the edit list for controlling reproduction in accordance with occurrence of an event. Then, in the second information processing device, the extraction unit may extract the coded data of the interaction type medium associated with the 3D data on the basis of the edit list. Note that the specification of the edit list may be any specification. For example, information corresponding to media time having a value of “−2” in the edit list may be control information for controlling reproduction in accordance with occurrence of an event.

An example of semantics of the media time (media_time) is indicated in a square 171 in FIG. 52. In the case of the example, in a case where a value of the media time (media_time) is “−2”, it indicates that the reproduction control is performed according to the occurrence of the event.

A description example of the edit list is indicated in the square 172 in FIG. 52. In the case of the example, two controls are described. By the first entry (edit_duration=2 seconds, media_time=−1, media_rate=1), reproduction of the medium is started 2 seconds after the reference time (Movie time=0). By the second entry (edit_duration=12 seconds, media_time=0 seconds, media_rate=1), the reproduction is continued for 12 seconds.

A description example of the edit list is indicated in a square 173 in FIG. 52. In the case of the example, one control is described. By the first entry (edit_duration=0, media_time=20, media_rate=1), reproduction is started from a position of 20 seconds from the head of the medium.

A description example of the edit list is indicated in a square 174 in FIG. 52. In the case of the example, one control is described. By the first entry (edit_duration=5 seconds, media_time=−2, media_rate=1), reproduction of the medium is performed for five seconds after the occurrence of the event.

By extending media time in this way, reproduction control of the interaction type medium can be performed.

Note that a value of media time indicating that the reproduction control is performed according to the occurrence of the event may be any value as long as the value is a negative value, and may be other than “−2” described above. For example, the value may be “−3” or less.

### <Method 2-3>

Note that, in a case where Method 2-2 described above is applied, in order to grasp whether or not the medium associated with the 3D data is the interaction type medium at the time of decoding, it is necessary to parse the edit list, and complicated processing has been necessary.

Thus, in a case where Method 2 is applied, for example, as indicated in the fourth row from the top of the table in FIG. 50, ‘sync’ track reference=0 may be set (Method 2-3). As described above in <Reproduction Synchronization>, “‘sync’ track reference” described in Non-Patent Document 9 is track reference information indicating whether or not to perform synchronization with reproduction of a medium of another track of the same file (specifically, whether or not to synchronize a reproduction clock with a clock on the transmission side). In a case where a value thereof is “0” (‘sync’ track reference=0), it indicates that a medium of the track is reproduced without being synchronized with reproduction of a medium of another track. The reproduction of the interaction type medium is started on the basis of the occurrence of the event and is therefore not synchronized with the reproduction of a medium of another track. In other words, in a case where the value is “1” (‘sync’ track reference=1), it can be said that the medium of the track is not the interaction type medium.

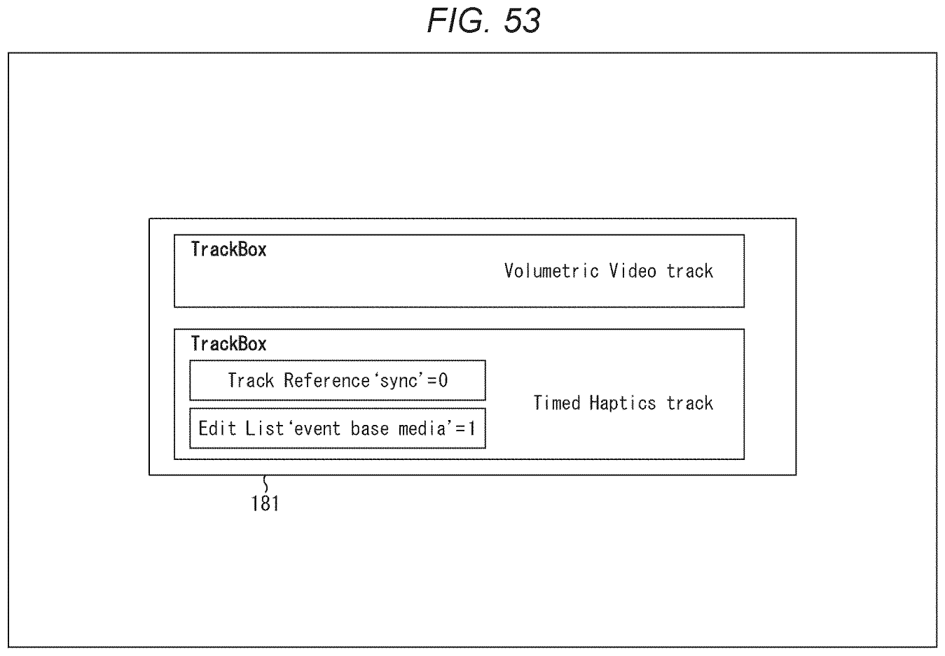

Thus, for example, as in a file 181 illustrated in FIG. 53, “‘sync’ track reference=0” is set in a track box (Track Box) of a track (Timed Haptics Track) that stores a medium (for example, a haptics medium) associated with 3D data, whereby it may be indicated that the medium is the interaction type medium. By doing like this, it is possible to more easily grasp whether the medium of the track is the interaction type medium only by parsing the “‘sync’ track reference”.

Note that, strictly speaking, as described above, the “‘sync’ track reference” is information simply indicating whether or not reproduction is synchronized with reproduction of a medium of another track, and thus, even if the value is “0”, the medium of the track is not necessarily the interaction type medium. Thus, flag information for identifying that the medium associated with the 3D data is the interaction type medium may be further stored. For example, an “event base media” flag may be defined as in the file 181 illustrated in FIG. 53. The “event base media” flag is flag information indicating whether or not the medium of the track starts to be reproduced on the basis of an event (that is, whether or not the medium is the interaction type medium). In a case where a value of the flag is true (for example, “1”), it indicates that the medium of the track (medium associated with 3D data) is the interaction type medium.

For example, in the first information processing device, the generation unit may store flag information for identifying that the medium associated with the 3D data is the interaction type medium and “‘sync’trac reference=0” indicating that the interaction type medium is reproduced asynchronously with a medium of another track in the distribution file as information defining the interaction type medium.

Furthermore, for example, the information defining the interaction type medium included in the distribution file supplied to the second information processing device may include flag information for identifying that the medium associated with the 3D data is the interaction type medium, and “‘sync’trac reference=0” indicating that the interaction type medium is reproduced asynchronously with a medium of another track. Then, in the second information processing device, the extraction unit may extract the coded data of the interaction type medium associated with the 3D data on the basis of the flag information and the “‘sync’trac reference=0”.

Note that the “event base media” flag may be stored anywhere in the distribution file. For example, the “event base media” flag may be stored in the event list in Method 2-2. Furthermore, similarly to the case of Method 2-1, Flags (Event base media mapping) may be extended instead of the “event base media” flag. Furthermore, other flag information may be set.

By doing like this, it is possible to more easily and more accurately grasp whether the medium is the interaction type medium.

Note that any one of “‘sync’trac reference=0” and “edit list ‘event base media’=1” in the example in FIG. 53 may be applied.

### <Method 2-4>

Note that, in a case where “‘sync’trac reference” or “edit list ‘event base media’” is used as in Method 2-3 described above, a device that does not recognize this function cannot correctly parse these pieces of information, and thus, there is a possibility that the interaction type medium is handled as a normal synchronous type medium. That is, there has been a possibility that the interaction type medium is reproduced by an unauthorized method.

Thus, in a case where Method 2 is applied, for example, as indicated in the bottom row of the table in FIG. 50, a restricted sample entry (RestrictedSampleEntry ‘resp’) may be defined as a haptic sample entry (HapticsSampleEntry), and a sample of the interaction type medium may be identified by its scheme type (scheme_type) (Method 2-4).

For example, in the first information processing device, the generation unit may define a sample entry indicating that another process is required in addition to a normal reproduction process in the distribution file, and store information identifying the sample of the interaction type medium in the sample entry as information defining the interaction type medium. Note that the generation unit may further store flag information for identifying that the medium associated with the 3D data is the interaction type medium outside the sample entry of the distribution file as the information defining the interaction type medium. Furthermore, the generation unit may further store “‘sync’trac reference=0” indicating that the interaction type medium is reproduced asynchronously with a medium of another track outside the sample entry of the distribution file.

Furthermore, for example, the information defining the interaction type medium included in the distribution file supplied to the second information processing device may include the sample entry indicating that another process is required in addition to the normal reproduction process. Then, the sample entry may include the information identifying the sample of the interaction type medium. Then, in the second information processing device, the extraction unit may extract the coded data of the interaction type medium associated with the 3D data on the basis of the information stored in the sample entry. Furthermore, the information defining the interaction type medium may further include flag information that is stored outside the sample entry of the distribution file and for identifying that the medium associated with the 3D data is the interaction type medium. Then, in the second information processing device, the extraction unit may further extract the coded data of the interaction type medium associated with the 3D data on the basis of the flag information.

Furthermore, the information defining the interaction type medium may further include “‘sync’trac reference=0” indicating that the interaction type medium is reproduced asynchronously with a medium of another track, which is stored outside the sample entry of the distribution file. Then, in the second information processing device, the extraction unit may further extract the coded data of the interaction type medium associated with the 3D data on the basis of “‘sync’trac reference=0”.

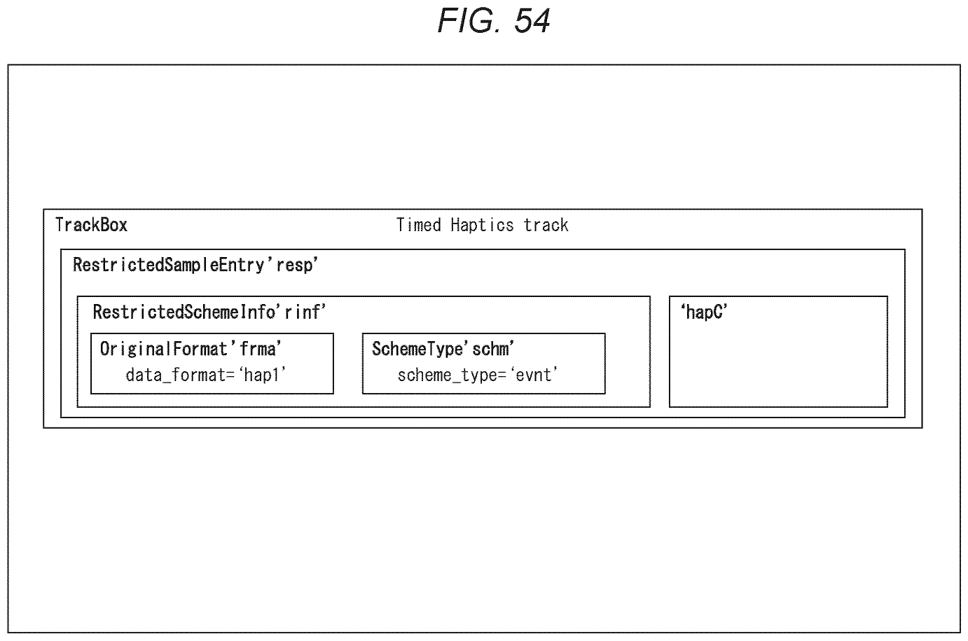

For example, as illustrated in FIG. 54, a restricted sample entry (RestrictedSampleEntry) may be defined in a track box of a track (Timed Haptics Track) that stores an interaction type medium. This restricted sample entry (RestrictedSampleEntry) is, for example, a sample entry used for encryption, 360-degree reproduction, and the like, and indicates that another process is required in addition to the normal reproduction process. In a case where the sample entry cannot be recognized, the medium cannot be reproduced. Note that “resp” indicates a restricted sample entry for a haptics medium. For example, resv may be used in a case where the medium is video. Furthermore, resa may be used in a case where the medium is audio.

Furthermore, as in the example in FIG. 54, a restricted scheme info (RestrictedSchemeInfo‘rinf’) may be defined in the restricted sample entry, and in an original format (OriginalFormat ‘frma’) inside thereof, a data format (data format) may be defined. In the case of the example in FIG. 54, “data format=‘hap1’” is set in the original format. The “hap1” is identification information indicating an encoding tool for haptics. Furthermore, as in the example in FIG. 54, a scheme type (SchemeType ‘schm’) may be defined in the restricted scheme info, and a scheme type (“scheme type=‘evnt’”) may be defined therein. The scheme type (scheme_type) indicates what kind of processing is required in reproduction. The “evnt” indicates that the medium is an interaction type medium.

By doing like this, it is possible to suppress that the interaction type medium is reproduced by an unauthorized method.

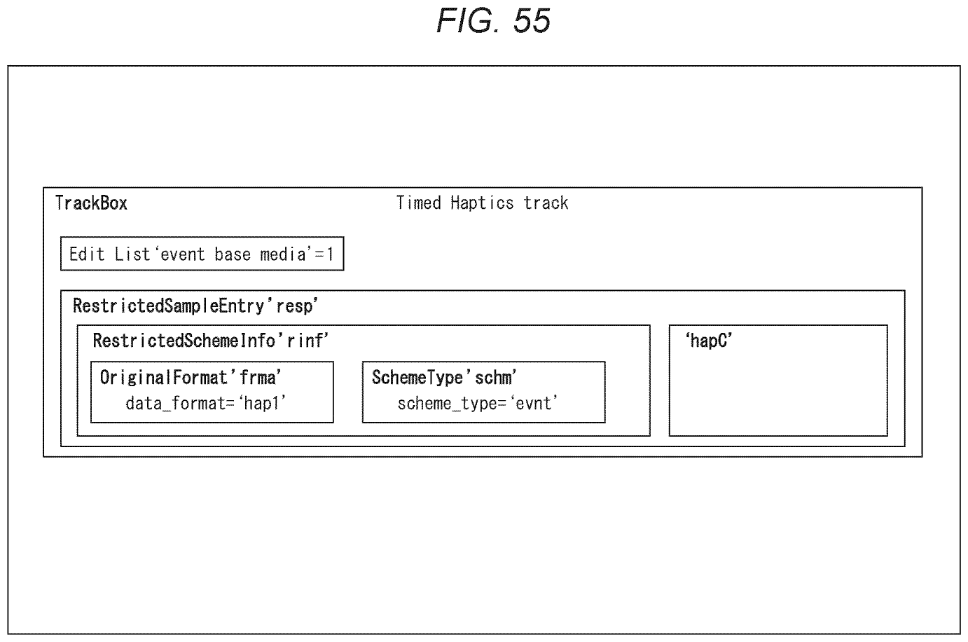

Furthermore, for example, as illustrated in FIG. 55, in addition to the example in FIG. 54, the “edit list ‘event base media’=1” described above in Method 2-3 may be applied. By doing like this, at the time of reproduction, it is possible to more easily grasp that the medium is the interaction type medium only by parsing the “edit list ‘event base media’=1” without parsing the restricted sample entry (RestrictedSampleEntry).

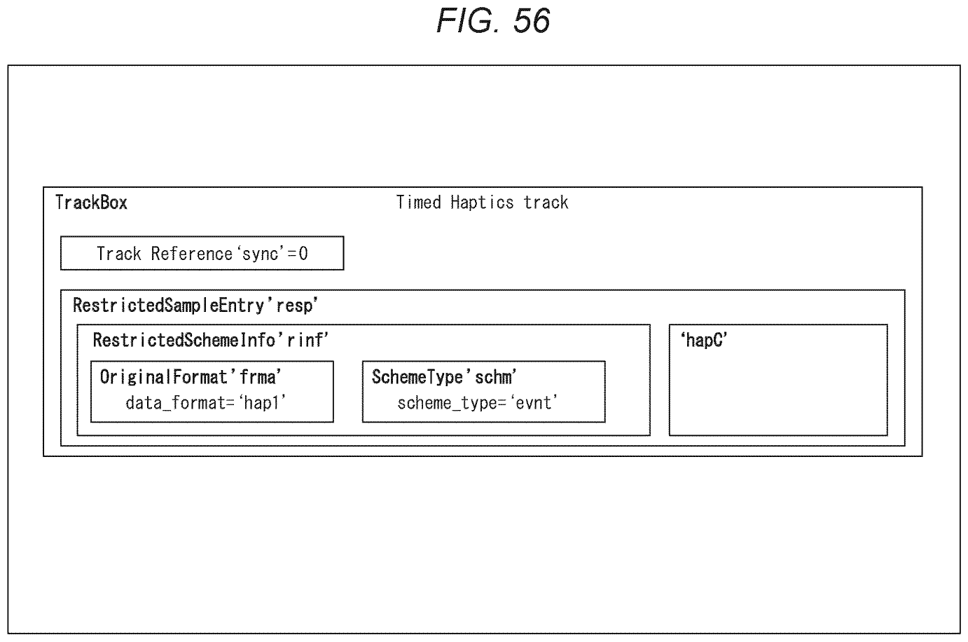

Furthermore, for example, as illustrated in FIG. 56, in addition to the example in FIG. 54, the “‘sync’trac reference=0” described above in Method 2-3 may be applied. By doing like this, at the time of reproduction, it is possible to more easily grasp that the medium is the interaction type medium (medium to be reproduced asynchronously with another medium) only by parsing the “‘sync’trac reference=0” without parsing the restricted sample entry (RestrictedSampleEntry).

Of course, in addition to the example in FIG. 54, both the “edit list ‘event base media’=1” and the “‘sync’trac reference=0” may be applied.

### 5. Storage of Haptics Medium as Metadata

### <Method 3>

In the above description, a track structure of ISOBMFF is extended, and transmission of the interaction type medium or the haptics medium is implemented. However, in general, the interaction type medium or the haptics medium have a short reproduction time, and in a case where the interaction type medium or the haptics medium is stored in a track and transmitted, there has been a possibility that a processing load for the reproduction increases.

Thus, as indicated in the fourth row from the top of the table in FIG. 34, the haptics medium (interaction type medium) is stored as metadata in ISOBMFF that is a distribution file (Method 3). As described with reference to FIGS. 18 to 20, in ISOBMFF, a general-purpose structure called a metadata box is defined. For example, HEIF that stores a still image extends and defines this metadata structure. This function is further extended so that the haptics medium (interaction type medium) can be handled as metadata for a short time.

For example, the first information processing device includes: an encoding unit that encodes a haptics medium associated with 3D data and generates coded data of the haptics medium; and a generation unit that generates a distribution file in which the coded data is stored as metadata and further including information defining the haptics medium as the metadata.

Furthermore, in the first information processing method executed by the first information processing device, a haptics medium associated with 3D data is encoded, coded data of the haptics medium is generated, and a distribution file in which the coded data is stored as metadata and including information defining the haptics medium as the metadata is generated.

For example, the second information processing device includes: an acquisition unit that acquires a distribution file in which coded data of a haptics medium associated with 3D data is stored as metadata and further including information defining the haptics medium as the metadata; an extraction unit that extracts the coded data from the distribution file on the basis of the information; and a decoding unit that decodes the extracted coded data. Furthermore, in the second information processing method executed by the second information processing device, a distribution file in which coded data of a haptics medium associated with 3D data is stored as metadata and including information defining the haptics medium as the metadata is acquired, the coded data is extracted from the distribution file on the basis of the information, and the extracted coded data is decoded.

By doing like this, it is possible to perform handling with a small reproduction overhead by defining the haptics medium (interaction type medium) having a short reproduction time as a timed meta item. That is, it is possible to suppress an increase in load of a reproduction process. Furthermore, similarly to a case where data of animation of a moving image is handled as metadata, timed haptics is also handled as similar metadata, whereby reuse is made easier and it is possible to contribute to a content ecosystem of content distribution, content production, and the like.

### <Method 3-1>

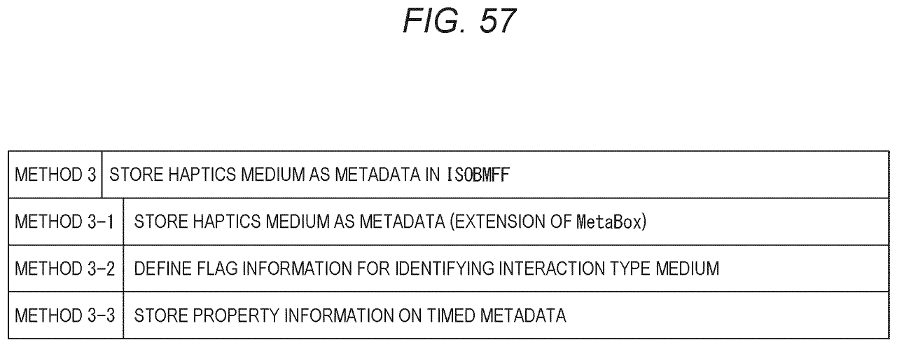

In a case where Method 3 is applied, for example, as indicated in the second row from the top of a table in FIG. 57, the meta-box (MetaBox) may be extended so that the haptics medium can be stored as metadata (Method 3-1).

For example, in the first information processing device, the generation unit may store information defining the haptics medium as the metadata in a meta-box defining the metadata of the distribution file. For example, the information that is included in the distribution file supplied to the second information processing device and defines the haptics medium as the metadata may be stored in the meta-box defining the metadata of the distribution file.

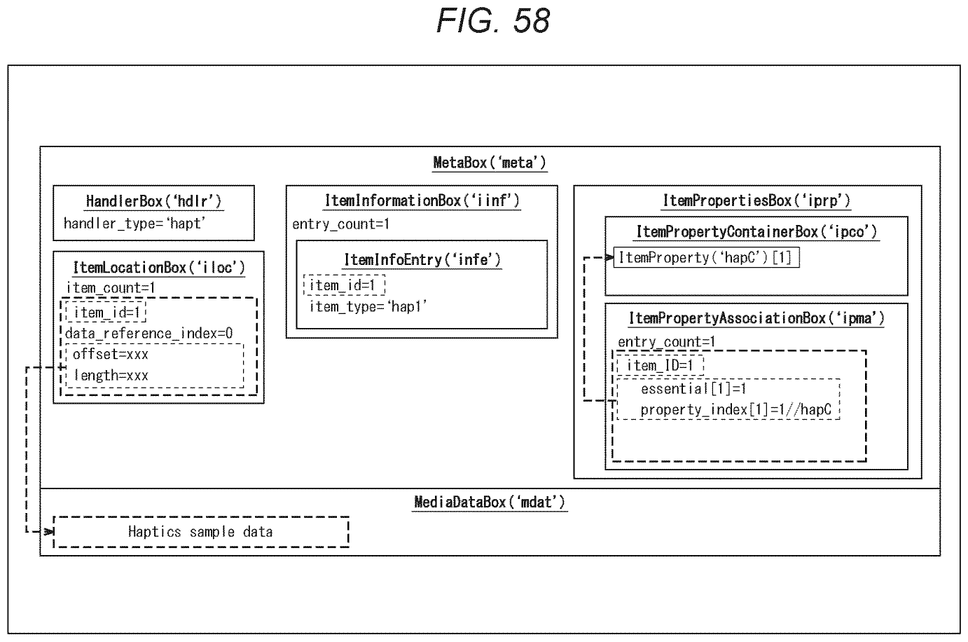

For example, the meta-box as illustrated in FIG. 58 may be extended to store information regarding the haptics medium and store the haptics medium as the metadata.

For example, in the first information processing device, the generation unit may store handler type information indicating that the metadata is the haptics medium in a handler box in the meta-box as the information defining the haptics medium as the metadata. For example, the information that is included in the distribution file supplied to the second information processing device and defines the haptics medium as the metadata may include the handler type information indicating that the metadata is the haptics medium, which is stored in the handler box in the meta-box of the distribution file. Then, in the second information processing device, the extraction unit may extract the coded data of the haptics medium associated with the 3D data on the basis of the handler type information.

For example, as illustrated in FIG. 58, handler type information (handler type) may be defined in the handler box (HandlerBox(‘hdlr’)) of the meta-box. In the case of the example in FIG. 58, a value (hapt) indicating the haptics medium is set in the handler type information (handler type=‘hapt’). With such a configuration, it is possible to easily grasp that the metadata is the haptics medium by referring to the handler type information at the time of reproduction.

For example, in the first information processing device, the generation unit may store item type information indicating an encoding tool used for encoding the haptics medium in an item info entry in the meta-box as information defining the haptics medium as the metadata. For example, the information that is included in the distribution file supplied to the second information processing device and defines the haptics medium as the metadata may include the item type information indicating the encoding tool used for encoding the haptics medium, which is stored in the item info entry in the meta-box. Then, in the second information processing device, the extraction unit may extract the coded data of the haptics medium associated with the 3D data on the basis of the item type information.

For example, as illustrated in FIG. 58, the item type information (item type) indicating an encoding tool used for encoding an item (metadata) may be defined in the item info entry (ItemInfoEntry(‘infe’)) in the item information box (ItemInformationBox(‘iinf’)) of the meta-box. In the case of the example in FIG. 58, a value (hap1) indicating the encoding tool for the haptics medium described in Method 1-1 is set in the item information (item type=‘hap1’). With such a configuration, it is possible to easily grasp the encoding tool used for encoding the item (metadata) by referring to the item information at the time of reproduction.

Note that the value indicating the encoding tool for the haptics medium may be any value, and is not limited to the example of “hap1”. For example, the hap2 described in Method 1-2 may be set in the item type information. Furthermore, the hapV described in Method 1-3 may be set in the item type information. Furthermore, the hapQ described in Method 1-4 may be set in the item type information. Furthermore, the hapW described in Method 1-5 may be set in the item type information. Furthermore, the hap21 described in Method 1-6 may be set in the item type information. Furthermore, values other than these may be set in the item type information.

For example, in the first information processing device, the generation unit may store location information indicating a storage location of the haptics medium in the item location box in the meta-box as information defining the haptics medium as the metadata. For example, the information that is included in the distribution file supplied to the second information processing device and defines the haptics medium as the metadata may include the location information indicating the storage location of the haptics medium stored in the item location box in the meta-box. Then, in the second information processing device, the extraction unit may extract the coded data of the haptics medium associated with the 3D data on the basis of the location information.

For example, as illustrated in FIG. 58, location information indicating a storage location of an item (metadata) stored in the media data box (MediaDataBox(‘mdat’)) may be defined in the item location box (ItemLocationBox(‘iloc’)) of the meta-box. In the case of the example in FIG. 58, in the location information, the storage location of the item is indicated by an offset (offset) and a length (length). With such a configuration, it is possible to easily grasp the storage location of the item (metadata) by referring to the location information at the time of reproduction.

For example, in the first information processing device, the generation unit may store item property information indicating the configuration information on the haptics medium in the item property container box in the meta-box as information defining the haptics medium as the metadata. For example, the information that is included in the distribution file supplied to the second information processing device and defines the haptics medium as the metadata may include the item property information indicating the configuration information on the haptics medium, which is stored in the item property container box in the meta-box. Then, in the second information processing device, the extraction unit may extract the coded data of the haptics medium associated with the 3D data on the basis of the item property information.

For example, as illustrated in FIG. 58, item property information (ItemProperty(‘hapC’)) indicating the configuration information on the haptics medium may be defined in an item property container box (ItemPropertiesContainerBox(‘ipco’)) of an item property box (ItemPropertiesBox(‘iprp’)) of the meta-box. The item property information is associated with the item by using the identification information (item Id) about the item in the item property association box (ItemPropertyAssociationBox(‘ipma’)). With such a configuration, it is possible to easily grasp the configuration information on the item (metadata) by referring to the item property information at the time of reproduction.

Note that, although an example in which the haptics medium is stored as the metadata has been described above, the interaction type medium may be stored as the metadata. Also in this case, the meta-box is only required to be extended similarly to the case of the haptics medium. However, a value of each piece of information is made to indicate the interaction type medium instead of the haptics medium.

### <Method 3-2>

In the case of Method 3-1, it is not clearly indicated that the haptics medium is the interaction type medium to be reproduced on an event basis. Thus, in a case where Method 3 is applied, for example, as indicated in the third row from the top of the table in FIG. 57, flag information for identifying the interaction type medium may be defined (Method 3-2).

For example, in the first information processing device, the generation unit may store flag information for identifying that the haptics medium is the interaction type medium to be reproduced on the basis of occurrence of a predetermined event in the meta-box as information defining the haptics medium as the metadata. For example, the information that is included in the distribution file supplied to the second information processing device and defines the haptics medium as the metadata may include the flag information for identifying that the haptics medium is the interaction type medium to be reproduced on the basis of occurrence of the predetermined event, which is stored in the meta-box. Then, in the second information processing device, the extraction unit may extract the coded data of the haptics medium associated with the 3D data on the basis of the flag information.

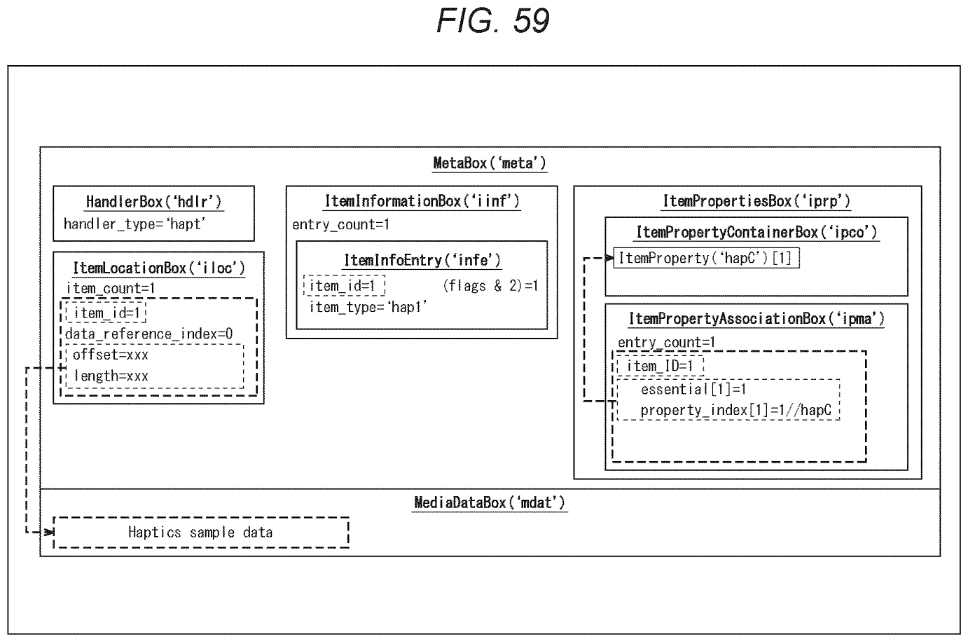

For example, as illustrated in FIG. 59, flags stored in the item info entry (ItemInfoEntry(‘infe’)) in the item information box (ItemInformationBox(‘iinf’)) of the meta-box may be extended, and in the second bit thereof, whether or not the item (metadata) is the interaction type medium may be indicated. Similarly to the Flags in the edit list box, the flags includes a plurality of bits and is flag information indicating true or false depending on its value in each bit, and the second bit is extended for the haptics medium. For example, in a case where the second bit of the flags is true (for example, “1”), it indicates that the item (metadata) is the interaction type medium ((flags & 2)=1). Furthermore, in a case where the value is false (for example, “0”), it is indicated that the item (metadata) is not the interaction type medium ((flags & 2)=0).

With such a configuration, it is possible to easily grasp whether or not the item (metadata) is the interaction type medium by referring to this flag information at the time of reproduction.

Note that this flag information may be stored in any manner, and is not limited to the example in FIG. 59.

For example, allocation may be performed on the third or subsequent bit of the flags. Furthermore, this flag information may be defined as flag information other than the flags. For example, new flag information may be defined as this flag information.

### <Method 3-3>

In the case of Method 3-1 or Method 3-2, it is not clearly indicated that the haptics medium is a meta item including timed information. Thus, in a case where Method 3 is applied, for example, as indicated in the bottom row of the table in FIG. 57, property information on timed metadata may be stored (Method 3-3).

For example, in the first information processing device, the generation unit may store the property information on the timed metadata of the haptics medium in the distribution file, and store the item property information indicating the property information in the meta-box as information defining the haptics medium as the metadata. For example, the property information on the timed metadata of the haptics medium may be stored in the distribution file supplied to the second information processing device. Then, the information that is included in the distribution file and defines the haptics medium as the metadata may include the item property information indicating the property information, which is stored in the meta-box. Then, in the second information processing device, the extraction unit may extract the coded data of the haptics medium associated with the 3D data on the basis of the item property information.

For example, the property information may include flag information indicating whether the medium is the interaction type medium to be reproduced on the basis of occurrence of a predetermined event, information indicating a scale of time information indicated in the property information, and information indicating a duration of reproduction of the haptics medium.

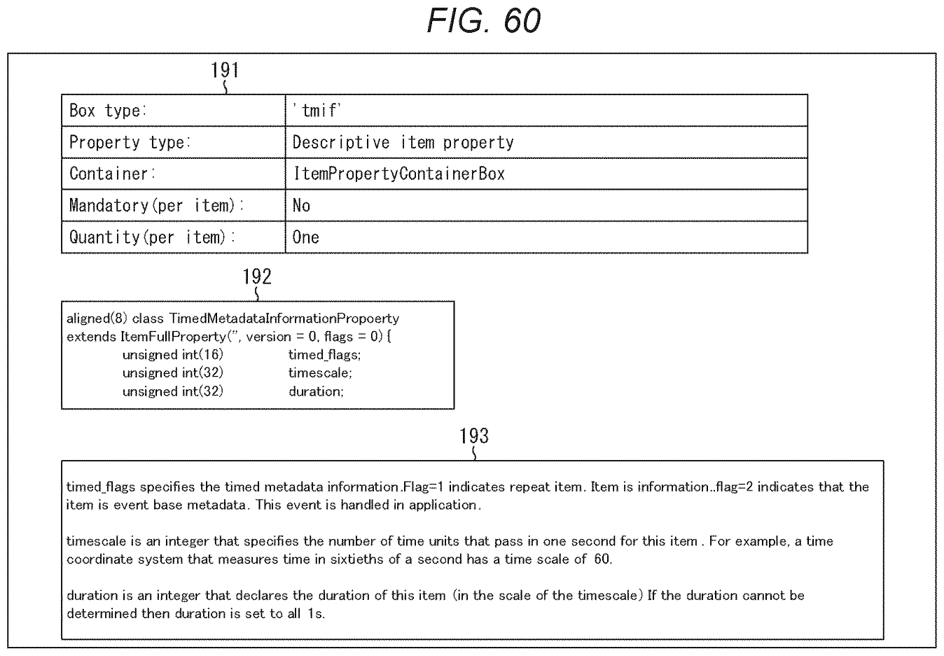

For example, as indicated in Table 191 in FIG. 60, item property information (ItemProperty(“tmif”)) is defined in an item property container box (ItemPropertyContainerBox). The item property information (ItemProperty(“tmif”)) indicates timed metadata information property (TimedMetadataInformationProperty). An example of syntax of the timed metadata information property (TimedMetadataInformationProperty) is indicated in a square 192 in FIG. 60. As indicated in the square 192, the timed metadata information property includes a timed flag (timed flags), a time scale (timescale), and a duration (duration).

An example of semantics of each element constituting the timed metadata information property (TimedMetadataInformationProperty) is indicated in a square 193 in FIG. 60. As indicated in the square 193, the timed flag (timed flags) includes a plurality of bits, and is flag information indicating true or false depending on its value in each bit. For example, the second bit of the timed flag may be used as flag information indicating whether or not the haptics medium is the interaction type medium to be reproduced on the basis of occurrence of a predetermined event. Of course, another bit (for example, the third or subsequent bit) of the timed flag may be used as the flag information indicating whether or not the medium is the timed metadata to be reproduced on an event basis. Furthermore, flag information other than the flags may be set. For example, new flag information indicating whether or not the medium is the timed metadata to be reproduced on an event basis may be added. Furthermore, the flag information may be provided outside the timed metadata information property (TimedMetadataInformationProperty). The time scale (timescale) indicates a reproduction speed (a scale of time information indicated in the property information). The time scale (timescale) may be omitted. The duration (duration) indicates a control period (that is, a duration of reproduction).

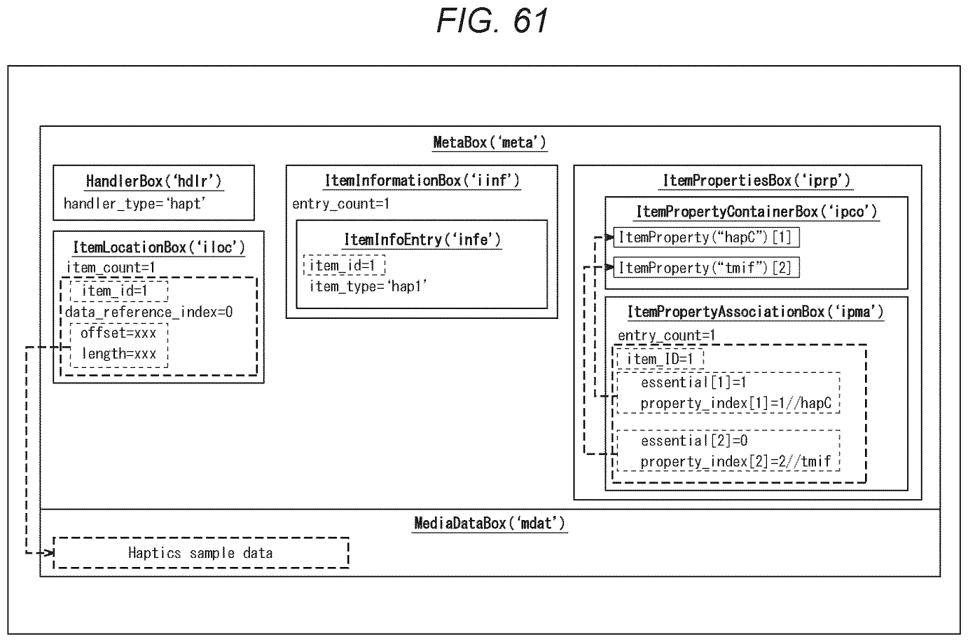

FIG. 61 is a diagram illustrating an example of the meta-box in this case. As illustrated in FIG. 61, the item property information (ItemProperty(“tmif”)) is stored in the item property container box

(ItemPropertyContainerBox). Then, in the item property association box (ItemPropertyAssociationBox(‘ipma’)), the item property information and the haptics medium (item) are associated with each other.

With such a configuration, it is possible to easily grasp timed information on the item (metadata) by referring to the item property information at the time of reproduction.

### 6. Associating 3D Data with Interaction Type Medium

### <Method 4>

As described in Non-Patent Document 2 and Non-Patent Document 5, in a conventional scene description, an association between a volumetric video that is 3D data and a haptics medium (haptics track/meta) is defined through a condition of interaction (for example, a user's contact with the volumetric video or the like) and an action (that is, reproduction of the haptics medium) generated as a result thereof, and ISOBMFF does not include information clearly indicating associating the volumetric video with the haptics medium. For that reason, for example, in a case where the scene description is not used, there has been a case where it is difficult to associate the volumetric video with the haptics medium.

Thus, as indicated in the fifth row from the top of the table in FIG. 34, the 3D data and the interaction type medium are associated with each other in ISOBMFF that is a distribution file (Method 4).

For example, the first information processing device includes: an encoding unit that encodes an interaction type medium and generates coded data of the interaction type medium; and a generation unit that generates a distribution file including the coded data and information associating the coded data with 3D data. Furthermore, in the first information processing method executed by the first information processing device, an interaction type medium is encoded, coded data of the interaction type medium is generated, and a distribution file including the coded data and information associating the coded data with 3D data is generated.

For example, the second information processing device includes: an acquisition unit that acquires a distribution file including coded data of an interaction type medium to be reproduced on the basis of occurrence of a predetermined event and information associating the coded data with 3D data; an extraction unit that extracts the coded data from the distribution file on the basis of the information; and a decoding unit that decodes the extracted coded data. Furthermore, in the second information processing method executed by the second information processing device, a distribution file including coded data of an interaction type medium to be reproduced on the basis of occurrence of a predetermined event and information associating the coded data with 3D data is acquired, the coded data is extracted from the distribution file on the basis of the information, and the extracted coded data is decoded.

Note that the interaction type medium is a medium to be reproduced on the basis of occurrence of a predetermined event.

By doing like this, in ISOBMFF, it is possible to associate the 3D data and the interaction type medium with each other. Thus, the interaction type medium can be correctly reproduced on the basis of occurrence of a predetermined event. That is, the interaction type medium can be correctly distributed as the interaction type medium. That is, it is possible to suppress a reduction in distribution performance for media data associated with 3D data.

### <Method 4-1>

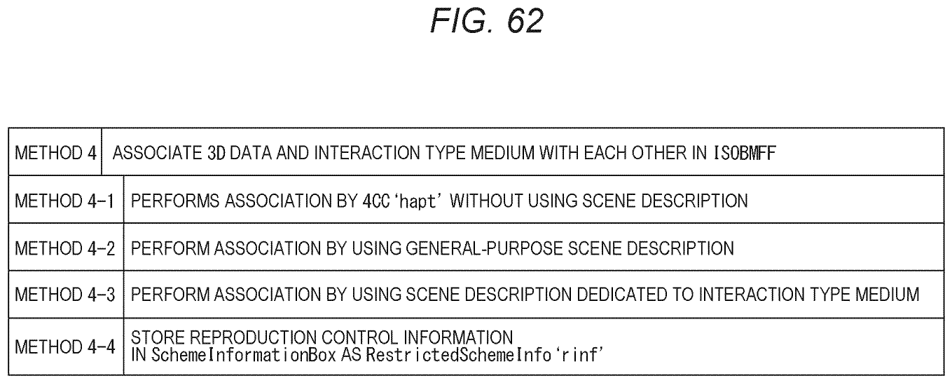

In a case where Method 4 is applied, for example, as indicated in the second row from the top of a table in FIG. 62, the 3D data and the interaction type medium may be associated with each other by 4CC‘hapt’ without using the scene description (Method 4-1).

For example, in the first information processing device, the generation unit may store identification information about a track that stores the coded data of the interaction type medium, as information associating the coded data with 3D data, in the track that stores the 3D data of the distribution file. Furthermore, for example, the information that is included in the distribution file supplied to the second information processing device and associates the coded data of the interaction type medium with the 3D data may include the identification information about the track that stores the coded data, which is stored in the track that stores the 3D data of the distribution file. Then, in the second information processing device, the extraction unit may extract the coded data on the basis of the identification information.

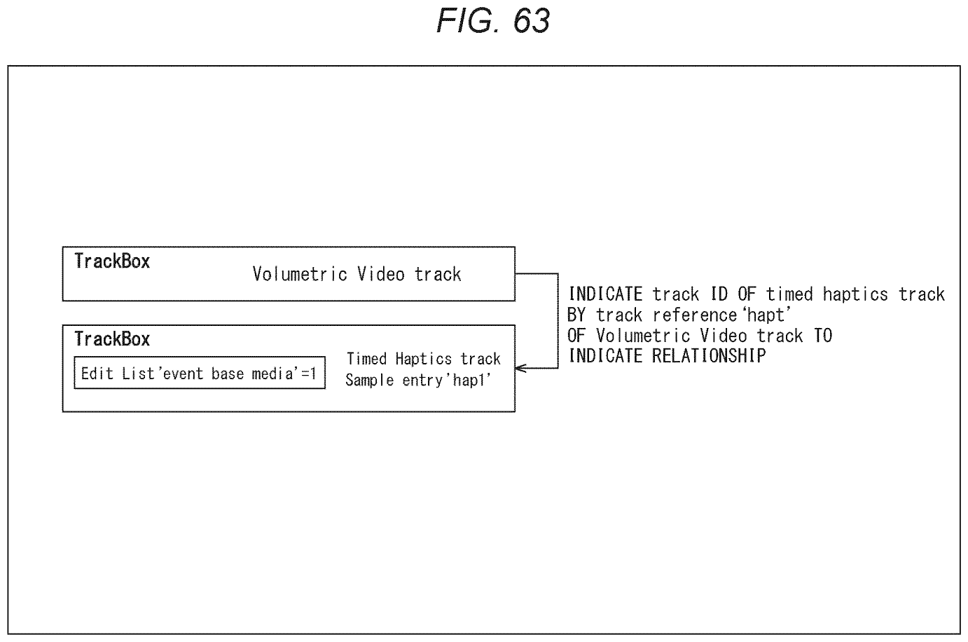

For example, as illustrated in FIG. 63, in a case where an interaction type medium is stored in a track (Timed Haptics Track), in a volumetric video track (Volumetric Video track) in which 3D data (volumetric video) is stored, track reference information (track reference ‘hapt’) indicating a track to be referred to may indicate identification information (track ID) about the track (timed haptics track) in which the interaction type medium is stored. That is, the track reference information of the volumetric video track may be used to associate the volumetric video track with the track in which the interaction type medium is stored. With such a configuration, in a case where some event occurs with respect to the 3D data of the volumetric video track, the interaction type medium associated by the track reference information can be reproduced. Note that these tracks may be stored in the same file or may be stored in different files.

For example, in the first information processing device, the generation unit may store grouping type information indicating that pieces of data belong to the same group type as information associating the coded data of the interaction type medium with the 3D data in a meta-box defining the coded data as metadata and a track that stores the 3D data, of the distribution file. Furthermore, for example, the grouping type information indicating that pieces of data belong to the same group type may be included, which is included in the distribution file supplied to the second information processing device and stored in the meta-box defining the coded data of the interaction type medium as metadata and the track that stores the 3D data. Then, in the second information processing device, the extraction unit may extract the coded data on the basis of the grouping type information.

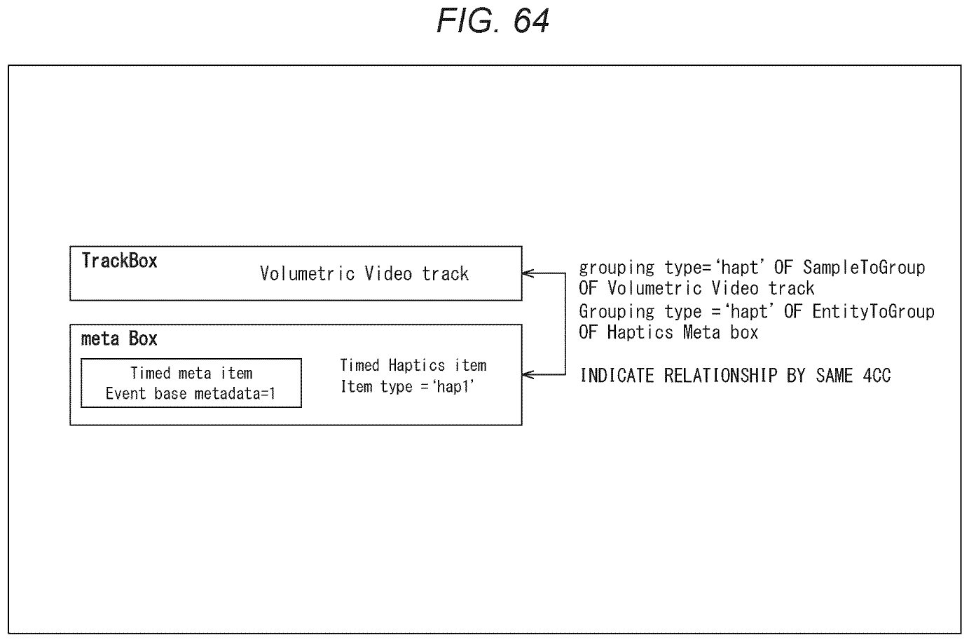

For example, as indicated in FIG. 64, in a case where an interaction type medium is stored as metadata (Timed Haptics Item), in sample-to-group (SampleToGroup) of a volumetric video track (Volumetric Video track) in which 3D data (volumetric video) is stored, the grouping type information may be set to (hapt) indicating the haptics medium (grouping type=‘hapt’). Furthermore, in entry-to-group (EntityToGroup) of a meta-box (Haptics Meta box), the grouping type information may be set to (hapt) indicating the haptics medium. That is, the same 4CC may be set as the grouping type information in the sample-to-group (SampleToGroup) of the volumetric video track (Volumetric Video track) and the entry-to-group (EntityToGroup) of the meta-box (Haptics Meta box). As described above, the 3D data and the interaction type medium are associated with each other on the basis of the same grouping type information, whereby, in a case where some event occurs with respect to the 3D data of the volumetric video track, the interaction type medium associated by the grouping type information can be reproduced. Note that the meta-box (MetaBox) and the media data box (MediaDataBox) may be stored in the same file, or may be stored in different files.

### <Method 4-2>

In a case where Method 4 is applied, for example, as indicated in the third row from the top of the table in FIG. 62, association may be performed using a general-purpose scene description (Method 4-2).

For example, in the first information processing device, the generation unit may store information associating the coded data of the interaction type medium with the 3D data in the scene description. Furthermore, for example, the information that is included in the distribution file supplied to the second information processing device and associates the coded data of the interaction type medium with the 3D data may be stored in the scene description.

Furthermore, the scene description may be stored in ISOBMFF as metadata. For example, in the first information processing device, the generation unit may store the scene description as the metadata in the distribution file. Furthermore, for example, the scene description supplied to the second information processing device may be stored in the distribution file as the metadata.

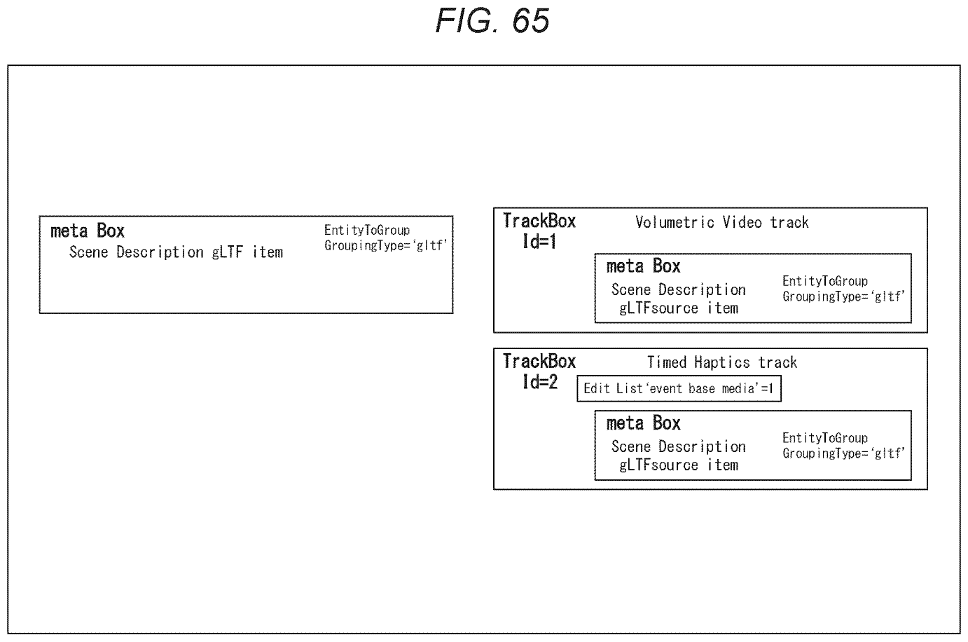

For example, as illustrated in FIG. 65, entity-to-group (EntityToGroup) may be defined in a meta-box that stores information regarding a scene description, a volumetric video track (Volumetric Video track) referred to from the scene description, and a track (Timed Haptics Track) that stores an interaction type medium referred to from the scene description, and a common group (GroupingType=‘gltf) may be set therein as grouping type information (GroupingType). That is, the scene description and each track referred to from the scene description may be associated with each other by the common group (GroupingType=′gltf). With such a configuration, in a case where some event occurs with respect to the 3D data of the volumetric video track, it is possible to reproduce the interaction type medium associated by the grouping type information. Note that these tracks may be stored in the same file or may be stored in different files.

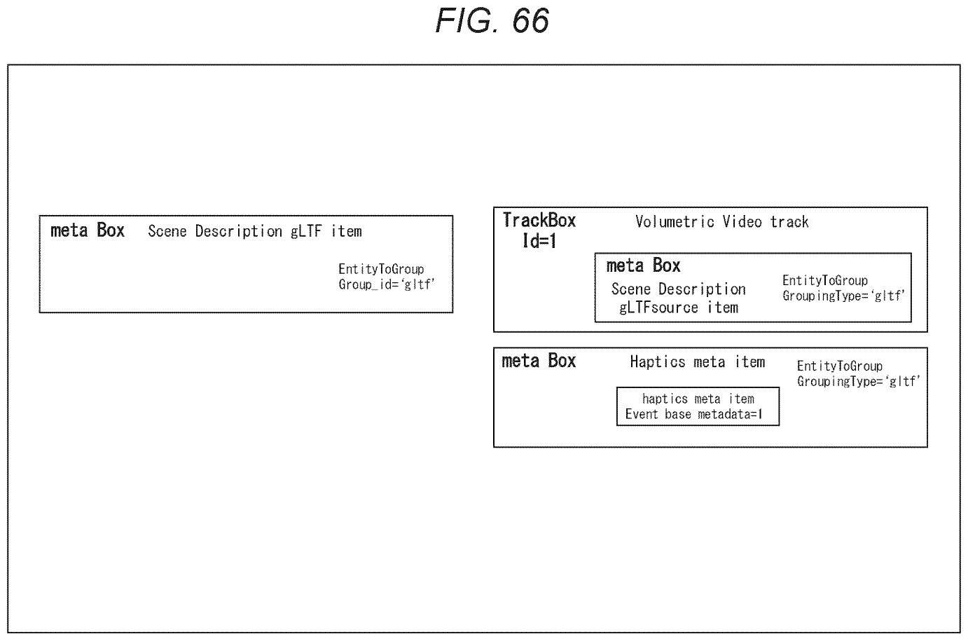

Note that, as illustrated in FIG. 66, also in a case where the interaction type medium is stored as the metadata (Timed Haptics Item), similarly to the case of FIG. 65, entity-to-group (EntityToGroup) may be defined in a meta-box that stores information regarding a scene description, a volumetric video track (Volumetric Video track) referred to from the scene description, and a meta-box (Haptics Meta Item) that stores information regarding the interaction type medium referred to from the scene description, and a common group (GroupingType=‘gltf) may be set therein as grouping type information (GroupingType). That is, also in this case, the scene description and each track referred to from the scene description may be associated with each other by the common group (GroupingType=‘gltf). With such a configuration, in a case where some event occurs with respect to the 3D data of the volumetric video track, it is possible to reproduce the interaction type medium associated by the grouping type information. Note that these tracks and items may be stored in the same file or may be stored in different files.

Note that the specification of the track is any specification, and for example, may be any of the specifications described in Method 2 to Method 2-4, or may be a specification other than these examples.

Furthermore, the specification of the meta-box is any specification, and for example, may be any of the specifications described in Method 3 to Method 3-3, or may be a specification other than these examples. For the track, the sample entry may be applied instead of the group entry.

By applying the scene description in this manner, it is possible to perform reproduction more easily.

### <Method 4-3>

The scene description can be stored as metadata in ISOBMFF. However, in a use case of handling one or a small number of volumetric videos and a haptics medium generated by interaction with the volumetric videos, there has been a possibility that overhead of scene descriptions is large, and a processing load of a terminal increases.

Thus, only information necessary for the interaction, which is defined in the scene description, may be defined as a meta item. For example, in a case where Method 4 is applied, as indicated in the fourth row from the top of the table in FIG. 62, association may be performed by using a scene description dedicated to an interaction type medium (Method 4-3).

For example, in the first information processing device, the generation unit may further store reproduction control information regarding reproduction control of the interaction type medium in the distribution file. Furthermore, for example, the reproduction control information regarding reproduction control of the interaction type medium may be further stored in the distribution file supplied to the second information processing device.

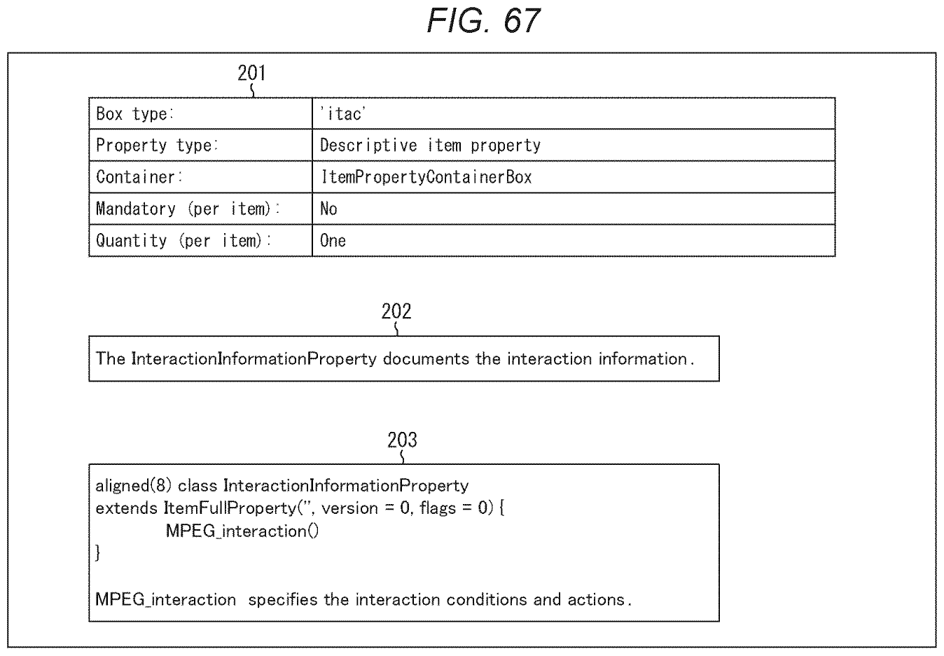

For example, as indicated in Table 201 in FIG. 67, item property information (ItemProperty(“itac”)) is defined in the item property container box (ItemPropertyContainerBox). The item property information (ItemProperty(“itac”)) indicates an interaction information property (Interaction InformationProperty). Information regarding interaction is stored in the interaction information property. An example of semantics of the interaction information property (Interaction InformationProperty) is indicated in a square 202 in FIG. 67. Furthermore, an example of syntax of the interaction information property (InteractionInformationProperty) is indicated in a square 203 in FIG. 67. As indicated in the square 203, the information regarding the interaction (in the case of the example in FIG. 67, MPEG interaction (MPEG_interaction( ))) is stored in the interaction information property.

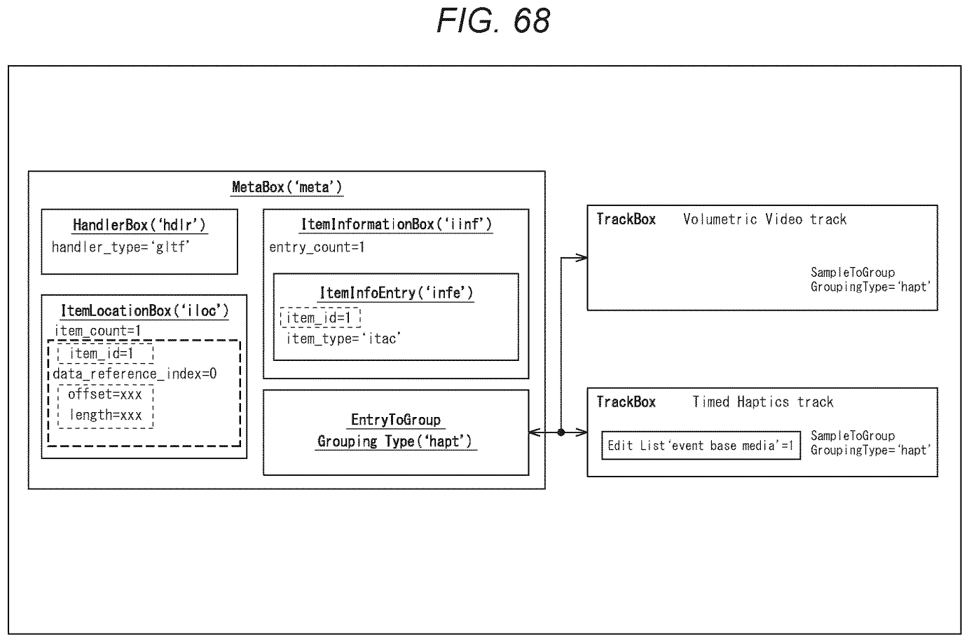

FIG. 68 is a diagram illustrating an example of the meta-box in this case. In the case of the example in FIG. 68, the haptics medium is stored in a track. The item property information (ItemProperty(“itac”)) described above is stored in the item info entry (ItemInfoEntry(‘infe’)) (item type=‘itac’). That is, the meta item ‘itac’ is defined that stores a condition of interaction (such as a user's contact with a volumetric video) defined by the scene description and MPEG_interaction defining an action generated as a result of the interaction.

Note that, in this case, associating the scene description with each track is performed using a grouping types having the same entity-to-group (EntityToGroup) and sample-to-group (SampleToGroup), as in the case of Method 4-2. Thus, interaction with the volumetric video causes a haptics track associated with the volumetric video by using the grouping type to be reproduced (rendered), as an action.

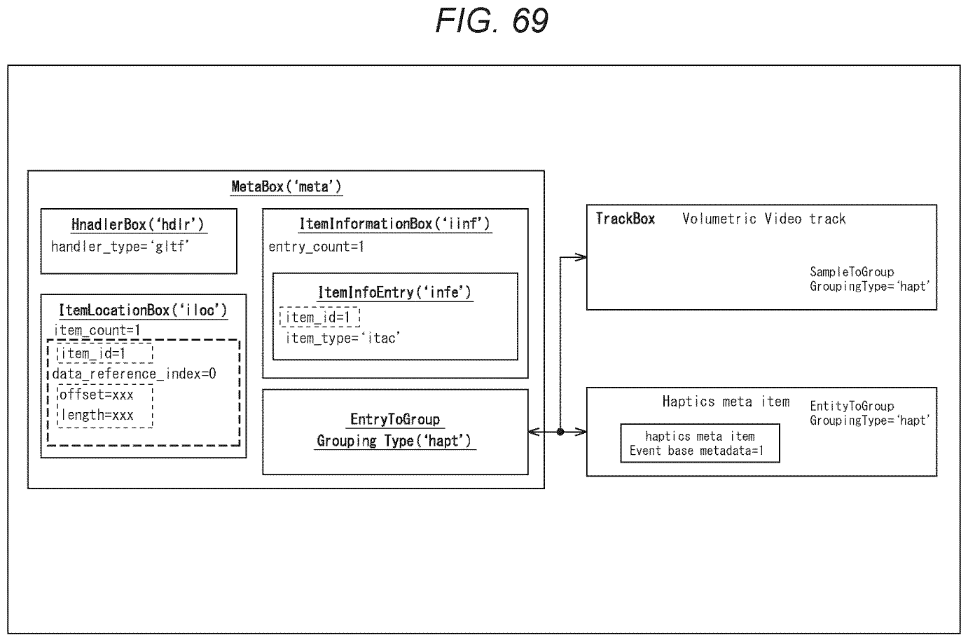

FIG. 69 is a diagram illustrating an example of the meta-box in this case. In the case of the example in FIG. 69, the haptics medium is stored as metadata. Also in this case, similarly to the case of FIG. 68, the item property information (ItemProperty(“itac”)) described above is stored in the item info entry (ItemInfoEntry(‘infe’)) (item type=‘itac’). That is, the meta item ‘itac’ is defined that stores a condition of interaction (such as a user's contact with a volumetric video) defined by the scene description and MPEG_interaction defining an action generated as a result of the interaction.

Note that, in this case, associating the scene description, the track, and the metadata with each other is performed using grouping types having the same entity-to-group (EntityToGroup) and sample-to-group (SampleToGroup), as in the case of Method 4-2. Thus, interaction with the volumetric video causes a haptics meta associated with the volumetric video by using the grouping type to be reproduced (rendered), as an action.

With such a configuration, an increase in overhead can be suppressed.

### <Method 4-4>

In a case where Method 4 is applied, for example, as indicated in the bottom row of the table in FIG. 62, reproduction control information (for example, information serving as an event condition) may be stored in a scheme information box (Scheme InformaitonBox) as restricted scheme info (RestrictedSchemeInfo‘rinf’) (Method 4-4).

For example, in the first information processing device, the generation unit may further define a sample entry indicating that another process is required in addition to the normal reproduction process in the distribution file, and store the reproduction control information in the sample entry. Furthermore, for example, the sample entry indicating that another process is required in addition to the normal reproduction process may be defined in the distribution file supplied to the second information processing device, and the reproduction control information may be stored in the sample entry.

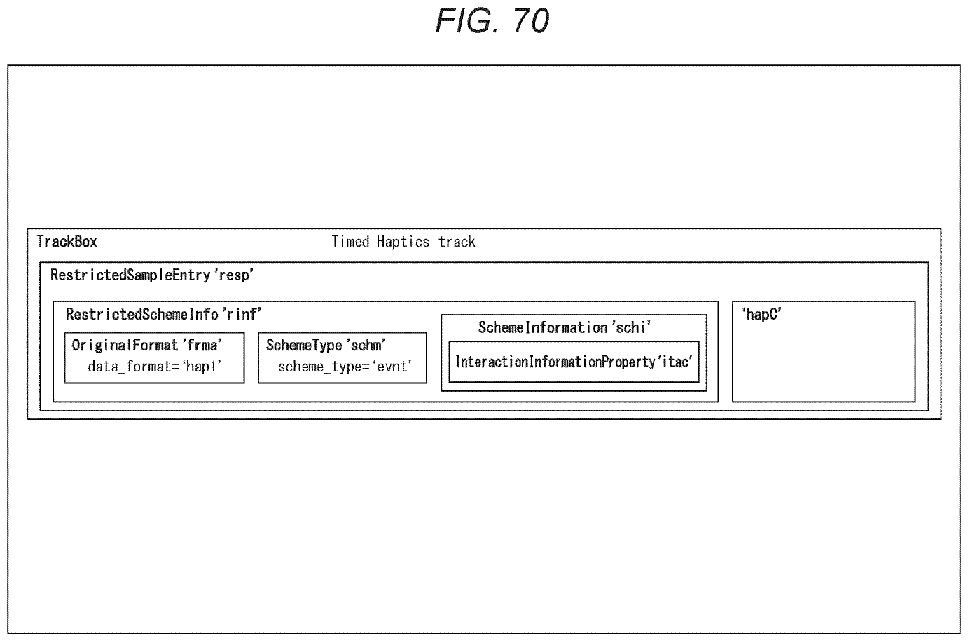

For example, as illustrated in FIG. 70, a restricted sample entry (RestrictedSampleEntry ‘resp’) may be defined in a track (Timed Haptics Track) in which the haptics medium is stored. Then, in the restricted sample entry, restricted scheme info (RestrictedSchemeInfo‘rinf’) may be defined. Then, scheme information (SchemeInformation ‘schi’) may be defined in the restricted scheme info. Then, an interaction information property (Interaction InformationProperty‘itac’) indicating an event condition may be stored in the scheme information.

By doing like this, it is possible to suppress erroneous reproduction of the interaction type medium by an unauthorized method.

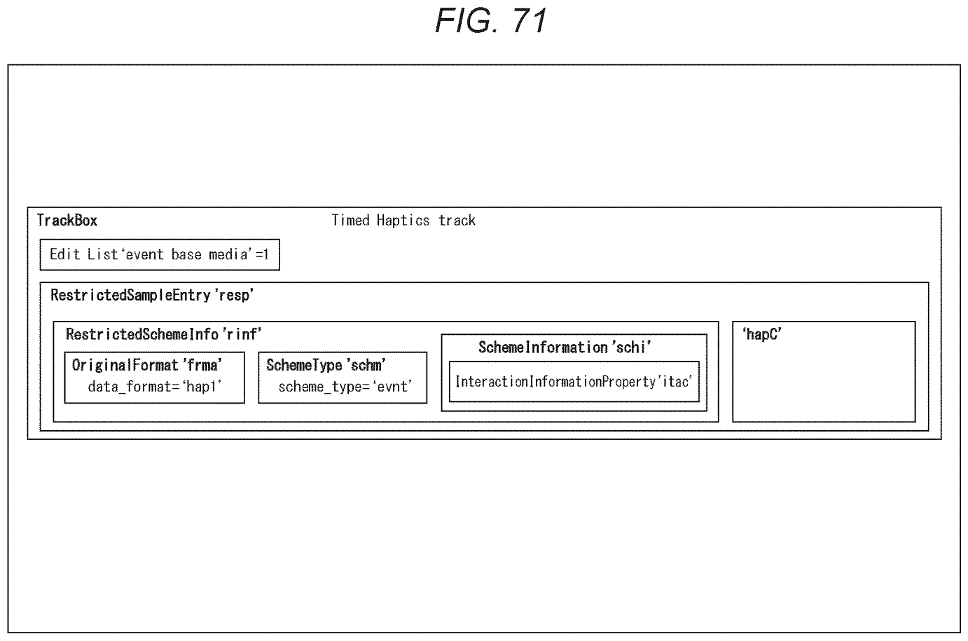

Furthermore, for example, as indicated in FIG. 71, in addition to the example in FIG. 70, the “edit list ‘event base media’=1” described above in Method 2-3 may be applied.

For example, in the first information processing device, the generation unit may further store flag information for identifying that the medium associated with the 3D data is the interaction type medium outside the sample entry of the distribution file as information associating the coded data of the interaction type medium with the 3D data. Furthermore, for example, the information that is included in the distribution file supplied to the second information processing device and associates the coded data of the interaction type medium with the 3D data may further include the flag information for identifying that the medium associated with the 3D data is the interaction type medium, which is stored outside the sample entry of the distribution file. Then, in the second information processing device, the extraction unit may further extract the coded data on the basis of the flag information.

By doing like this, at the time of reproduction, it is possible to more easily grasp that the medium is the interaction type medium only by parsing the “edit list ‘event base media’=1” without parsing the restricted sample entry (RestrictedSampleEntry).

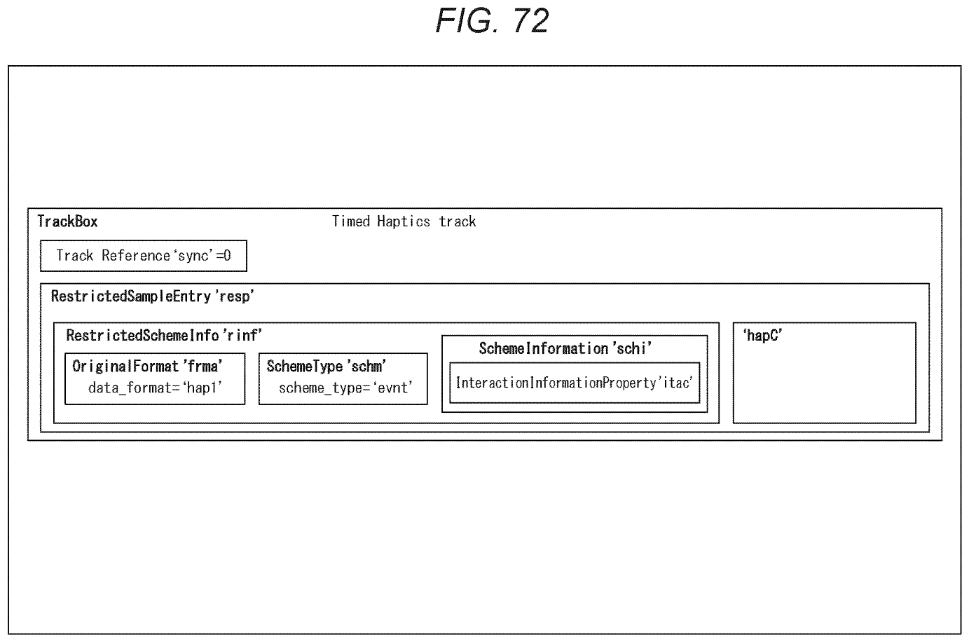

Furthermore, for example, as indicated in FIG. 72, in addition to the example in FIG. 70, the “‘sync’trac reference=0” described above in Method 2-3 may be applied.

For example, in the first information processing device, the generation unit may further store the “‘sync’trac reference=0” indicating that the interaction type medium is reproduced asynchronously with a medium of another track outside the sample entry of the distribution file as information associating the coded data of the interaction type medium with the 3D data. Furthermore, for example, the information that is included in the distribution file supplied to the second information processing device and associates the coded data of the interaction type medium with the 3D data may further include the “‘sync’trac reference=0” indicating that the interaction type medium is reproduced asynchronously with a medium of another track, which is stored outside the sample entry of the distribution file. Then, in the second information processing device, the extraction unit may extract the coded data on the basis of the “‘sync’trac reference=0”.

By doing like this, at the time of reproduction, it is possible to more easily grasp that the medium is the interaction type medium (medium to be reproduced asynchronously with another medium) only by parsing the “‘sync’trac reference=0” without parsing the restricted sample entry (RestrictedSampleEntry).

Of course, in addition to the example in FIG. 70, both the “edit list ‘event base media’=1” and the “‘sync’ trac reference=0” may be applied.

### 7. Interaction Type Medium Support in MPD

### <Method 5>

Note that the haptics medium and the interaction type medium described above may be defined in an MPD, for example. For example, as illustrated at the bottom row of the table in FIG. 34, a haptics medium and an interaction type medium are defined in the MPD (Method 5).

For example, the first information processing device includes: an encoding unit that encodes an interaction type medium associated with 3D data and generates coded data of the interaction type medium; and a generation unit that generates a media file including the coded data, and further generates a control file including control information on distribution of the media file and information defining the interaction type medium. Furthermore, in the first information processing method executed by the first information processing device, an interaction type medium associated with 3D data is encoded, coded data of the interaction type medium is generated, a media file including the coded data is generated, and further, a control file including control information on distribution of the media file and information defining the interaction type medium is generated.

Furthermore, for example, the second information processing device includes: an acquisition unit that acquires a media file on the basis of information that is included in a control file for controlling distribution of the media file including coded data of an interaction type medium associated with 3D data and defines the interaction type medium; an extraction unit that extracts the coded data from the media file; and a decoding unit that decodes the extracted coded data. Furthermore, in the second information processing method executed by the second information processing device, a media file may be acquired on the basis of information that is included in a control file for controlling distribution of the media file including coded data of an interaction type medium associated with 3D data and defines the interaction type medium, coded data may be extracted from the media file, and the extracted coded data may be decoded.

Note that the interaction type medium described above may be a medium to be reproduced on the basis of occurrence of a predetermined event.

By doing like this, for example, it is possible to indicate that the reproduction start time of an adaptation set (AdaptationSet) or representation set (Representaion) thereof is event-based, and to perform reproduction on an event basis asynchronously with a normal adaptation set (AdaptationSet) or representation (Representaion).

### <Method 5-1>

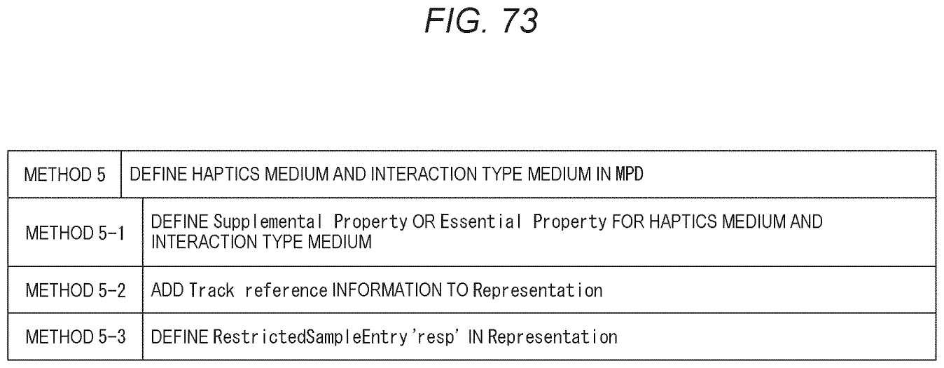

In a case where Method 5 is applied, for example, as indicated in the second row from the top of a table in FIG. 73, a supplemental property (Supplemental Property) or an essential property (Essential Property) for the haptics medium and interaction type medium may be defined (Method 5-1).

For example, in the first information processing device, the generation unit may store the information defining the interaction type medium in the supplemental property of the adaptation set of the control file. For example, the information defining the interaction type medium may be stored in the supplemental property of the adaptation set of the control file.

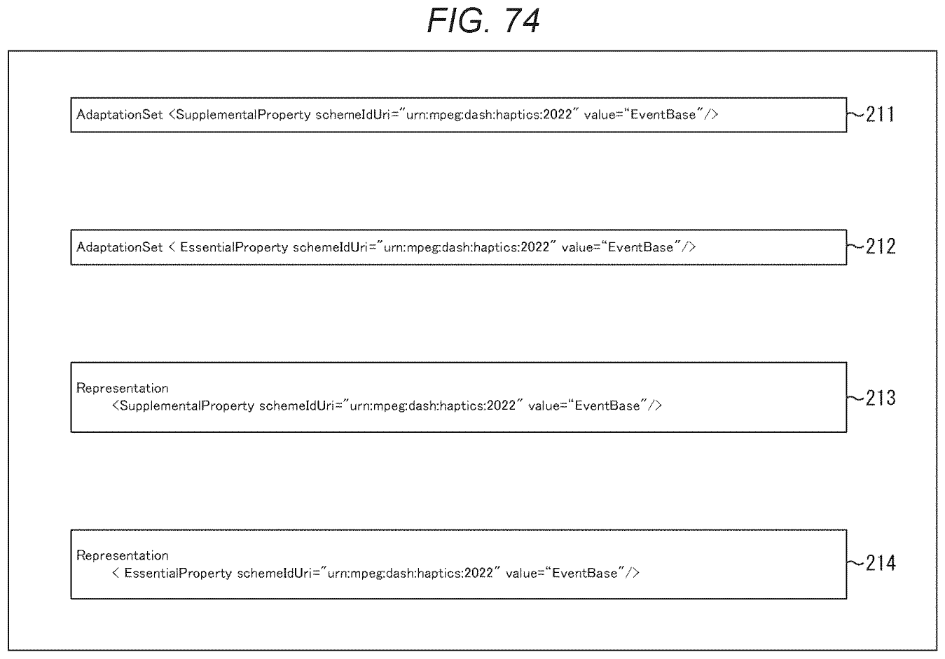

FIG. 74 is a diagram illustrating description examples of the MPD. For example, as indicated in a square 211 in FIG. 74, the information defining the interaction type medium may be described using the supplemental property in the adaptation set.

For example, in the first information processing device, the generation unit may store the information defining the interaction type medium in the essential property of the adaptation set of the control file. For example, the information defining the interaction type medium may be stored in the essential property of the adaptation set of the control file.

For example, as indicated in a square 212 in FIG. 74, the information defining the interaction type medium may be described using the essential property in the adaptation set.

For example, in the first information processing device, the generation unit may store the information defining the interaction type medium in the supplemental property of the representation of the control file. For example, the information defining the interaction type medium may be stored in the supplemental property of the representation of the control file.

For example, as indicated in a square 213 in FIG. 74, the information defining the interaction type medium may be described using the supplemental property in the representation.

For example, in the first information processing device, the generation unit may store the information defining the interaction type medium in the essential property of the representation of the control file. For example, the information defining the interaction type medium may be stored in the essential property of the representation of the control file.

For example, as indicated in a square 214 in FIG. 74, the information defining the interaction type medium may be described using the essential property in the representation.

For example, the information defining the interaction type medium may include information indicating that the interaction type medium is a haptics medium.

For example, as indicated in the squares 211 to 214 in FIG. 74, “schemeIdUri=“urn:mpeg:dash:haptics:2022”” is described to indicate that the interaction type medium is a haptics medium.

### <Method 5-2>

Furthermore, in a case where Method 5 is applied, for example, as indicated in the third row from the top of the table in FIG. 73, track reference information (Track reference) may be added to the representation (Representation) (Method 5-2).

For example, in the first information processing device, the generation unit may store information regarding a track to be referred to in the representation of the control file as the information defining the interaction type medium. For example, the information that is supplied to the second information processing device and defines the interaction type medium may include the information regarding the track to be referred to, which is stored in the representation of the control file.

For example, the information regarding the track to be referred to may include identification information about association and information indicating a type of the association.

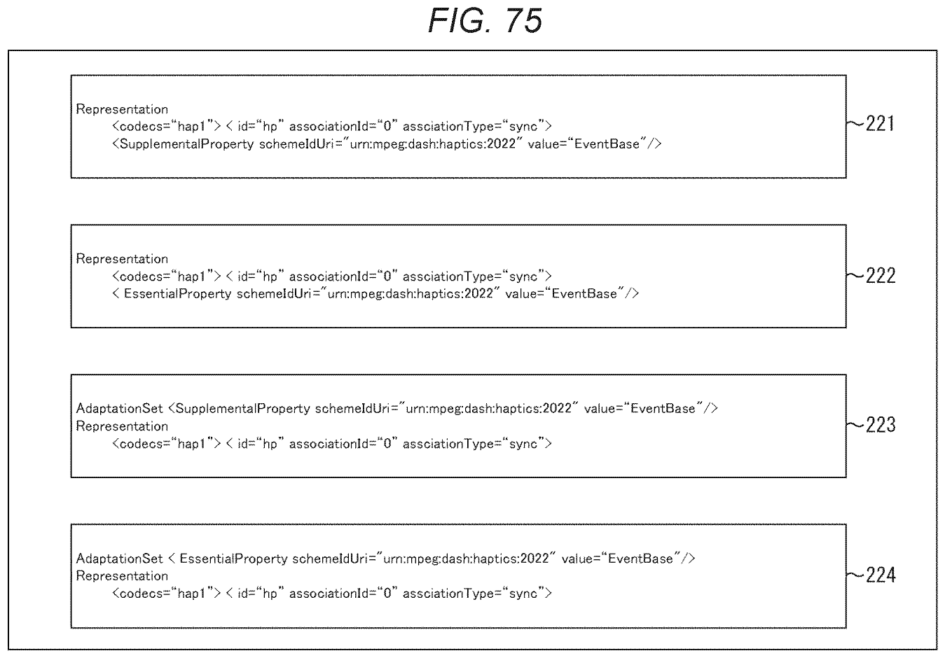

FIG. 75 is a diagram illustrating description examples of the MPD. For example, as indicated in each of squares 221 to 224 in FIG. 75, an association ID (associationId) and an association type (associationType) may be added as the track reference information in the representation. The association ID (associationId) is the identification information about the association. The association type (associationType) is information indicating the type of the association.

The description example in the square 221 in FIG. 75 corresponds to the example in the square 213 in FIG. 74, and the information defining the interaction type medium is described using the supplemental property in the representation. The description example in the square 222 in FIG. 75 corresponds to the example in the square 214 in FIG. 74, and the information defining the interaction type medium is described using the essential property in the representation. The description example in the square 223 in FIG. 75 corresponds to the example in the square 211 in FIG. 74, and the information defining the interaction type medium is described using the supplemental property in the adaptation set. The description example in the square 224 in FIG. 75 corresponds to the example in the square 212 in FIG. 74, and the information defining the interaction type medium is described using the essential property in the adaptation set.

### <Method 5-3>

Furthermore, in a case where Method 5 is applied, for example, as indicated in the bottom row of the table in FIG. 73, a restricted sample entry (RestrictedSampleEntry ‘resp’) may be defined in the representation (Representation) (Method 5-3).

For example, in the first information processing device, the generation unit may store information indicating a sample entry indicating that another process is required in addition to the normal reproduction process in the representation of the control file as the information defining the interaction type medium. For example, the information that is supplied to the second information processing device and defines the interaction type medium may include the information indicating the sample entry indicating that another process is required in addition to the normal reproduction process, which is stored in the representation of the control file.

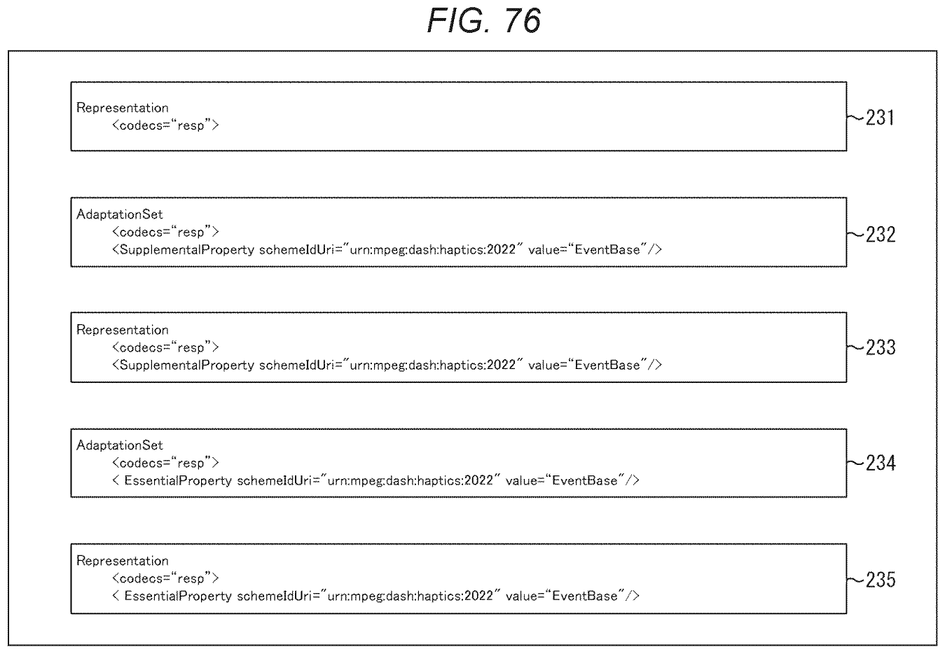

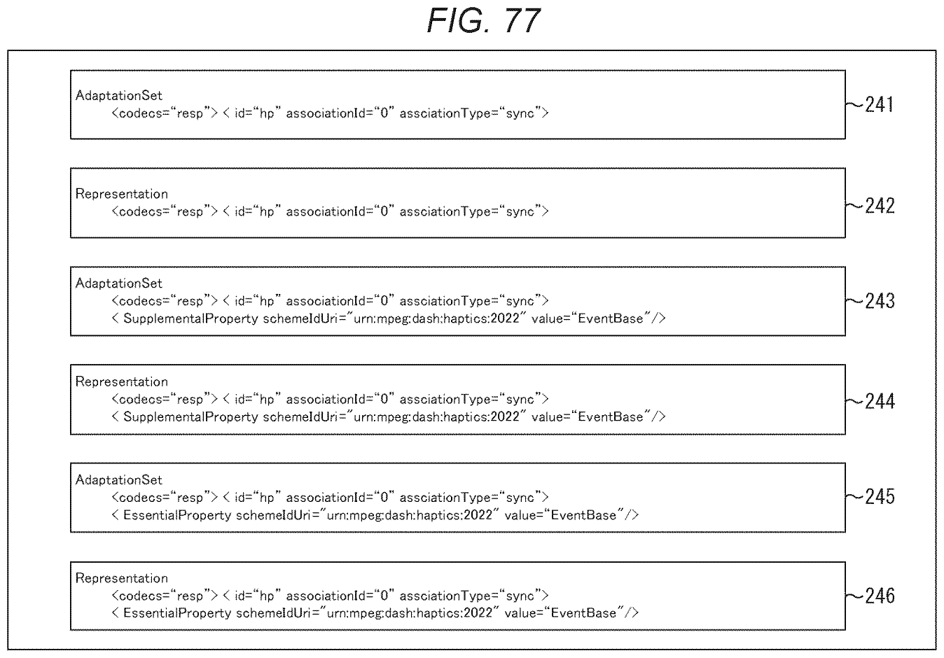

FIGS. 76 and 77 are diagrams illustrating description examples of the MPD. For example, as indicated in a square 231 in FIG. 76, <codecs=“resp”> may be described in the representation. This description indicates that the restricted sample entry (RestrictedSampleEntry ‘resp’) is applied. That is, the restricted sample entry (RestrictedSampleEntry ‘resp’) is defined in the representation (Representation).

This description may be combined with the description example in FIG. 74. For example, a description example in a square 232 in FIG. 76 corresponds to the example in the square 211 in FIG. 74, and the information defining the interaction type medium is described using the supplemental property in the adaptation set. Furthermore, a description example in a square 233 in FIG. 76 corresponds to the example in the square 213 in FIG. 74, and the information defining the interaction type medium is described using the supplemental property in the representation.

Furthermore, a description example in a square 234 in FIG. 76 corresponds to the example in the square 212 in FIG. 74, and the information defining the interaction type medium is described using the essential property in the adaptation set. Furthermore, a description example in a square 235 in FIG. 76 corresponds to the example in the square 214 in FIG. 74, and the information defining the interaction type medium is described using the essential property in the representation.

Furthermore, this description may be combined with the description example in FIG. 75. For example, as indicated in a square 241 in FIG. 77, a definition of the restricted sample entry (<codecs=“resp”>) and information indicating that the interaction type medium is a haptics medium (<id=“hp” associationId=“0” associationType=“sync”>) may be described in the adaptation set. Furthermore, as indicated in a square 242 in FIG. 77, the definition of the restricted sample entry (<codecs=“resp”>) and the information indicating that the interaction type medium is a haptics medium (id=“hp” associationId=“0” assciationType=“sync”>) may be described in the representation.

Furthermore, a description example in a square 243 in FIG. 77 corresponds to the example in the square 223 in FIG. 75, and the information defining the interaction type medium is described using the supplemental property in the adaptation set. Furthermore, a description example in a square 244 in FIG. 77 corresponds to the example in the square 221 in FIG. 75, and the information defining the interaction type medium is described using the supplemental property in the representation. Furthermore, a description example in a square 245 in FIG. 77 corresponds to the example in the square 224 in FIG. 75, and the information defining the interaction type medium is described using the essential property in the adaptation set. Furthermore, a description example in a square 246 in FIG. 77 corresponds to the example in the square 222 in FIG. 75, and the information defining the interaction type medium is described using the essential property in the representation.

### 8. Matroska Media Container

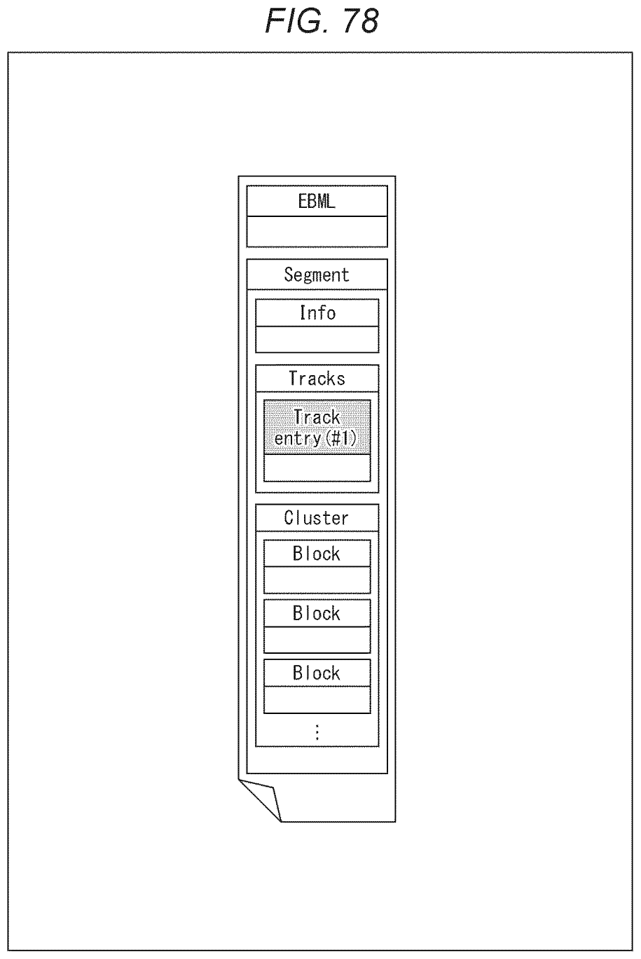

In the above description, ISOBMFF has been used as an example of the distribution file (file container); however, the format and specification of the distribution file that performs the extended definition regarding the medium associated with the 3D data may be any format and specification, and are not limited to ISOBMFF. For example, a matroska media container as illustrated in FIG. 78 may be used. Of course, other formats also may be used.

### 9. First Embodiment

### <File Generation Device>

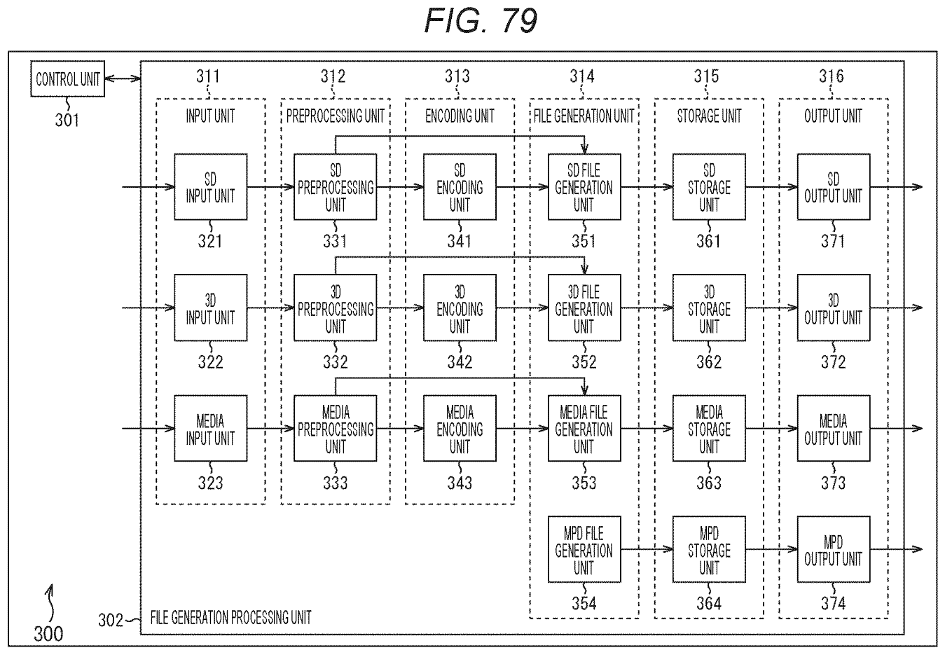

The present technology described above can be applied to any device. FIG. 79 is a block diagram illustrating an example of a configuration of a file generation device that is an aspect of an information processing device to which the present technology is applied. A file generation device 300 illustrated in FIG. 79 is a device that encodes 3D object content (for example, 3D data such as a point cloud) associated with a medium such as a haptics medium (or interaction type medium) and stores coded content in a file container of ISOBMFF or the like. Furthermore, the file generation device 300 generates a scene description file of the 3D object content.

Note that, in FIG. 79, main processing units, main data flows, and the like are illustrated, and those illustrated in FIG. 79 are not necessarily all. That is, in the file generation device 300, there may be a processing unit not illustrated as a block in FIG. 79, or there may be processing or a data flow not illustrated as an arrow or the like in FIG. 79.

As illustrated in FIG. 79, the file generation device 300 includes a control unit 301 and a file generation processing unit 302. The control unit 301 controls the file generation processing unit 302. The file generation processing unit 302 is controlled by the control unit 301 and performs processing related to file generation.

The file generation processing unit 302 includes an input unit 311, a preprocessing unit 312, an encoding unit 313, a file generation unit 314, a storage unit 315, and an output unit 316.

The input unit 311 performs processing related to acquisition of data supplied from the outside of the file generation device 100. The input unit 311 includes an SD input unit 321, a 3D input unit 322, and a media input unit 323. The SD input unit 321 acquires scene configuration data (data used for generation of a scene description) supplied to the file generation device 300. The SD input unit 321 supplies the acquired scene configuration data to an SD preprocessing unit 331 of the preprocessing unit 312. The 3D input unit 322 acquires 3D data supplied to the file generation device 300. The 3D input unit 322 supplies the acquired 3D data to a 3D preprocessing unit 332 of the preprocessing unit 312. The media input unit 323 acquires media data (data such as a haptics medium or an interaction type medium associated with 3D data) supplied to the file generation device 300. The media input unit 323 supplies the acquired media data to a media preprocessing unit 333 of the preprocessing unit 312.

The preprocessing unit 312 executes processing related to preprocessing performed on data supplied from the input unit 311 before encoding. The preprocessing unit 312 includes the SD preprocessing unit 331, the 3D preprocessing unit 332, and the media preprocessing unit 333. For example, the SD preprocessing unit 331 may acquire information necessary for generation of the scene description from the scene configuration data supplied from the SD input unit 321, and supply the information to an SD file generation unit 351 of the file generation unit 314. Furthermore, the SD preprocessing unit 331 may supply the scene configuration data to an SD encoding unit 341 of the encoding unit 313. For example, the 3D preprocessing unit 332 may acquire, from the 3D data supplied from the 3D input unit 322, information necessary for generation of a distribution file that stores the 3D data, and supply the information to an 3D file generation unit 352 of the file generation unit 314. Furthermore, the 3D preprocessing unit 332 may supply the 3D data to a 3D encoding unit 342 of the encoding unit 313. For example, the media preprocessing unit 333 may acquire, from the media data supplied from the media input unit 323, information necessary for generation of a distribution file that stores the media data, and supply the information to a media file generation unit 353 of the file generation unit 314. Furthermore, the media preprocessing unit 333 may supply the media data to a media encoding unit 343 of the encoding unit 313.

The encoding unit 313 executes processing related to encoding of the 3D data. For example, the encoding unit 313 encodes data supplied from the preprocessing unit 312 and generates coded data thereof. The encoding unit 313 includes the SD encoding unit 341, the 3D encoding unit 342, and the media encoding unit 343. The SD encoding unit 341 encodes the scene configuration data supplied from the SD preprocessing unit 331, and supplies coded data thereof to the SD file generation unit 351 of the file generation unit 314. The 3D encoding unit 342 encodes the 3D data supplied from the 3D preprocessing unit 332, and supplies coded data thereof to the 3D file generation unit 352 of the file generation unit 314. The media encoding unit 343 encodes the media data supplied from the media preprocessing unit 333, and supplies coded data thereof to the media file generation unit 353 of the file generation unit 314.

The file generation unit 314 performs processing related to generation of a file or the like. The file generation unit 314 includes the SD file generation unit 351, the 3D file generation unit 352, the media file generation unit 353, and an MPD file generation unit 354. The SD file generation unit 351 generates a scene description file that stores a scene description on the basis of the information supplied from the SD preprocessing unit 331 and the SD encoding unit 341. The SD file generation unit 351 supplies the scene description file to an SD storage unit 361 of the storage unit 315. The 3D file generation unit 352 generates a 3D file that stores the coded data of the 3D data on the basis of the information supplied from the 3D preprocessing unit 332 and the 3D encoding unit 342. The 3D file generation unit 352 supplies the 3D file to a 3D storage unit 362 of the storage unit 315. The media file generation unit 353 generates a media file that stores the coded data of the media data on the basis of the information supplied from the media preprocessing unit 333 and the media encoding unit 343. The media file generation unit 353 supplies the media file to a media storage unit 363 of the storage unit 315. The MPD file generation unit 354 generates an MPD file that stores MPD that controls distribution of the SD file, the 3D file, the media file, and the like on the basis of the various types of information supplied to the file generation unit 314. The MPD file generation unit 354 supplies the MPD file to an MPD storage unit 364 of the storage unit 315.

The storage unit 315 includes any storage medium such as a hard disk or a semiconductor memory, for example, and executes processing related to data storage. The storage unit 315 includes the SD storage unit 361, the 3D storage unit 362, the media storage unit 363, and the MPD storage unit 364. The SD storage unit 361 stores the SD file supplied from the SD file generation unit 351. Furthermore, the SD storage unit 361 supplies the

SD file to an SD output unit 371 in response to a request from the SD output unit 371 or the like of the output unit 316 or at a predetermined timing. The 3D storage unit 362 stores the 3D file supplied from the 3D file generation unit 352. Furthermore, the 3D storage unit 362 supplies the 3D file to a 3D output unit 372 in response to a request from the 3D output unit 372 or the like of the output unit 316 or at a predetermined timing. The media storage unit 363 stores the media file supplied from the media file generation unit 353. Furthermore, the media storage unit 363 supplies the media file to a media output unit 373 in response to a request from the media output unit 373 or the like of the output unit 316 or at a predetermined timing. The MPD storage unit 364 stores the MPD file supplied from the MPD file generation unit 354. Furthermore, the MPD storage unit 364 supplies the media file to an MPD output unit 374 in response to a request from the MPD output unit 374 or the like of the output unit 316 or at a predetermined timing.

The output unit 316 acquires the file or the like supplied from the storage unit 315, and outputs the file or the like to the outside of the file generation device 300 (for example, a distribution server, a reproduction device, or the like). The output unit 316 includes the SD output unit 371, the 3D output unit 372, the media output unit 373, and the MPD output unit 374. The SD output unit 371 acquires the SD file read from the SD storage unit 361, and outputs the SD file to the outside of the file generation device 300. The 3D output unit 372 acquires the 3D file read from the 3D storage unit 362, and outputs the 3D file to the outside of the file generation device 300. The media output unit 373 acquires the media file read from the media storage unit 363, and outputs the media file to the outside of the file generation device 300. The MPD output unit 374 acquires the MPD file read from the MPD storage unit 364, and outputs the MPD file to the outside of the file generation device 300.

In the file generation device 300 having the above configuration, as the first information processing device described above, the present technology described above in <3. Haptics Medium Support in ISOBMFF> to <8. Matroska Media Container> may be applied.

For example, Method 1 may be applied, the encoding unit 313 (media encoding unit 343) may encode a haptics medium associated with 3D data and generate coded data of the haptics medium, and the file generation unit 314 (media file generation unit 353) may generate a distribution file (for example, ISOBMFF) including the coded data and information defining the haptics medium.

Furthermore, any of Method 1-1 to Method 1-3 may be applied. By doing like this, it is possible for the file generation device 300 to obtain an effect similar to that described above in <3. Haptics Medium Support in

ISOBMFF>. That is, the file generation device 300 can suppress a reduction in distribution performance for the media data associated with the 3D data.

For example, Method 2 may be applied, the encoding unit 313 (media encoding unit 343) may encode an interaction type medium associated with 3D data and generate coded data of the interaction type medium, and the file generation unit 314 (media file generation unit 353) may generate a distribution file including the coded data and information defining the interaction type medium. Furthermore, any of Method 2-1 to Method 2-4 may be applied. By doing like this, the file generation device 300 can obtain an effect similar to that described above in <4. Interaction Type Medium Support in ISOBMFF>. That is, the file generation device 300 can suppress a reduction in distribution performance for the media data associated with the 3D data.

For example, Method 3 may be applied, the encoding unit 313 (media encoding unit 343) may encode a haptics medium associated with 3D data and generate coded data of the haptics medium, and the file generation unit 314 (media file generation unit 353) may store the coded data as metadata and further generate a distribution file including information defining the haptics medium as the metadata. Furthermore, any of Method 3-1 to Method 3-3 may be applied. By doing like this, the file generation device 300 can obtain an effect similar to that described above in <5. Storage of Haptics Medium as Metadata>. That is, the file generation device 300 can suppress a reduction in distribution performance for the media data associated with the 3D data.

For example, Method 4 may be applied, the encoding unit 313 (media encoding unit 343) may encode an interaction type medium and generate coded data of the interaction type medium, and the file generation unit 314 (media file generation unit 353) may generate a distribution file including the coded data and information associating the coded data with 3D data. Furthermore, any of Method 4-1 to Method 4-4 may be applied. By doing like this, the file generation device 300 can obtain an effect similar to that described above in <6. Associating 3D Data with Interaction Type Medium>. That is, the file generation device 300 can suppress a reduction in distribution performance for the media data associated with the 3D data.

For example, Method 5 may be applied, the encoding unit 313 (media encoding unit 343) may encode an interaction type medium associated with 3D data and generate coded data of the interaction type medium, and the file generation unit 314 (media file generation unit 353) may generate a media file including the coded data and further generate a control file including control information on distribution of the media file and information defining the interaction type medium. Furthermore, any of Method 5-1 to Method 5-3 may be applied. By doing like this, the file generation device 300 can obtain an effect similar to that described above in <7. Interaction Type Medium Support in MPD>. That is, the file generation device 300 can suppress a reduction in distribution performance for the media data associated with the 3D data.

Of course, the technology described above in <8. Matroska Media Container> may be applied.

### <Flow of File Generation Process>

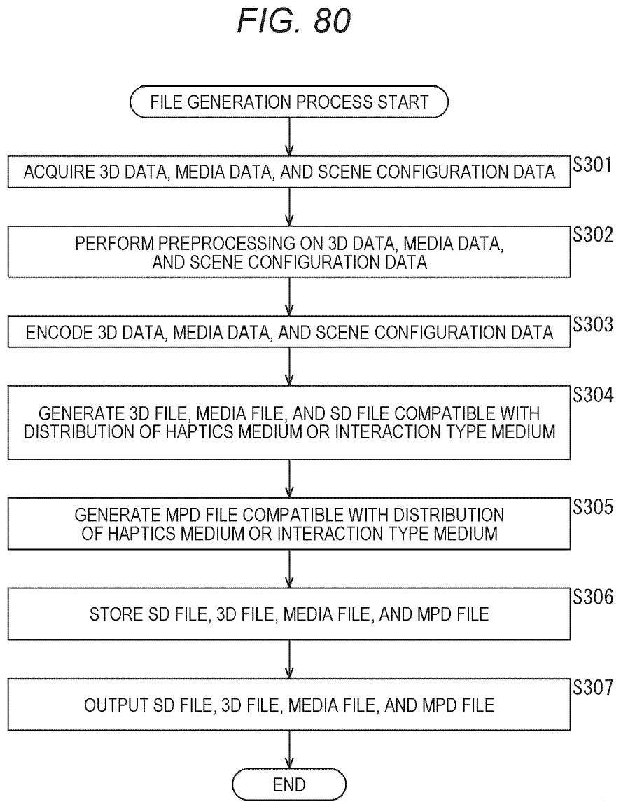

Next, an example of a flow of a file generation process executed by the file generation device 300 will be described with reference to a flowchart of FIG. 80.

When the file generation process is started, the input unit 311 (the SD input unit 321 to the media input unit 323) of the file generation device 300 acquires 3D data, media data, and scene configuration data in step S301.

In step S302, the preprocessing unit 312 (the SD preprocessing unit 331 to the media preprocessing unit 333) executes preprocessing on the 3D data, the media data, and the scene configuration data.

In step S303, the encoding unit 313 (the SD encoding unit 341 to the media encoding unit 343) encodes the 3D data, the media data, and the scene configuration data.

In step S304, the file generation unit 314 (the SD file generation unit 351 to the media file generation unit 353) generates a 3D file, a media file, and an SD file compatible with distribution of a haptics medium or interaction type medium.

In step S305, the MPD file generation unit 354 generates an MPD file compatible with distribution of the haptics medium or interaction type medium. Note that, in a case where distribution control using the MPD file is not performed, this processing may be omitted.

In step S306, the storage unit 315 (the SD storage unit 361 to the MPD storage unit 364) stores the SD file, the 3D file, the media file, and the MPD file.

In step S307, the output unit 316 (the SD output unit 371 to the MPD output unit 374) reads and outputs the SD file, the 3D file, the media file, and the MPD file from the storage unit 315.

When the processing in step S307 ends, the file generation process ends.

In such a file generation process, the present technology described above in <3. Haptics Medium Support in ISOBMFF> to <8. Matroska Media Container> may be applied.

For example, Method 1 may be applied, in step S303, the encoding unit 313 (media encoding unit 343) may encode a haptics medium associated with 3D data and generate coded data of the haptics medium, and in step S304, the file generation unit 314 (media file generation unit 353) may generate a distribution file (for example, ISOBMFF) including the coded data and information defining the haptics medium. Furthermore, any of Method 1-1 to Method 1-3 may be applied. By doing like this, it is possible for the file generation device 300 to obtain an effect similar to that described above in <3. Haptics Medium Support in ISOBMFF>. That is, the file generation device 300 can suppress a reduction in distribution performance for the media data associated with the 3D data.

For example, Method 2 may be applied, in step S303, the encoding unit 313 (media encoding unit 343) may encode an interaction type medium associated with 3D data and generate coded data of the interaction type medium, and in step S304, the file generation unit 314 (media file generation unit 353) may generate a distribution file including the coded data and information defining the interaction type medium. Furthermore, any of Method 2-1 to Method 2-4 may be applied. By doing like this, the file generation device 300 can obtain an effect similar to that described above in <4. Interaction Type Medium Support in ISOBMFF>. That is, the file generation device 300 can suppress a reduction in distribution performance for the media data associated with the 3D data.

For example, Method 3 may be applied, in step S303, the encoding unit 313 (media encoding unit 343) may encode a haptics medium associated with 3D data and generate coded data of the haptics medium, and in step S304, the file generation unit 314 (media file generation unit 353) may store the coded data as metadata and further generate a distribution file including information defining the haptics medium as the metadata. Furthermore, any of Method 3-1 to Method 3-3 may be applied. By doing like this, the file generation device 300 can obtain an effect similar to that described above in <5. Storage of Haptics Medium as Metadata>. That is, the file generation device 300 can suppress a reduction in distribution performance for the media data associated with the 3D data.

For example, Method 4 may be applied, in step S303, the encoding unit 313 (media encoding unit 343) may encode an interaction type medium and generate coded data of the interaction type medium, and in step S304, the file generation unit 314 (media file generation unit 353) may generate a distribution file including the coded data and information associating the coded data with the 3D data. Furthermore, any of Method 4-1 to Method 4-4 may be applied. By doing like this, the file generation device 300 can obtain an effect similar to that described above in <6. Associating 3D Data with Interaction Type Medium>. That is, the file generation device 300 can suppress a reduction in distribution performance for the media data associated with the 3D data.

For example, Method 5 may be applied, in step S303, the encoding unit 313 (media encoding unit 343) may encode an interaction type medium associated with 3D data and generate coded data of the interaction type medium, and in step S304, the file generation unit 314 (media file generation unit 353) may generate a media file including the coded data and further generate a control file including control information on distribution of the media file and information defining the interaction type medium. Furthermore, any of Method 5-1 to Method 5-3 may be applied. By doing like this, the file generation device 300 can obtain an effect similar to that described above in <7. Interaction Type Medium Support in MPD>. That is, the file generation device 300 can suppress a reduction in distribution performance for the media data associated with the 3D data.

Of course, the technology described above in <8. Matroska Media Container> may be applied.

### 10. Second Embodiment

### <Client Device>

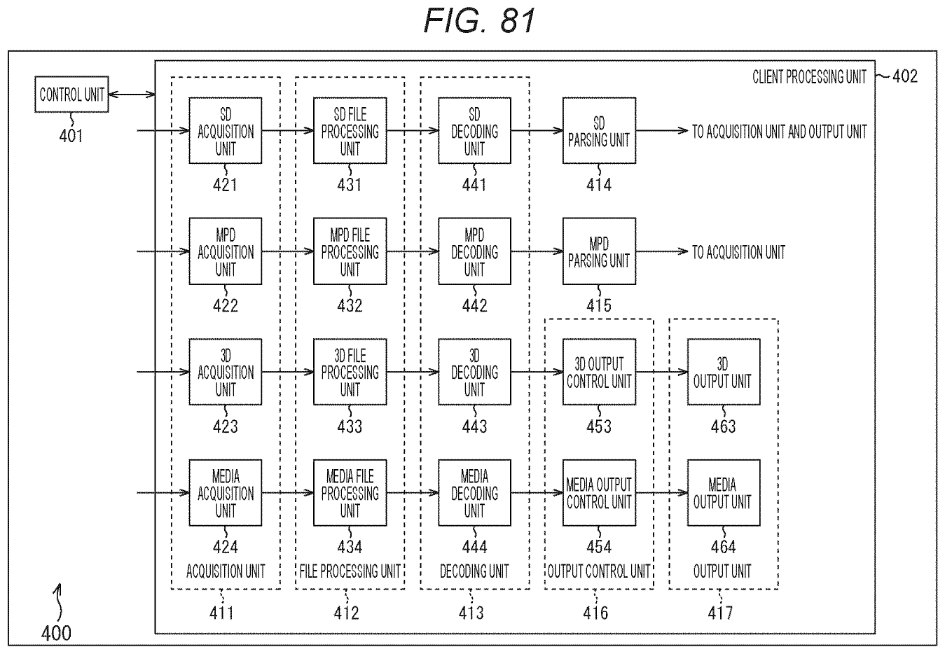

The present technology described above can be applied to any device. FIG. 81 is a block diagram illustrating an example of a configuration of a client device that is an aspect of the information processing device to which the present technology is applied. A client device 400 illustrated in FIG. 81 is a reproduction device that performs a reproduction process for 3D data and media data associated with the 3D data on the basis of a scene description. For example, the client device 400 acquires a file generated by the file generation device 300, and reproduces 3D data and media data stored in the file.

Note that, in FIG. 81, main processing units, main data flows, and the like are illustrated, and those illustrated in FIG. 81 are not necessarily all. That is, in the client device 400, there may be a processing unit not illustrated as a block in FIG. 81, or there may be processing or a data flow not illustrated as an arrow or the like in FIG. 81.

As illustrated in FIG. 81, the client device 400 includes a control unit 401 and a client processing unit 402. The control unit 401 performs processing related to control of the client processing unit 402. The client processing unit 402 performs processing related to reproduction of the 3D data and the media data.

The client processing unit 402 includes an acquisition unit 411, a file processing unit 412, a decoding unit 413, an SD parsing unit 414, an MPD parsing unit 415, an output control unit 416, and an output unit 417.

The acquisition unit 411 performs processing related to acquisition of data supplied from a distribution server, the file generation device 100, or the like to the client device 400. For example, the acquisition unit 411 includes an SD acquisition unit 421, an MPD acquisition unit 422, a 3D acquisition unit 423, and a media acquisition unit 424. The SD acquisition unit 421 acquires an SD file supplied from the outside of the client device 400, and supplies the SD file to an SD file processing unit 431 of the file processing unit 412. The MPD acquisition unit 422 acquires an MPD file supplied from the outside of the client device 400, and supplies the MPD file to an MPD file processing unit 432 of the file processing unit 412. The 3D acquisition unit 423 acquires a 3D file supplied from the outside of the client device 400, and supplies the 3D file to a 3D file processing unit 433 of the file processing unit 412. The media acquisition unit 424 acquires a media file supplied from the outside of the client device 400, and supplies the media file to a media file processing unit 434 of the file processing unit 412.

The file processing unit 412 performs processing related to the file acquired by the acquisition unit 411. For example, the file processing unit 412 may extract data stored in the file. The file processing unit 412 includes the SD file processing unit 431, the MPD file processing unit 432, the 3D file processing unit 433, and the media file processing unit 434. The SD file processing unit 431 acquires the SD file supplied from the SD acquisition unit 421, extracts coded data of a scene description from the SD file, and supplies the coded data to an SD decoding unit 441. The MPD file processing unit 432 acquires the MPD file supplied from the MPD acquisition unit 422, extracts coded data of MPD from the MPD file, and supplies the coded data to an MPD decoding unit 442. The 3D file processing unit 433 acquires the 3D file supplied from the 3D acquisition unit 423, extracts coded data of the 3D data from the 3D file, and supplies the coded data to a 3D decoding unit 443. The media file processing unit 434 acquires the media file supplied from the media acquisition unit 424, extracts coded data of the media data from the media file, and supplies the coded data to a media decoding unit 444.

The decoding unit 413 performs processing related to decoding of the coded data supplied from the file processing unit 412. The decoding unit 413 includes the SD decoding unit 441, the MPD decoding unit 442, the 3D decoding unit 443, and the media decoding unit 444. The SD decoding unit 441 decodes the coded data of the scene description supplied from the SD file processing unit 431, generates (restores) the scene description, and supplies the scene description to the SD parsing unit 414. The MPD decoding unit 442 decodes the coded data of the MPD supplied from the MPD file processing unit 432, generates (restores) the MPD, and supplies the MPD to the MPD parsing unit 415. The 3D decoding unit 443 decodes the coded data of the 3D data supplied from the 3D file processing unit 433, generates (restores) the 3D data, and supplies the 3D data to a 3D output control unit 453. The media decoding unit 444 decodes the coded data of the media data supplied from the media file processing unit 434, generates (restores) the media data, and supplies the media data to a media output control unit 454.

The SD parsing unit 414 performs processing related to parsing of the scene description. For example, the SD parsing unit 414 may acquire the scene description supplied from the SD decoding unit 441, parse the scene description, and control the acquisition unit 411 and the output control unit 416 according to the description.

The MPD parsing unit 415 performs processing related to parsing of the MPD. For example, the MPD parsing unit 415 may acquire the MPD supplied from the MPD decoding unit 442, parse the MPD, and control the acquisition unit 411 according to the description.

The output control unit 416 performs processing related to output control of the 3D data and the media data. For example, the output control unit 416 can perform processing such as rendering using the 3D data and the media data. The output control unit 416 includes the 3D output control unit 459 and the media output control unit 454. The 3D output control unit 453 performs rendering or the like using the 3D data supplied from the 3D decoding unit 443, generates information (for example, an image or the like) to be output, and supplies the information to a 3D output unit 463 of the output unit 417. The media output control unit 454 performs rendering or the like using the media data supplied from the media decoding unit 444, generates information (for example, vibration information or the like) to be output, and supplies the information to a media output unit 464 of the output unit 417.

The output unit 417 includes a display device, an audio output device, a haptics device (for example, a vibration device), and the like, and performs processing related to information output (image display, audio output, haptics medium output (for example, vibration output), or the like). The output unit 417 includes the 3D output unit 463 and the media output unit 464. The 3D output unit 463 includes, for example, an image display device such as a display, an audio output device such as a speaker, and the like, and outputs information for outputting the 3D data (for example, a display image, output audio information, and the like) supplied from the 3D output control unit 453, by using these devices. The media output unit 464 includes, for example, an output device for a haptics medium or an interaction type medium, such as a vibration device, and outputs information for outputting the media data (for example, vibration information or the like) supplied from the media output control unit 454, by using the output device.

In the client device 400 having the above configuration, as the second information processing device described above, the present technology described above in <3. Haptics Medium Support in ISOBMFF> to <8. Matroska Media Container> may be applied.

For example, Method 1 may be applied, and the acquisition unit 411 (media acquisition unit 424) may acquire a distribution file including coded data of a haptics medium associated with 3D data and information defining the haptics medium. Furthermore, the file processing unit 412 (media file processing unit 434) may extract the coded data from the distribution file on the basis of the information. Furthermore, the decoding unit 413 (media decoding unit 444) may decode the extracted coded data. Furthermore, any of Method 1-1 to Method 1-3 may be applied. By doing like this, it is possible for the client device 400 to obtain an effect similar to that described above in <3. Haptics Medium Support in ISOBMFF>. That is, the client device 400 can suppress a reduction in distribution performance for the media data associated with the 3D data.

For example, Method 2 may be applied, and the acquisition unit 411 (media acquisition unit 424) may acquire a distribution file including coded data of an interaction type medium associated with 3D data and information defining the interaction type medium. Furthermore, the file processing unit 412 (media file processing unit 434) may extract the coded data from the distribution file on the basis of the information. Furthermore, the decoding unit 413 (media decoding unit 444) may decode the extracted coded data. Furthermore, any of Method 2-1 to Method 2-4 may be applied. By doing like this, the client device 400 can obtain an effect similar to that described above in <4. Interaction Type Medium Support in ISOBMFF>. That is, the client device 400 can suppress a reduction in distribution performance for the media data associated with the 3D data.

For example, Method 3 may be applied, and the acquisition unit 411 (media acquisition unit 424) may store coded data of a haptics medium associated with 3D data as metadata and further acquire a distribution file including information defining the haptics medium as the metadata. Furthermore, the file processing unit 412 (media file processing unit 434) may extract the coded data from the distribution file on the basis of the information. Furthermore, the decoding unit 413 (media decoding unit 444) may decode the extracted coded data. Furthermore, any of Method 3-1 to Method 3-3 may be applied. By doing like this, the client device 400 can obtain an effect similar to that described above in <5. Storage of Haptics Medium as Metadata>. That is, the client device 400 can suppress a reduction in distribution performance for the media data associated with the 3D data.

For example, Method 4 may be applied, and the acquisition unit 411 (media acquisition unit 424) may acquire a distribution file including coded data of an interaction type medium to be reproduced on the basis of occurrence of a predetermined event and information associating the coded data with 3D data. Furthermore, the file processing unit 412 (media file processing unit 434) may extract the coded data from the distribution file on the basis of the information. Furthermore, the decoding unit 413 (media decoding unit 444) may decode the extracted coded data. Furthermore, any of Method 4-1 to Method 4-4 may be applied. By doing like this, the client device 400 can obtain an effect similar to that described above in <6. Associating 3D Data with

Interaction Type Medium>. That is, the client device 400 can suppress a reduction in distribution performance for the media data associated with the 3D data.

For example, Method 5 may be applied, and the acquisition unit 411 (media acquisition unit 424) may acquire a media file on the basis of information that is included in a control file for controlling distribution of the media file including coded data of an interaction type medium associated with 3D data and defines the interaction type medium. Furthermore, the file processing unit 412 (media file processing unit 434) may extract the coded data from the media file. Furthermore, the decoding unit 413 (media decoding unit 444) may decode the extracted coded data. Furthermore, any of

Method 5-1 to Method 5-3 may be applied. By doing like this, the client device 400 can obtain an effect similar to that described above in <7. Interaction Type Medium Support in MPD>. That is, the client device 400 can suppress a reduction in distribution performance for the media data associated with the 3D data.

Of course, the technology described above in <8. Matroska Media Container> may be applied.

### <Flow of Reproduction Process>

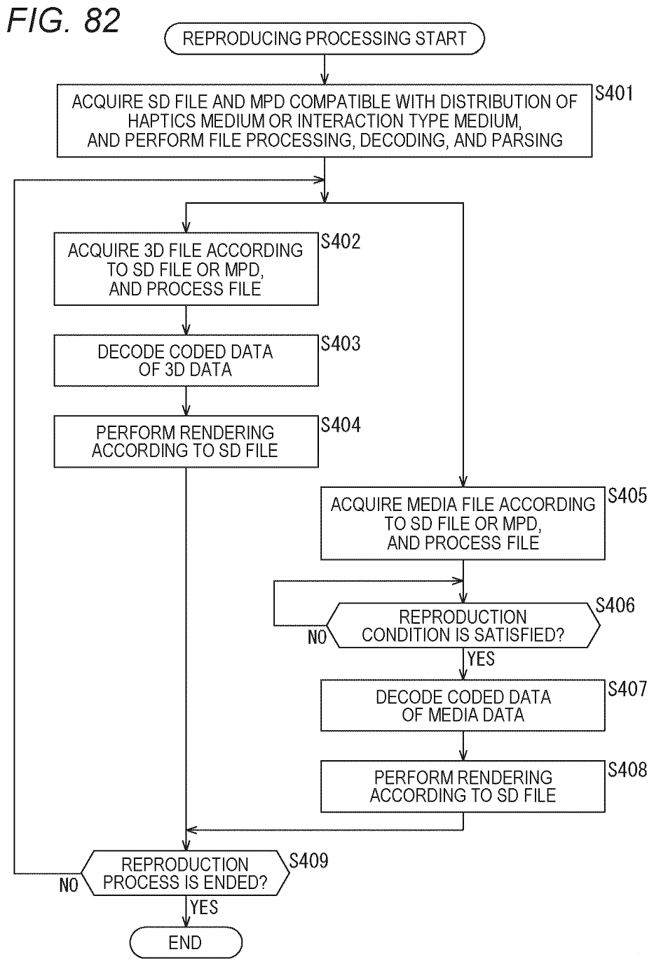

Next, an example of a flow of the reproduction process executed by the client device 400 will be described with reference to a flowchart of FIG. 82.

When the reproduction process is started, the acquisition unit 411 (the SD acquisition unit 421 and the MPD acquisition unit 422) of the client device 400 acquires an SD file and an MPD file compatible with distribution of a haptics medium or interaction type medium in step S401. The file processing unit 412 (the SD file processing unit 431 and the MPD file processing unit 432) extracts coded data of a scene description and coded data of an MPD from the acquired SD file and MPD file. The decoding unit 413 (the SD decoding unit 441 and the MPD decoding unit 442) decodes the coded data of the scene description and the coded data of the MPD, and generates (restores) the scene description and the MPD. The SD parsing unit 414 parses the scene description and controls acquisition of a 3D file and a media file on the basis of a result of the parsing. Furthermore, the SD parsing unit 414 controls output of the 3D file and the media file on the basis of the result of the parsing. Furthermore, the MPD parsing unit 415 parses the MPD and controls acquisition of the 3D file and the media file on the basis of a result of the parsing.

In step S402, the 3D acquisition unit 423 acquires the 3D file according to the control by the SD parsing unit 414 or the MPD parsing unit 415 (control based on the result of the parsing of the scene description or the MPD).

In step S403, the 3D file processing unit 433 extracts coded data of 3D data from the acquired 3D file. Furthermore, the 3D decoding unit 443 decodes the coded data of the 3D data extracted, and generates (restores) the 3D data.

In step S404, the 3D output control unit 453 generates information for outputting the 3D data by rendering the 3D data or the like according to the control by the SD parsing unit 414. The 3D output unit 463 outputs the information for the outputting (for example, an image, audio, or the like). When the processing in step S404 ends, the processing proceeds to step S409.

In parallel with (independently of) the processing in steps S402 to S404, the processing in steps S405 to S408 can be executed.

In step S405, the media acquisition unit 424 acquires the media file according to the control by the SD parsing unit 414 or the MPD parsing unit 415 (control based on the result of the parsing of the scene description or the MPD).

In step S406, the media file processing unit 434 determines whether or not a reproduction condition of the acquired media file is satisfied, and waits until it is determined that the reproduction condition is satisfied. In a case where the reproduction condition is satisfied, the processing proceeds to step S407.

In step S407, the media file processing unit 434 extracts coded data of media data from the acquired media file. Furthermore, the media decoding unit 444 decodes the coded data of the media data extracted, and generates (restores) the media data.

In step S408, the media output control unit 454 generates information for outputting the media data by rendering the media data or the like according to the control by the SD parsing unit 414. The media output unit 464 outputs the information for the outputting (for example, vibration information or the like). When the processing in step S408 ends, the processing proceeds to step S409.

In step S409, the control unit 401 determines whether or not to end the reproduction process. In a case where it is determined that the processing is not ended, the processing returns to steps S402 and S405. Furthermore, in a case where it is determined to end the reproduction process, the reproduction process ends.

In the client device 400 having the above configuration, as the second information processing device described above, the present technology described above in <3. Haptics Medium Support in ISOBMFF> to <8. Matroska Media Container> may be applied.

For example, Method 1 may be applied, and in step S405, the acquisition unit 411 (media acquisition unit 424) may acquire a distribution file including coded data of a haptics medium associated with 3D data and information defining the haptics medium. Furthermore, in step S407, the file processing unit 412 (media file processing unit 434) may extract the coded data from the distribution file on the basis of the information. Furthermore, in step S407, the decoding unit 413 (media decoding unit 444) may decode the extracted coded data. Furthermore, any of Method 1-1 to Method 1-3 may be applied. By doing like this, it is possible for the client device 400 to obtain an effect similar to that described above in <3. Haptics Medium Support in ISOBMFF>. That is, the client device 400 can suppress a reduction in distribution performance for the media data associated with the 3D data.

For example, Method 2 may be applied, and in step S405, the acquisition unit 411 (media acquisition unit 424) may acquire a distribution file including coded data of an interaction type medium associated with 3D data and information defining the interaction type medium. Furthermore, in step S407, the file processing unit 412 (media file processing unit 434) may extract the coded data from the distribution file on the basis of the information. Furthermore, in step S407, the decoding unit 413 (media decoding unit 444) may decode the extracted coded data. Furthermore, any of Method 2-1 to Method 2-4 may be applied. By doing like this, the client device 400 can obtain an effect similar to that described above in <4. Interaction Type Medium Support in ISOBMFF>. That is, the client device 400 can suppress a reduction in distribution performance for the media data associated with the 3D data.

For example, Method 3 may be applied, and in step S405, the acquisition unit 411 (media acquisition unit 424) may store coded data of a haptics medium associated with 3D data as metadata, and may further acquire a distribution file including information defining the haptics medium as the metadata. Furthermore, in step S407, the file processing unit 412 (media file processing unit 434) may extract the coded data from the distribution file on the basis of the information. Furthermore, in step S407, the decoding unit 413 (media decoding unit 444) may decode the extracted coded data. Furthermore, any of Method 3-1 to Method 3-3 may be applied. By doing like this, the client device 400 can obtain an effect similar to that described above in <5. Storage of Haptics Medium as Metadata>. That is, the client device 400 can suppress a reduction in distribution performance for the media data associated with the 3D data.

For example, Method 4 may be applied, and in step S405, the acquisition unit 411 (media acquisition unit 424) may acquire a distribution file including coded data of an interaction type medium to be reproduced on the basis of occurrence of a predetermined event and information associating the coded data with 3D data. Furthermore, in step S407, the file processing unit 412 (media file processing unit 434) may extract the coded data from the distribution file on the basis of the information. Furthermore, in step S407, the decoding unit 413 (media decoding unit 444) may decode the extracted coded data. Furthermore, any of Method 4-1 to Method 4-4 may be applied. By doing like this, the client device 400 can obtain an effect similar to that described above in <6. Associating 3D Data with Interaction Type Medium>. That is, the client device 400 can suppress a reduction in distribution performance for the media data associated with the 3D data.

For example, Method 5 may be applied, and in step S405, the acquisition unit 411 (media acquisition unit 424) may acquire a media file on the basis of information defining an interaction type medium included in a control file for controlling distribution of the media file including coded data of the interaction type medium associated with 3D data. Furthermore, in step S407, the file processing unit 412 (media file processing unit 434) may extract the coded data from the media file. Furthermore, in step S407, the decoding unit 413 (media decoding unit 444) may decode the extracted coded data. Furthermore, any of Method 5-1 to Method 5-3 may be applied. By doing like this, the client device 400 can obtain an effect similar to that described above in <7. Interaction Type Medium Support in MPD>. That is, the client device 400 can suppress a reduction in distribution performance for the media data associated with the 3D data.

Of course, the technology described above in <8. Matroska Media Container> may be applied.

### 11. Supplementary Note

### <Combination>

Each example (each method) of the present technology described above may be appropriately combined with other examples (other methods) and applied as long as there is no contradiction. Furthermore, each example of the present technology described above may be applied in combination with another technology other than the above-described technology.

### <Computer>

The above-described series of processing can be executed by hardware or software. In a case where the series of processing is executed by software, a program included in the software is installed on a computer. Here, the computer includes a computer incorporated in dedicated hardware, a general-purpose personal computer capable of executing various functions by installing various programs, and the like, for example.

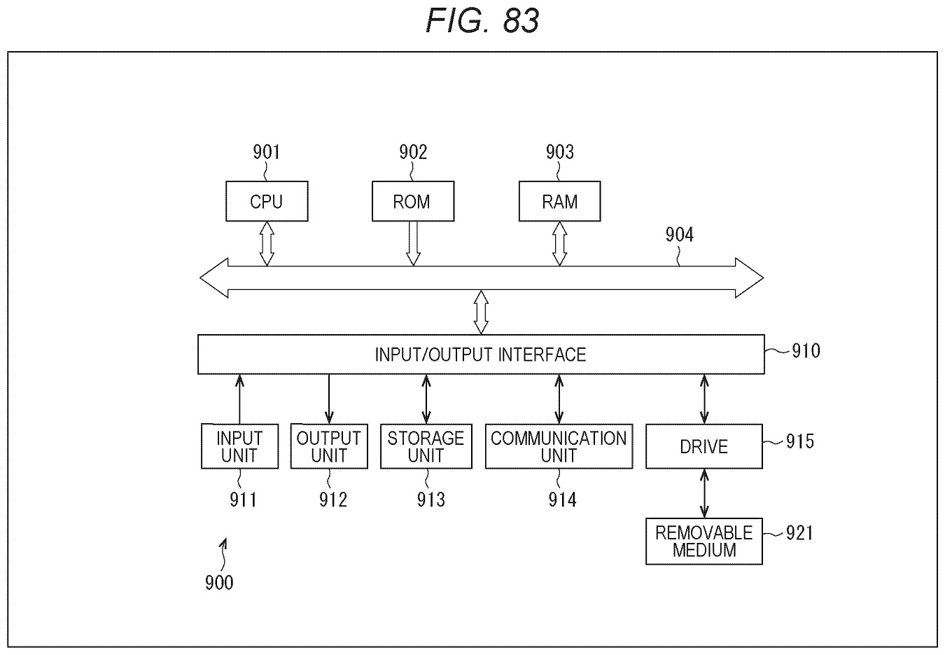

FIG. 83 is a block diagram illustrating a configuration example of hardware of a computer that executes the above-described series of processing by a program.

In a computer 900 illustrated in FIG. 83, a central processing unit (CPU) 901, a read only memory (ROM) 902, and a random access memory (RAM) 903 are connected to each other via a bus 904.

Furthermore, an input/output interface 910 is also connected to the bus 904. An input unit 911, an output unit 912, a storage unit 913, a communication unit 914, and a drive 915 are connected to the input/output interface 910.

The input unit 911 includes, for example, a keyboard, a mouse, a microphone, a touch panel, an input terminal, and the like. The output unit 912 includes, for example, a display, a speaker, an output terminal, and the like. The storage unit 913 includes, for example, a hard disk, a RAM disk, a non-volatile memory, and the like. The communication unit 914 includes, for example, a network interface. The drive 915 drives a removable medium 921 such as a magnetic disk, an optical disk, a magneto-optical disk, or a semiconductor memory.

In the computer configured as described above, for example, the CPU 901 loads a program stored in the storage unit 913 into the RAM 903 via the input/output interface 910 and the bus 904 and executes the program, whereby the above-described series of processing is performed. Furthermore, the RAM 903 also appropriately stores data and the like necessary for the CPU 901 to execute various types of processing.

A program executed by the computer can be applied by being recorded on the removable medium 921 as a package medium or the like, for example. In this case, the program can be installed in the storage unit 913 via the input/output interface 910 by attaching the removable medium 921 to the drive 915.

Furthermore, the program can also be provided via a wired or wireless transmission medium such as a local area network, the Internet, or digital satellite broadcasting. In this case, the program can be received by the communication unit 914 and installed in the storage unit 913.

In addition, the program can be installed in the ROM 902 or the storage unit 913 in advance.

### <Target to Which Present Technology Is Applicable>

The present technology can be applied to any encoding/decoding method.

Furthermore, the present technology can be applied to any configuration. For example, the present technology can be applied to various electronic devices.

Furthermore, for example, the present technology can also be implemented as a partial configuration of a device, such as a processor (for example, a video processor) as a system large scale integration (LSI) or the like, a module (for example, a video module) using a plurality of the processors or the like, a unit (for example, a video unit) using a plurality of the modules or the like, or a set (for example, a video set) obtained by further adding other functions to the unit.

Furthermore, for example, the present technology can also be applied to a network system including a plurality of devices. For example, the present technology may be implemented as cloud computing shared and processed in cooperation by a plurality of devices via a network. For example, the present technology may be implemented in a cloud service that provides a service related to an image (moving image) to any terminal such as a computer, an audio visual (AV) device, a portable information processing terminal, or an Internet of Things (IoT) device.

Note that, in the present specification, a system means a set of a plurality of components (devices, modules (parts) and the like), and it does not matter whether or not all the components are in the same housing. Thus, a plurality of devices housed in different housings and connected together via a network and one device in which a plurality of modules is stored in one housing are both systems.

<Field and Application to which Present Technology is Applicable>

The system, device, processing unit, and the like to which the present technology is applied can be used in any field such as traffic, medical care, crime prevention, agriculture, livestock industry, mining, beauty care, factory, household appliance, weather, and natural surveillance, for example. Furthermore, application thereof is also any application.

For example, the present technology can be applied to systems and devices used for providing content for appreciation and the like. Furthermore, for example, the present technology can also be applied to systems and devices used for traffic, such as traffic condition management and automated driving control. Moreover, for example, the present technology can also be applied to systems and devices used for security. Furthermore, for example, the present technology can be applied to systems and devices used for automatic control of a machine and the like. Moreover, for example, the present technology can also be applied to systems and devices used for use in agriculture and livestock industry. Furthermore, the present technology can also be applied to systems and devices that monitor, for example, the status of nature such as a volcano, a forest, and the ocean, wildlife and the like. Moreover, for example, the present technology can also be applied to systems and devices used for sports.

### <Others>

Note that, in the present specification, a “flag” is information for identifying a plurality of states, and includes not only information used for identifying two states of true (1) and false (0) but also information capable of identifying three or more states. Thus, the value that can be taken by the “flag” may be, for example, two values of 1/0 or three or more values. That is, the number of bits forming the “flag” is any number, and may be one bit or a plurality of bits. Furthermore, identification information (including the flag) is assumed to have not only a form of including, in a bitstream, the identification information but also a form of including, in the bitstream, information on a difference of the identification information with respect to certain reference information, and thus, in the present specification, the “flag” and “identification information” include not only the information but also information on a difference with respect to reference information.

Furthermore, various types of information (such as metadata) regarding coded data (bitstream) may be transmitted or recorded in any form as long as the information is associated with the coded data. Herein, the term “associate” is intended to mean to make, when processing one data, the other data available (linkable), for example. That is, pieces of data associated with each other may be collected as one data or may be made individual data. For example, information associated with the coded data (image) may be transmitted on a transmission path different from that for the coded data (image). Furthermore, for example, the information associated with the coded data (image) may be recorded in a recording medium different from that for the coded data (image) (or another recording area of the same recording medium). Note that, this “association” may be of not entire data but a part of data. For example, an image and information corresponding to the image may be associated with each other in any unit such as a plurality of frames, one frame, or a part within a frame.

Note that, in the present specification, terms such as “combine”, “multiplex”, “add”, “integrate”, “include”, “store”, “put in”, “introduce”, and “insert” mean, for example, to combine a plurality of objects into one, such as to combine coded data and metadata into one data, and mean one method of the “associate” described above.

Furthermore, embodiments of the present technology are not limited to the above-described embodiments, and various modifications are possible without departing from the scope of the present technology.

For example, a configuration described as one device (or processing unit) may be divided and configured as a plurality of devices (or processing units). Conversely, configurations described above as a plurality of devices (or processing units) may be collectively configured as one device (or processing unit).

Furthermore, it goes without saying that a configuration other than the above-described configurations may be added to the configuration of each device (or each processing unit). Moreover, when the configuration and operation as the entire system are substantially the same, a part of the configuration of a certain device (or processing unit) may be included in the configuration of another device (or another processing unit).

Furthermore, for example, the above-described programs may be executed in any device. In that case, the device is only required to have a necessary function (functional block or the like) and obtain necessary information.

Furthermore, for example, each step in one flowchart may be executed by one device, or may be executed by being shared by a plurality of devices. Moreover, in a case where a plurality of pieces of processing is included in one step, the plurality of pieces of processing may be executed by one device, or may be shared and executed by a plurality of devices. In other words, a plurality of pieces of processing included in one step can be executed as a plurality of steps. Conversely, processing described as a plurality of steps can also be collectively executed as one step.

Furthermore, for example, in a program executed by the computer, processing in steps describing the program may be executed in a time-series order in the order described in the present specification, or may be executed in parallel or individually at a required timing such as when a call is made. That is, as long as there is no contradiction, the processing of each step may be executed in an order different from the above-described order. Moreover, the processing in the steps describing the program may be executed in parallel with processing by another program, or may be executed in combination with the processing by the other program.

Furthermore, for example, a plurality of technologies related to the present technology can be implemented independently as a single entity as long as there is no contradiction. It goes without saying that any plurality of present technologies can be implemented in combination. For example, a part or all of the present technologies described in any of the embodiments can be implemented in combination with a part or all of the present technologies described in other embodiments. Furthermore, a part or all of any of the above-described present technologies can be implemented together with another technology that is not described above.

Note that the present technology can also have the following configurations.
(1) An information processing device including:
an encoding unit that encodes an interaction type medium associated with 3D data and generates coded data of the interaction type medium; and
a generation unit that generates a distribution file including the coded data and information defining the interaction type medium,
in which
the interaction type medium is a medium to be reproduced on the basis of occurrence of a predetermined event.
(2) The information processing device according to (1), in which
the generation unit stores flag information for identifying that the medium associated with the 3D data is the interaction type medium, in the distribution file, as the information.
(3) The information processing device according to (2), in which
the flag information is Flags stored in EditListBox of the distribution file.
(4) The information processing device according to (2) or (3), in which
the generation unit further stores “‘sync’trac reference=0” indicating that the interaction type medium is reproduced asynchronously with a medium of another track, in the distribution file, as the information.
(5) The information processing device according to any of (1) to (4), in which
the generation unit stores an edit list for controlling reproduction in accordance with occurrence of the event, in the distribution file, as the information.
(6) The information processing device according to (5), in which
information corresponding to media time having a value of “−2” in the edit list is control information for controlling reproduction in accordance with occurrence of the event.
(7) The information processing device according to any of (1) to (6), in which
the generation unit defines a sample entry indicating that another process is required in addition to a normal reproduction process in the distribution file, and stores information identifying a sample of the interaction type medium, in the sample entry, as the information.
(8) The information processing device according to (7), in which
the generation unit further stores flag information for identifying that the medium associated with the 3D data is the interaction type medium, outside the sample entry of the distribution file, as the information.
(9) The information processing device according to (7), in which
the generation unit further stores “‘sync’trac reference=0” indicating that the interaction type medium is reproduced asynchronously with a medium of another track, outside the sample entry of the distribution file, as the information.
(10) An information processing method including:
encoding an interaction type medium associated with 3D data and generating coded data of the interaction type medium; and
generating a distribution file including the coded data and information defining the interaction type medium, in which
the interaction type medium is a medium to be reproduced on the basis of occurrence of a predetermined event.
(11) An information processing device including:
an acquisition unit that acquires a distribution file including coded data of an interaction type medium associated with 3D data and information defining the interaction type medium;
an extraction unit that extracts the coded data from the distribution file on the basis of the information; and
a decoding unit that decodes the coded data extracted,
in which
the interaction type medium is a medium to be reproduced on the basis of occurrence of a predetermined event.
(12) The information processing device according to (11), in which
the information includes flag information for identifying that the medium associated with the 3D data is the interaction type medium, and
the extraction unit extracts the coded data on the basis of the flag information.
(13) The information processing device according to (12), in which
the flag information is Flags stored in EditListBox of the distribution file.
(14) The information processing device according to (12) or (13), in which
the information further includes “‘sync’trac reference=0” indicating that the interaction type medium is reproduced asynchronously with a medium of another track, and
the extraction unit extracts the coded data on the basis of the “‘sync’trac reference=0”.
(15) The information processing device according to any of (11) to (14), in which
the information includes an edit list for controlling reproduction in accordance with occurrence of the event, and
the extraction unit extracts the coded data on the basis of the edit list.
(16) The information processing device according to (15), in which
information corresponding to media time having a value of “−2” in the edit list is control information for controlling reproduction in accordance with occurrence of the event.
(17) The information processing device according to any of (11) to (16), in which
the information includes a sample entry indicating that another process is required in addition to a normal reproduction process,
the sample entry includes information identifying a sample of the interaction type medium, and
the extraction unit extracts the coded data on the basis of the information stored in the sample entry.
(18) The information processing device according to (17), in which
the information further includes flag information that is stored outside the sample entry of the distribution file and for identifying that the medium associated with the 3D data is the interaction type medium, and
the extraction unit further extracts the coded data on the basis of the flag information.
(19) The information processing device according to (17) or (18), in which
the information further includes “‘sync’trac reference=0” that is stored outside the sample entry of
the distribution file and indicates that the interaction type medium is reproduced asynchronously with a medium of another track, and
the extraction unit further extracts the coded data on the basis of the “‘sync’trac reference=0”.
(20) An information processing method including:
acquiring a distribution file including coded data of an interaction type medium associated with 3D data and information defining the interaction type medium;
extracting the coded data from the distribution file on the basis of the information; and
decoding the coded data extracted, in which
the interaction type medium is a medium to be reproduced on the basis of occurrence of a predetermined event.
(21) An information processing device including:
an encoding unit that encodes an interaction type medium associated with 3D data and generates coded data of the interaction type medium; and
a generation unit that generates a media file including the coded data, and further generates a control file including control information on distribution of the media file and information defining the interaction type medium,
in which
the interaction type medium is a medium to be reproduced on the basis of occurrence of a predetermined event.
(22) The information processing device according to (21), in which
the generation unit stores the information in a supplemental property of an adaptation set of the control file.
(23) The information processing device according to (21) in which
the generation unit stores the information in an essential property of an adaptation set of the control file.
(24) The information processing device according to (21), in which
the generation unit stores the information in a supplemental property of a representation of the control file.
(25) The information processing device according to (21), in which
the generation unit stores the information in an essential property of a representation of the control file.
(26) The information processing device according to any of (21) to (25), in which
the information includes information indicating that the interaction type medium is a haptics medium.
(27) The information processing device according to any of (21) to (26), in which
the generation unit stores information regarding a track to be referred to, as the information, in a representation of the control file.
(28) The information processing device according to (27), in which
the information regarding the track to be referred to includes identification information about association and information indicating a type of association.
(29) The information processing device according to any of (21) to (28), in which
the generation unit stores information indicating a sample entry indicating that another process is required in addition to a normal reproduction process in a representation of the control file as the information.
(30) An information processing method including:
encoding an interaction type medium associated with 3D data and generating coded data of the interaction type medium; and
generating a media file including the coded data, and further generating a control file including control information on distribution of the media file and information defining the interaction type medium, in which
the interaction type medium is a medium to be reproduced on the basis of occurrence of a predetermined event.
(31) An information processing device including:
an acquisition unit that acquires a media file on the basis of information that is included in a control file for controlling distribution of the media file including coded data of an interaction type medium associated with 3D data and defines the interaction type medium;
an extraction unit that extracts the coded data from the media file; and
a decoding unit that decodes the coded data extracted,
in which
the interaction type medium is a medium to be reproduced on the basis of occurrence of a predetermined event.
(32) The information processing device according to (31), in which
the information is stored in a supplemental property of an adaptation set of the control file.
(33) The information processing device according to (31), in which
the information is stored in an essential property of an adaptation set of the control file.
(34) The information processing device according to (31), in which
the information is stored in a supplemental property of a representation of the control file.
(35) The information processing device according to (31), in which
the information is stored in an essential property of a representation of the control file.
(36) The information processing device according to any of (31) to (35), in which
the information includes information indicating that the interaction type medium is a haptics medium.
(37) The information processing device according to any of (31) to (36), in which
the information includes information regarding a track to be referred to, the information being stored in a representation of the control file.
(38) The information processing device according to (37), in which
the information regarding the track to be referred to includes identification information about association and information indicating a type of association.
(39) The information processing device according to any of (31) to (38), in which
the information includes information indicating a sample entry indicating that another process is required in addition to a normal reproduction process, the information being stored in a representation of the control file.
(40) An information processing method including:
acquiring a media file on the basis of information that is included in a control file for controlling distribution of the media file including coded data of an interaction type medium associated with 3D data and defines the interaction type medium;
extracting the coded data from the media file; and
decoding the coded data extracted, in which
the interaction type medium is a medium to be reproduced on the basis of occurrence of a predetermined event.
(41) An information processing device including:
an encoding unit that encodes a haptics medium associated with 3D data and generates coded data of the haptics medium; and
a generation unit that generates a distribution file in which the coded data is stored as metadata and further including information defining the haptics medium as the metadata.
(42) The information processing device according to (41), in which
the generation unit stores the information in a meta-box defining metadata, of the distribution file.
(43) The information processing device according to (42), in which
the generation unit stores handler type information indicating that the metadata is the haptics medium, in a handler box in the meta-box, as the information.
(44) The information processing device according to (42) or (43), in which
the generation unit stores item type information indicating an encoding tool used for encoding the haptics medium, in an item info entry in the meta-box, as the information.
(45) The information processing device according to any of (42) to (44), in which the generation unit stores location information indicating a storage location of the haptics medium, in an item location box in the meta-box, as the information.
(46) The information processing device according to any of (42) to (45), in which
the generation unit stores item property information indicating configuration information on the haptics medium, in an item property container box in the meta-box, as the information.
(47) The information processing device according to any of (42) to (46), in which
the generation unit stores flag information for identifying that the haptics medium is an interaction type medium to be reproduced on the basis of occurrence of a predetermined event, in the meta-box, as the information.
(48) The information processing device according to any of (42) to (47), in which
the generation unit stores property information on timed metadata of the haptics medium in the distribution file, and stores item property information indicating the property information, in the meta-box, as the information.
(49) The information processing device according to (48), in which
the property information includes flag information indicating whether the medium is an interaction type medium to be reproduced on the basis of occurrence of a predetermined event, information indicating a scale of time information indicated in the property information, and information indicating duration of reproduction of the haptics medium.
(50) An information processing method including:
encoding a haptics medium associated with 3D data and generating coded data of the haptics medium; and
generating a distribution file in which the coded data is stored as metadata and further including information defining the haptics medium as the metadata.
(51) An information processing device including:
an acquisition unit that acquires a distribution file in which coded data of a haptics medium associated with 3D data is stored as metadata and further including information defining the haptics medium as the metadata; an extraction unit that extracts the coded data from the distribution file on the basis of the information; and
a decoding unit that decodes the coded data extracted.
(52) The information processing device according to (51), in which
the information is stored in a meta-box defining metadata, of the distribution file.
(53) The information processing device according to (52), in which
the information includes handler type information indicating that the metadata is the haptics medium, the handler type information being stored in a handler box in the meta-box, and
the extraction unit extracts the coded data on the basis of the handler type information.
(54) The information processing device according to (52) or (53), in which
the information includes item type information indicating an encoding tool used for encoding the haptics medium, the item type information being stored in an item info entry in the meta-box, and
the extraction unit extracts the coded data on the basis of the item type information.
(55) The information processing device according to any of (52) to (54), in which
the information includes location information indicating a storage location of the haptics medium, the location information being stored in an item location box in the meta-box, and
the extraction unit extracts the coded data on the basis of the location information.
(56) The information processing device according to any of (52) to (55), in which
the information includes item property information indicating configuration information on the haptics medium, the item property information being stored in an item property container box in the meta-box, and
the extraction unit extracts the coded data on the basis of the item property information.
(57) The information processing device according to any of (52) to (56), in which
the information includes flag information for identifying that the haptics medium is an interaction type medium to be reproduced on the basis of occurrence of a predetermined event, the flag information being stored in the meta-box, and
the extraction unit extracts the coded data on the basis of the flag information.
(58) The information processing device according to any of (52) to (57), in which
property information on timed metadata of the haptics medium is stored in the distribution file,
the information includes item property information indicating the property information, the item property information being stored in the meta-box, and
the extraction unit extracts the coded data on the basis of the item property information.
(59) The information processing device according to (58), in which
the property information includes flag information indicating whether the medium is an interaction type medium to be reproduced on the basis of occurrence of a predetermined event, information indicating a scale of time information indicated in the property information, and information indicating duration of reproduction of the haptics medium.
(60) An information processing method including:
acquiring a distribution file in which coded data of a haptics medium associated with 3D data is stored as metadata and further including information defining the haptics medium as the metadata;
extracting the coded data from the distribution file on the basis of the information; and
decoding the coded data extracted.
(61) An information processing device including:
an encoding unit that encodes a haptics medium associated with 3D data and generates coded data of the haptics medium; and
a generation unit that generates a distribution file including the coded data and information defining the haptics medium.
(62) The information processing device according to (61), in which
the generation unit stores binary header structure definition information defining a structure of a binary header of the haptics medium, in the distribution file, as the information.
(63) The information processing device according to (62), in which
the generation unit generates a configuration box that stores the binary header structure definition information, and stores the configuration box in a sample entry of the distribution file.
(64) The information processing device according to (63), in which
the generation unit further stores band header definition information defining a band header of a binary body of the haptics medium in the configuration box.
(65) The information processing device according to any of (61) to (64), in which
the generation unit stores binary body structure definition information defining a structure of a binary body of the haptics medium, in the distribution file, as the information.
(66) The information processing device according to (65), in which
the binary body structure definition information defines the structure of the binary body of the haptics medium by a sample structure in a media data box of the distribution file.
(67) The information processing device according to any of (61) to (66), in which
the generation unit stores encoding tool definition information defining an encoding tool used for encoding and decoding the haptics medium, in the distribution file, as the information.
(68) The information processing device according to (67), in which
the generation unit generates identification information about the encoding tool as the encoding tool definition information, and stores the identification information in a sample entry of the distribution file.
(69) The information processing device according to any of (61) to (68), in which
the distribution file is an International Organization for Standardization Base Media File Format (ISOBMFF).
(70) An information processing method including:
encoding a haptics medium associated with 3D data and generating coded data of the haptics medium; and
generating a distribution file including the coded data and information defining the haptics medium.
(71) An information processing device including:
an acquisition unit that acquires a distribution file including coded data of a haptics medium associated with 3D data and information defining the haptics medium;
an extraction unit that extracts the coded data from the distribution file on the basis of the information; and
a decoding unit that decodes the coded data extracted.
(72) The information processing device according to (71), in which
the information includes binary header structure definition information defining a structure of a binary header of the haptics medium, and
the extraction unit extracts the coded data on the basis of the binary header structure definition information.
(73) The information processing device according to (72), in which
the binary header structure definition information is stored in a configuration box of a sample entry of the distribution file.
(74) The information processing device according to (73), in which
the configuration box further stores band header definition information defining a band header of a binary body of the haptics medium, and the extraction unit further extracts the coded data on the basis of the band header definition information.

(75) The information processing device according to any of (71) to (74), in which
the information includes binary body structure definition information defining a structure of a binary body of the haptics medium, and the extraction unit extracts the coded data on the basis of the binary body structure definition information.
(76) The information processing device according to (75), in which
the binary body structure definition information defines the structure of the binary body of the haptics medium by a sample structure in a media data box of the distribution file.
(77) The information processing device according to any of (71) to (76), in which
the information includes encoding tool definition information defining an encoding tool used for encoding and decoding the haptics medium, and the decoding unit decodes the coded data by using the encoding tool defined by the encoding tool definition information.
(78) The information processing device according to (77), in which
the encoding tool definition information includes identification information about the encoding tool.
(79) The information processing device according to any of (71) to (78), in which
the distribution file is an International Organization for Standardization Base Media File Format (ISOBMFF).
(80) An information processing method including:
acquiring a distribution file including coded data of a haptics medium associated with 3D data and information defining the haptics medium;
extracting the coded data from the distribution file on the basis of the information; and
decoding the coded data extracted.
(81) An information processing device including:
an encoding unit that encodes an interaction type medium and generates coded data of the interaction type medium; and
a generation unit that generates a distribution file including the coded data and information associating the coded data with 3D data,
in which
the interaction type medium is a medium to be reproduced on the basis of occurrence of a predetermined event.
(82) The information processing device according to (81), in which
the generation unit stores, as the information, identification information about a track that stores the coded data, in a track that stores the 3D data, of the distribution file.
(83) The information processing device according to (81) to (82), in which
the generation unit stores, as the information, grouping type information indicating that pieces of data belong to the same group type, in a meta-box defining the coded data as metadata and a track that stores the 3D data, of the distribution file.
(84) The information processing device according to any of (81) to (83), in which
the generation unit stores the information in a scene description.
(85) The information processing device according to (84), in which
the generation unit stores the scene description as metadata in the distribution file.
(86) The information processing device according to (84) or (85), in which
the generation unit further stores reproduction control information regarding reproduction control of the interaction type medium in the scene description.
(87) The information processing device according to (86), in which
the generation unit further defines a sample entry indicating that another process is required in addition to a normal reproduction process, in the distribution file, and stores the reproduction control information in the sample entry.
(88) The information processing device according to (87), in which
the generation unit further stores flag information for identifying that the medium associated with the 3D data is the interaction type medium, outside the sample entry of the distribution file, as the information.
(89) The information processing device according to (87) or (88), in which
the generation unit further stores “‘sync’trac reference=0” indicating that the interaction type medium is reproduced asynchronously with a medium of another track, outside the sample entry of the distribution file, as the information.
(90) An information processing method including:
encoding an interaction type medium and generating coded data of the interaction type medium;
generating a distribution file including the coded data and information associating the coded data with 3D data, in which
the interaction type medium is a medium to be reproduced on the basis of occurrence of a predetermined event.
(91) An information processing device including:
an acquisition unit that acquires a distribution file including coded data of an interaction type medium to be reproduced on the basis of occurrence of a predetermined event and information associating the coded data with 3D data;
an extraction unit that extracts the coded data from the distribution file on the basis of the information; and
a decoding unit that decodes the coded data extracted.
(92) The information processing device according to (91), in which
the information includes identification information about a track that stores the coded data, the identification information being stored in a track that stores the 3D data, of the distribution file, and
the extraction unit extracts the coded data on the basis of the identification information.
(93) The information processing device according to (91) to (92), in which
the information includes grouping type information indicating that pieces of data belong to the same group type, the grouping type information being stored in a meta-box defining the coded data as metadata and a track that stores the 3D data, of the distribution file, and
the extraction unit extracts the coded data on the basis of the grouping type information.
(94) The information processing device according to any of (91) to (93), in which
the information is stored in a scene description.
(95) The information processing device according to (94), in which
the scene description is stored in the distribution file as metadata.
(96) The information processing device according to (94) or (95), in which
the scene description further stores reproduction control information regarding reproduction control of the interaction type medium.
(97) The information processing device according to (96), in which
a sample entry indicating that another process is required in addition to a normal reproduction process is defined in the distribution file, and
the sample entry stores the reproduction control information.
(98) The information processing device according to (97), in which
the information further includes flag information for identifying that a medium associated with the 3D data is the interaction type medium, the flag information being stored outside the sample entry of the distribution file, and
the extraction unit further extracts the coded data on the basis of the flag information.
(99) The information processing device according to (97) or (98), in which
the information further includes “‘sync’trac reference=0” that is stored outside the sample entry of the distribution file and indicates that the interaction type medium is reproduced asynchronously with a medium of another track, and
the extraction unit further extracts the coded data on the basis of the “‘sync’trac reference=0”.
(100) An information processing method including:
acquiring a distribution file including coded data of an interaction type medium to be reproduced on the basis of occurrence of a predetermined event and information associating the coded data with 3D data; and
extracting the coded data from the distribution file on the basis of the information; and
decoding the coded data extracted.

### REFERENCE SIGNS LIST

300 File generation device
301 Control unit
302 File generation processing unit
311 Input unit
312 Preprocessing unit
313 Encoding unit
314 File generation unit
315 Storage unit
316 Output unit
321 SD input unit
322 3D input unit
323 Media input unit
331 SD preprocessing unit
332 3D preprocessing unit
333 Media preprocessing unit
341 SD encoding unit
342 3D encoding unit
343 Media encoding unit
351 SD file generation unit
352 3D file generation unit
353 Media file generation unit
354 MPD file generation unit
361 SD storage unit
362 3D storage unit
363 Media storage unit
364 MPD storage unit
371 SD output unit
372 3D output unit
373 Media output unit
374 MPD output unit
400 Client device
401 Control unit
402 Client processing unit
411 Acquisition unit
412 File processing unit
413 Decoding unit
414 SD parsing unit
415 MPD parsing unit
416 Output control unit
417 Output unit
421 SD acquisition unit
422 MPD acquisition unit
423 3D acquisition unit
424 Media acquisition unit
431 SD file processing unit
432 MPD file processing unit
433 3D file processing unit
434 Media file processing unit
441 SD decoding unit
442 MPD decoding unit
443 3D decoding unit
444 Media decoding unit
453 3D output control unit
454 Media output control unit
463 3D output unit
464 Media output unit

1. An information processing device comprising:
an encoding unit that encodes an interaction type medium associated with 3D data and generates coded data of the interaction type medium; and
a generation unit that generates a distribution file including the coded data and information defining the interaction type medium,
wherein
the interaction type medium is a medium to be reproduced on a basis of occurrence of a predetermined event.

2. The information processing device according to claim 1, wherein
the generation unit stores flag information for identifying that the medium associated with the 3D data is the interaction type medium, in the distribution file, as the information.

3. The information processing device according to claim 2, wherein
the generation unit further stores “‘sync’trac reference=0” indicating that the interaction type medium is reproduced asynchronously with a medium of another track, in the distribution file, as the information.

4. The information processing device according to claim 1, wherein
the generation unit stores an edit list for controlling reproduction in accordance with occurrence of the event, in the distribution file, as the information.

5. The information processing device according to claim 1, wherein
the generation unit defines a sample entry indicating that another process is required in addition to a normal reproduction process in the distribution file, and stores information identifying a sample of the interaction type medium, in the sample entry, as the information.

6. An information processing method comprising:
encoding an interaction type medium associated with 3D data and generating coded data of the interaction type medium; and
generating a distribution file including the coded data and information defining the interaction type medium, wherein
the interaction type medium is a medium to be reproduced on a basis of occurrence of a predetermined event.

7. An information processing device comprising:
an acquisition unit that acquires a distribution file including coded data of an interaction type medium associated with 3D data and information defining the interaction type medium;
an extraction unit that extracts the coded data from the distribution file on a basis of the information; and
a decoding unit that decodes the coded data extracted,
wherein
the interaction type medium is a medium to be reproduced on a basis of occurrence of a predetermined event.

8. An information processing method comprising:
acquiring a distribution file including coded data of an interaction type medium associated with 3D data and information defining the interaction type medium;
extracting the coded data from the distribution file on a basis of the information; and
decoding the coded data extracted, wherein
the interaction type medium is a medium to be reproduced on a basis of occurrence of a predetermined event.

9. An information processing device comprising:
an encoding unit that encodes an interaction type medium associated with 3D data and generates coded data of the interaction type medium; and
a generation unit that generates a media file including the coded data, and further generates a control file including control information on distribution of the media file and information defining the interaction type medium,
wherein
the interaction type medium is a medium to be reproduced on a basis of occurrence of a predetermined event.

10. The information processing device according to claim 9, wherein
the generation unit stores the information in a supplemental property or an essential property, of an adaptation set or a representation, of the control file.

11. An information processing method comprising:
encoding an interaction type medium associated with 3D data and generating coded data of the interaction type medium; and
generating a media file including the coded data, and further generating a control file including control information on distribution of the media file and information defining the interaction type medium, wherein
the interaction type medium is a medium to be reproduced on a basis of occurrence of a predetermined event.

12. An information processing device comprising:
an acquisition unit that acquires a media file on a basis of information that is included in a control file for controlling distribution of the media file including coded data of an interaction type medium associated with 3D data and defines the interaction type medium;
an extraction unit that extracts the coded data from the media file; and
a decoding unit that decodes the coded data extracted,
wherein
the interaction type medium is a medium to be reproduced on a basis of occurrence of a predetermined event.

13. An information processing method comprising:
acquiring a media file on a basis of information that is included in a control file for controlling distribution of the media file including coded data of an interaction type medium associated with 3D data and defines the interaction type medium;
extracting the coded data from the media file; and
decoding the coded data extracted, wherein
the interaction type medium is a medium to be reproduced on a basis of occurrence of a predetermined event.

14. An information processing device comprising:
an encoding unit that encodes a haptics medium associated with 3D data and generates coded data of the haptics medium; and
a generation unit that generates a distribution file in which the coded data is stored as metadata and further including information defining the haptics medium as the metadata.

15. The information processing device according to claim 14, wherein
the generation unit stores the information in a meta-box defining metadata, of the distribution file.

16. The information processing device according to claim 15, wherein
the generation unit stores flag information for identifying that the haptics medium is an interaction type medium to be reproduced on a basis of occurrence of a predetermined event, in the meta-box, as the information.

17. The information processing device according to claim 15, wherein
the generation unit stores property information on timed metadata of the haptics medium in the distribution file, and stores item property information indicating the property information, in the meta-box, as the information.

18. An information processing method comprising:
encoding a haptics medium associated with 3D data and generating coded data of the haptics medium; and
generating a distribution file in which the coded data is stored as metadata and further including information defining the haptics medium as the metadata.

19. An information processing device comprising:
an acquisition unit that acquires a distribution file in which coded data of a haptics medium associated with 3D data is stored as metadata and further including information defining the haptics medium as the metadata;
an extraction unit that extracts the coded data from the distribution file on a basis of the information; and
a decoding unit that decodes the coded data extracted.

20. An information processing method comprising:
acquiring a distribution file in which coded data of a haptics medium associated with 3D data is stored as metadata and further including information defining the haptics medium as the metadata;
extracting the coded data from the distribution file on a basis of the information; and
decoding the coded data extracted.
